(19) United States
(12) Patent Application Publication
(10) Pub. No.: US 2013/0344588 A1
(43) Pub. Date: Dec. 26, 2013

(54) DEVICES AND METHODS FOR CONCENTRATION AND ANALYSIS OF FLUIDS

(71) Applicants: Perry V. Halushka, Charleston, SC (US); Dennis K. Watson, Mount Pleasant, SC (US); Omar Moussa, Mount Pleasant, SC (US); Robert G. Dickie, King City (CA)

(72) Inventors: Perry V. Halushka, Charleston, SC (US); Dennis K. Watson, Mount Pleasant, SC (US); Omar Moussa, Mount Pleasant, SC (US); Robert G. Dickie, King City (CA)

(73) Assignee: MEDICAL UNIVERSITY OF SOUTH CAROLINA, Charleston, SC (US)

(21) Appl. No.: 13/884,697

(22) PCT Filed: Nov. 10, 2011
(86) PCT No.: PCT/US11/60208

§ 371 Date: Aug. 22, 2013

Related U.S. Application Data
(60) Provisional application No. 61/412,176, filed on Nov. 10, 2010.

(51) Int. Cl. G01N 1/40

(52) U.S. Cl. CPC G01N 1/4005
USPC 435/309.1; 422/527; 422/534

(57) ABSTRACT

Disclosed are articles, compositions and methods for detecting analytes. The disclosed articled, compositions and methods increase the ease of detection and quantitation of the target analyte.

### CROSS-REFERENCE TO RELATED APPLICATIONS

This application claims the benefit of U.S. Provisional Patent Application No. 61/412,176, filed Nov. 10, 2010, which is incorporated herein by reference in its entirety.

### FIELD

The disclosed are compositions, articles, machines, and methods generally in the field of collecting, separating, concentrating, and/or detecting analytes such as proteins, nucleic acids, drugs, steroids, biomarkers and diseases markers in biological samples.

### BACKGROUND

Analysis of samples (biological or environmental) can be cumbersome and expensive. Quick, easy and sensitive analysis of specific analytes is important in many aspects, particularly disease monitoring/diagnosing and drug screening. Many current detection and screening assays are not sensitive enough to detect low levels of analytes. Increased sensitivity for analyte detection can be a huge asset for newly developed detection and screening methods. Such analysis can be used, for example, to screen employee applicants or athletes for illegal drug use or to monitor a patient's disease status or screen for a disease. Environmental analysis sometimes requires collection of large quantities of liquid material for pollution analysis from remote areas. On site-collection, concentration, and preservation of the analytes can be improved the sensitivity of the testing.

Most tests on bodily fluids, particularly urine, are actually performed directly without any adjustments to the sample immediately after collection. This can be problematic due to the chemical and biological environment of the urine and other bodily fluids. Several factors affect the environment (e.g. pH) of urine such as a subject's hydration level or the amount of salts in the body. When testing for the presence of specific analytes in a sample like urine, the pH can drastically affect the results thus leading to false positives or false negatives. Testing of urine which has been appropriately buffered or treated to increase detection of the analyte (i.e. prevent breakdown of the analyte) can greatly improve urinalysis results. Furthermore, components in urine, such as urea, can affect urinalysis and thus the ability to buffer, treat or dilute the urine prior to testing can be beneficial. Furthermore, concentration of dilute analytes can aid in the identification of low amounts of analytes in a sample.

Quick and easy tests, for example, the dipstick test, can result in false negatives due to the specific analyte not coming in contact with the test stick, because of, for example, low concentrations or because of non-optimal binding conditions, such as unbuffered conditions. A device which can address one or more of these issues, gives a higher probability of more accurate results.

### BRIEF SUMMARY

Disclosed herein is an article comprising a first chamber and a second chamber, wherein the first chamber and second chamber can be connected by a collection assembly, wherein the collection assembly can comprise a port through which liquid can pass and a solid substrate, wherein the solid substrate can retain a substance, and a vacuum generator operably connected to the second chamber.

In one embodiment, the first chamber and second chamber share at least one wall.

In one embodiment, the collection assembly further comprises a solid substrate support. The collection assembly can further comprise a solid support lock operably connected to a solid substrate support. In one embodiment, the collection assembly can comprise a one-way valve to prevent the liquid from flowing back through the filter. In one embodiment, the collection assembly can further comprise a removable filter cassette for processing or analysis outside of the article.

In one embodiment, the article can comprise a sealer operably connected to the solid substrate support and the second chamber. There can also be a sealer operably connected to the solid substrate support and the solid support lock.

In one embodiment, the solid substrate can comprise an acrylamide, cellulose, nitrocellulose, glass, polystyrene, polyvinylidene fluoride, filter, filter paper (Whatman), Glass fiber filters (GF) (A,B,C), fiberglass, polyethylenimine coated GFs, porous mylar or other transparent porous films, cellulose nitrate (CN) membrane, mixed cellulose ester membrane, cellulose acetate membrane, polyethersulfone (PES) membrane, PTFE membrane, ultrafiltration membranes of poly(vinyl chloride) (PVC), carboxylated poly(vinyl chloride) (CPVC), polystyrene, polyethylene vinyl acetate, polypropylene, polymethacrylate, polyethylene, polyethylene oxide, glass, polysilicates, polycarbonates, teflon, fluorocarbons, nylon, silicon rubber, polyanhydrides, polyglycolic acid, polylactic acid, polyorthoesters, polypropylfumerate, collagen, glycosaminoglycans, and polyamino acids.

Also disclosed, the solid substrate can further comprise a detection agent. In one embodiment, the detection agent can comprise a label moiety. The label moiety can comprise an enzymatic moiety, radioactive moiety, electromagnetic field moiety, chromophore moiety, fluorophores moiety, quantum dot moiety, heavy element moiety, proton emitting moiety, phosphorescent moiety, antibody moiety and fluorescent moiety.

In one embodiment, the fluorophore moiety can comprise fluorescein isothiocyanate (FITC), 5,6-carboxymethyl fluorescein, Texas red, nitrobenz-2-oxa-1,3-diazol-4-yl (NBD), coumarin, dansyl chloride, rhodamine, amino-methyl coumarin (AMCA), Eosin, Erythrosin, BODIPY°, Cascade Blue®, Oregon Green®, pyrene, lissamine, xanthenes, acridines, oxazines, phycoerythrin, macrocyclic chelates of lanthanide ions such as quantum Dye™, fluorescent energy transfer dyes, such as thiazole orange-ethidium heterodimer, and the cyanine dyes Cy3, Cy3.5, Cy5, Cy5.5 and Cy7. Examples of other specific fluorescent labels include 3-Hydroxypyrene 5,8,10-Tri Sulfonic acid, 5-Hydroxy Tryptamine (5-HT), Acid Fuchsin, Alizarin Complexon, Alizarin Red, Allophycocyanin, Aminocoumarin, Anthroyl Stearate, Astrazon Brilliant Red 4G, Astrazon Orange R, Astrazon Red 6B, Astrazon Yellow 7 GLL, Atabrine, Auramine, Aurophosphine, Aurophosphine G, BAO 9 (Bisaminophenyloxadiazole), BCECF, Berberine Sulphate, Bisbenzamide, Blancophor FFG Solution, Blancophor SV, Bodipy F1, Brilliant Sulphoflavin FF, Calcien Blue, Calcium Green, Calcofluor RW Solution, Calcofluor White, Calcophor White ABT Solution, Calcophor White Standard Solution, Carbostyryl, Cascade Yellow, Catecholamine, Chinacrine, Coriphosphine O, Coumarin-Phalloidin, CY3.1 8, CY5.1 8, CY7, Dans (1-Dimethyl Amino Naphaline 5 Sulphonic Acid), Dansa (Diamino Naphtyl Sulphonic Acid), Dansyl NH—CH3, Diamino Phenyl Oxydiazole (DAO), Dimethylamino-5-Sulphonic acid, Dipyrrometheneboron Difluoride, Diphenyl Brilliant Flavine 7GFF, Dopamine, Erythrosin ITC, Euchrysin, FIF (Formaldehyde Induced Fluorescence), Flazo Orange, Fluo 3, Fluorescamine, Fura-2, Genacryl Brilliant Red B, Genacryl Brilliant Yellow 10GF, Genacryl Pink 3G, Genacryl Yellow 5GF, Gloxalic Acid, Granular Blue, Haematoporphyrin, Indo-1, Intrawhite Cf Liquid, Leucophor PAF, Leucophor SF, Leucophor WS, Lissamine Rhodamine B200 (RD200), Lucifer Yellow CH, Lucifer Yellow VS, Magdala Red, Marina Blue, Maxilon Brilliant Flavin 10 GFF, Maxilon Brilliant Flavin 8 GFF, MPS (Methyl Green Pyronine Stilbene), Mithramycin, NBD Amine, Nitrobenzoxadidole, Noradrenaline, Nuclear Fast Red, Nuclear Yellow, Nylosan Brilliant Flavin EBG, Oxadiazole, Pacific Blue, Pararosaniline (Feulgen), Phorwite AR Solution, Phorwite BKL, Phorwite Rev, Phorwite RPA, Phosphine 3R, Phthalocyanine, Phycoerythrin R, Polyazaindacene Pontochrome Blue Black, Porphyrin, Primuline, Procion Yellow, Pyronine, Pyronine B, Pyrozal Brilliant Flavin 7GF, Quinacrine Mustard, Rhodamine 123, Rhodamine 5 GLD, Rhodamine 6G, Rhodamine B, Rhodamine B 200, Rhodamine B Extra, Rhodamine BB, Rhodamine BG, Rhodamine WT, Serotonin, Sevron Brilliant Red 2B, Sevron Brilliant Red 4G, Sevron Brilliant Red B, Sevron Orange, Sevron Yellow L, SITS (Primuline), SITS (Stilbene Isothiosulphonic acid), Stilbene, Snarf 1, sulpho Rhodamine B Can C, Sulpho Rhodamine G Extra, Tetracycline, Thiazine Red R, Thioflavin S, Thioflavin TCN, Thioflavin 5, Thiolyte, Thiozol Orange, Tinopol CBS, True Blue, Ultralite, Uranine B, Uvitex SFC, Xylene Orange, and XRITC, fluorescein (5-carboxyfluorescein-N-hydroxysuccinimide ester), rhodamine (5,6-tetramethyl rhodamine), and the cyanine dyes Cy3, Cy3.5, Cy5, Cy5.5 and Cy7, 6-carboxyfluorescein (6-FAM), 2′,4′,1,4,-tetrachlorofluorescein (TET), 2′,4′,5′,7′,1,4-hexachlorofluorescein (HEX), 2′,7′-dimethoxy-4′,5′-dichloro-6-carboxyrhodamine (JOE), 2′-chloro-5′-fluoro-7′,8′-fused phenyl-1,4-dichloro-6-carboxyfluorescein (NED), and 2′-chloro-7′-phenyl-1,4-dichloro-6-carboxyfluorescein (VIC).

In one embodiment, the detection agent can comprise proteins, functional nucleic acids, carbohydrates, lipids, carbohydrate containing molecules, lipid containing molecules, aptamers, or peptidomimetics.

In one embodiment, the protein can comprise an antibody or receptor. The antibody can comprise a monoclonal or polyclonal antibody. The antibody may be immobilized on beads or other solid/semi-solid support. The receptor can comprise protein A, Protein G, avidin, streptavidin, or neutravidin. In one embodiment, the functional nucleic acid can comprise an antisense or microRNA probe or aptamer.

The collection assembly of the disclosed article can further comprise a multi-layers filtering system to isolate different components for example, a first, second, third, etc. solid substrate and a first, second, third, etc. pre-filter.

In one embodiment, the disclosed article can further comprise a buffer. The buffer can comprise a buffer capsule.

In one embodiment, the buffer agent can comprise a solid form. The buffer agent can comprise TRIS or other buffers, phosphates, NaHCO₃, HEPES, PIPES, protein stabilizers, RNA stabilizers, DNA stabilizers, cell preserving, fixing agents, lysing agents and detergents.

In one embodiment, the protein stabilizers can be protease inhibitors or phosphatase inhibitors, the RNA stabilizers can be RNase inhibitors and the DNA stabilizers can be DNase inhibitors.

In one embodiment, the disclosed article can comprise a detection agent capsule.

The vacuum generator of the disclosed article can comprise a spring activated piston device. The vacuum generator can comprise a tube with a piston operatively connected to the second chamber, wherein when the piston is withdrawn from the tube air in the second chamber can be removed. In one embodiment, the vacuum generator can further comprise a spring operatively associated with the piston, wherein the spring when uncompressed forces the piston to be withdrawn. The spring may be of variable tensions to regulate the flow of the sample.

In one embodiment, the substance of the disclosed article can comprise pharmaceuticals such as Marijuana/cannabinoid, amphetamine and methamphetamine, Opiates/narcotics (i.e. morphine, codeine), phencyclidine (PCP), alcohol, lysergic acid diethylamide (LSD), methaqualone, barbiturates (Phenobarbital), benzodiazepines (i.e. xanax, valium), cotinine, nicotine, heroin, methadone, MDMA (ecstasy), hydrocodone (vicodin), oxycodone (oxycontin), steroids, narcotics (i.e. opium, cocaine). The substance can comprise tumor markers such as Prostate Specific Antigen, Human chorionic gonadotropin, Alpha fetoprotein, CA 125, Carcinoembryonic antigen, CA 15-3, Beta-2-microglobulin, Bladder tumor antigen, CA 27.29, CA 72-4, CA 125, CA 19-9, Chromogranin A, Epidermal growth factor receptor, Hormone receptors, HER2, Neuron-specific enolase, NMP22, Prostatic acid phosphatase, Prostate specific membrane antigen, S-100, TA-90, Thyroglobulin, CYFRA21.1. The substance can comprise cells such as red blood cells, white blood cells, bacterial cells, epithelial cells, kidney cells, fungal cells, yeast cells, cancer cells, and renal cells.

The disclosed article can further comprise a lid, which can be connected to the first chamber by a hinge, wherein the lid can form a seal with the first chamber. The lid can invert during processing.

In one embodiment, the disclosed article can further comprise a slot blot adaptor, ELISA adapter and/or a support screen.

The disclosed article can also further comprise a third chamber, wherein the third chamber can retain unprocessed fluids.

In one embodiment, the first chamber of the disclosed article can comprise a bead holder compartment that allows mixing of the fluids with beads prior to processing.

In one embodiment, the disclosed liquid can comprise the samples disclosed herein.

For instance, the liquid can be cell culture media or body fluids such as urine, stool, blood—whole serum or plasma—, spinal fluid, cerebrospinal fluid, ocular lens liquid, semen, synovial fluid, peritoneal fluid, pleural fluid, sputum, lymph fluid, saliva, amniotic fluid, pus, lavage fluid, sweat, bile, tears, exosomes, nanoparticles, nanotubes, vomit, cerumen (earwax), gastric juice, pancreatic juice, breast milk, mucus, sebum (skin oil), vaginal secretion, aqueous humour, pericardial fluid, lymph, chyme, prostatic fluid. In one embodiment, the disclosed article can further comprise a mechanical piston lock to store energy.

Also disclosed are collection assemblies. The collection assemblies are optionally used in the described articles and/or methods.

Additional advantages of the disclosed methods and compositions, articles of manufacture and machines, will be set forth in part in the description which follows, and in part will be understood from the description, or may be learned by practice of the disclosed method and compositions. The advantages of the disclosed methods and compositions, articles of manufacture and machines will be realized and attained by means of the elements and combinations particularly pointed out in the appended claims. It is to be understood that both the foregoing general description and the following detailed description are exemplary and explanatory only and are not restrictive of the invention as claimed.

### BRIEF DESCRIPTION OF THE DRAWINGS

The accompanying drawings, which are incorporated in and constitute a part of this specification, illustrate several embodiments of the disclosed method and compositions and together with the description, serve to explain the principles of the disclosed method and compositions.

FIG. 1 is a diagram of the outside of an analyzer (1).

FIG. 2 is a side view of the outside of the analyzer (1).

FIG. 3 is a view of the analyzer showing the spring activated piston device (8).

FIG. 4 is a top view of the analyzer without the lid.

FIG. 5 is a diagram of the analyzer (1) showing an expanded view of the vacuum generator (7), spring activated piston device (8) and the collection assembly (10).

FIG. 6 is a diagram showing an expanded view of the collection assembly (10). Starting from the bottom, the port (16) is where the sample flow through (any unbound analytes) drains into the second chamber of the analyzer. The sealer (18) fits on the bottom of the solid substrate support (19) which houses the support screen (20) and supports the solid substrate (11) and/or filter (4). The solid substrate (11) is sealed by a sealer (18) and further held into position by the solid support lock (21) which also allows for stacking of another solid substrate or pre-solid substrate (22).

FIG. 7 is a longitudinal section of the analyzer (1). This view shows the spring activated piston device (8), the spring (9), all the pieces of the collection assembly (10).

FIG. 8 is a longitudinal section of the analyzer (1) similar to FIG. 7 except that a sample (3) is present in the first chamber (5).

FIG. 9 is a longitudinal section of the analyzer (1) showing the spring (9) after the spring activated piston device (8) has been released. The analytes (2) that did not bind to the solid substrate (4) moved from the first chamber (#5) to the second chamber (#6).

FIGS. 10A and 10B are top views of the analyzer (1) without the lid. FIG. 10A shows the first chamber (5), the vacuum generator (7) and the collection assembly (10) which comprises the solid substrate (4) and solid substrate support (19). FIG. 10B shows the same view as seen in 10A but including the presence of the analytes (2) in the first chamber (5).

FIGS. 11A and 11B are top views of the analyzer (1) without the lid and show the first chamber (5) divided into two separate compartments via the divider (40), seen here as the first chamber (5) and the reservoir container (41). FIG. 11A shows the analyzer without sample present and FIG. 11B shows sample (3) in the first chamber (5) and reservoir container (41).

FIGS. 12A and 12B are top views of the analyzer without the lid and show the first chamber (5) comprising a fourth chamber (25). The side chamber can house reagents to be released into the first chamber.

FIGS. 13A and 13B are side views of the analyzer without the side panel. This shows the lid (12), the reservoir container (41), the first chamber (5), the vacuum generator (7) and the spring activated piston device (8).

FIG. 14 shows a side view of the Analyzer (1).

FIG. 15 shows a side view of the Analyzer (1).

FIG. 16 shows a dot blot.

FIG. 17A is a photograph of a commercial pregnancy test device indicating the sensitivity of detection for a 50 mU/ml dilution of HCG.

FIG. 17B is a photograph of a commercial pregnancy test device indicating the sensitivity of detection for a 20 mU/ml dilution of HCG.

FIG. 17C is a photograph of a blot of six nitrocellulose filters at varying dilutions of HCG.

FIG. 18 is a diagram showing an expanded view of an example collection assembly.

### DETAILED DESCRIPTION OF THE INVENTION

The disclosed methods and compositions, articles of manufacture and machines may be understood more readily by reference to the following detailed description of particular embodiments and the Example included therein and to the Figures and their previous and following description.

It is to be understood that the disclosed method and compositions are not limited to specific synthetic methods, specific analytical techniques, or to particular reagents unless otherwise specified, and, as such, may vary. It is also to be understood that the terminology used herein is for the purpose of describing particular embodiments only and is not intended to be limiting.

Disclosed are analyzers which can be used for the processing of samples, suspended in liquid, and liquid samples, such as body fluid. The analyzers in certain embodiments comprise assemblies capable of identifying and concentrating one or more molecules or substances, such as an analyte, which can then be identified, such as through a fluorophore assay. In certain embodiments, the analyzer can allow for mixing or providing one or more reagents, such as a pH buffer or lysis buffer to the sample either prior to or after identification. The analyzer comprises a number of different parts, a list of certain of these parts is provided below and definitions for these are provided herein. A discussion of the methods of using the analyzer in certain assays is provided herein as well.

### A. Analyzer

Materials for the components of the analyzer and assembly are selected from the following groups of materials.

Numbering refers to the embodiment shown in the figures only, and the numbering is not limiting to the scope of the disclosed articles and devices.

A parts list for figures and numbering is provided herein.

| Part | Number in figures |
|---|---|
| analyzer (1) | 1 |
| Filtered specimen (2) | 2 |
| sample (3) | 3 |
| solid substrate (4) (Filter) | 4 |
| First chamber (5) | 5 |
| second chamber (6) | 6 |
| vacuum generator (7) | 7 |
| spring activated piston device (8) | 8 |
| Tuneable spring (9) | 9 |
| collection assembly (10) | 10 |
| filter (11) | 11 |
| lid (12) | 12 |
| hinge (13) | 13 |
| Flow through (15) | 15 |
| Port (16) | 16 |
| pre-filter(s) (17 | 17 |
| sealer (18) (O RING) | 18 |
| substrate support (19) | 19 |
| Porous support (20) | 20 |
| Filter holder (21) | 21 |
| Pre-solid substrate (22) | 22 |
| Large Particle Filter (23) | 23 |
| Slot Blot Adaptor (24) | 24 |
| Chemical holding chamber (25) | 25 |
| Chemical Pack (26) | 26 |
| Separating wall (27) | 27 |
| Clean specimen compartment (28) | 28 |
| Specimen (29) | 29 |
| Chemicals | 30 |
| Chemical holding pouch | 31 |
| Rod connection for removal of assembly | 32 |

In general, the analyzer (1) is an article that allows for analytes (2) in a sample (3) to be placed in direct contact with a solid substrate (4) which can be used for detection or identification of a variety of analytes (13). The device (1) is comprised of a first chamber (5), where the sample (3) is placed, and a second chamber (6), where unbound analytes (13) and flow through (14) accumulate. The sample (3) is pulled from the first chamber (5) to the second chamber (6) via a vacuum generator (7), such as a spring activated piston (8). As the spring (9) is released, it causes suction in the second chamber (6) which pulls the sample (3) from the first chamber (5) to the second chamber (6) by way of the collection assembly (10) containing, for example, a filter (11), such as a size exclusion filter or a capture tag impregnated filter.

The analyzer (1) can be a unitary structure and is made of a thermoplastic material. Such thermoplastic material includes, but is not limited to, polyethylene, polypropylene, high impact polystyrene and acrylonitrile-butadiene-styrene terpolymer.

The analyzer (1) can be sterile. Sterilization of the analyzer can comprise a variety of procedures. Sterilization may be accomplished by, for example, chemical, physical, or irradiation techniques. Examples of chemical methods include exposure to ethylene oxide or hydrogen peroxide vapor. Examples of physical methods include sterilization by heat (dry or moist), retort canning, and filtration. The British Pharmacopoeia recommends heating at a minimum of 160° C. for not less than 2 hours, a minimum of 170° C. for not less than 1 hour and a minimum of 180° C. for not less than 30 minutes for effective sterilization. For examples of heat sterilization, see U.S. Pat. No. 6,136,326, which is hereby incorporated by reference.

Examples of sterilization agents include, but are not limited to, ultraviolet light, gamma radiation, sonic radiation, chemicals, infrared radiation, steam, gases, and the like. Numerous types of sterilization agents are known and are commercially available. Additional examples of such sterilization agents include, but are not limited to, alcohol, ethylene oxide, ozone, ozonated water, ultraviolet light, gamma radiation, heat, steam, heat and pressure, chlorine, ammonia, and the like.

The analyzer (1) typically has a lid (12) (the lid (12) can be made of woven polyethylene, paper, or any thermoplastic material). In one embodiment, the lid (12) is a separate unit from the main analyzer (1). In another embodiment, the lid (12) is attached to the analyzer (1). The lid (1) can be attached to the main unit (comprised of the first chamber (5) and second chamber (6)) in many ways, for example via a hinge (13), wherein the hinge can be comprised of a variety of materials (e.g. plastic, metal, rubber, etc.). In one embodiment, the lid (12) is left open during processing. In another embodiment, the lid (12) is shut before the spring (9) is released causing suction and thus causing the lid to invert.

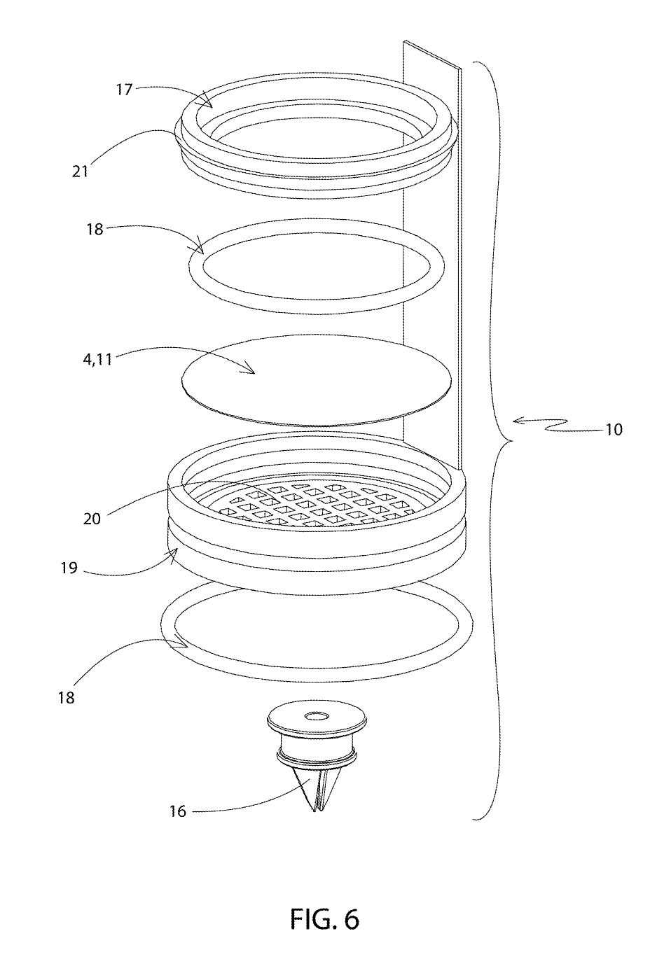

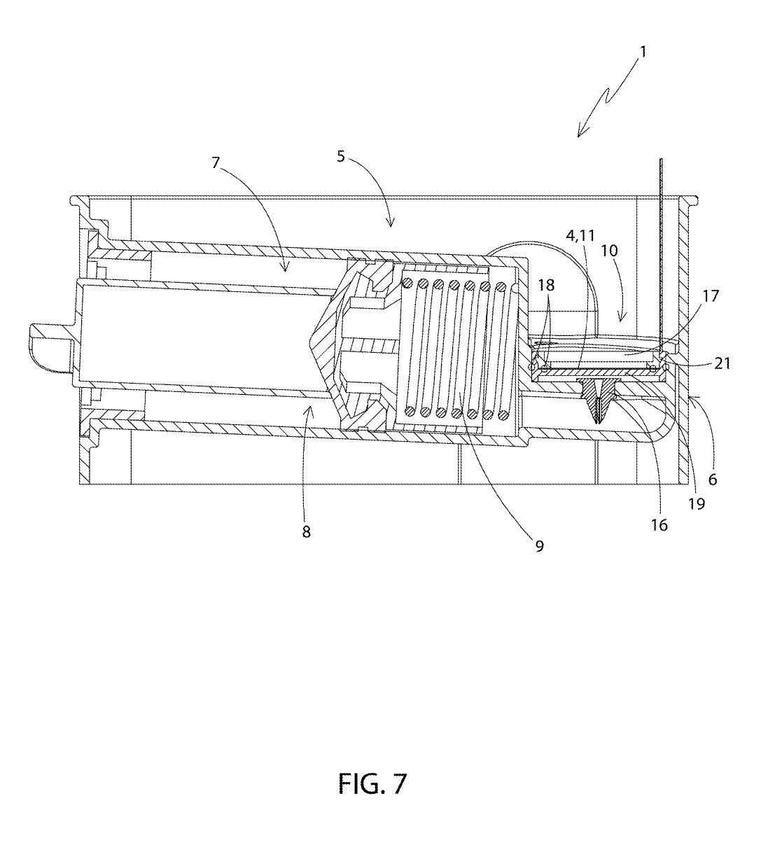

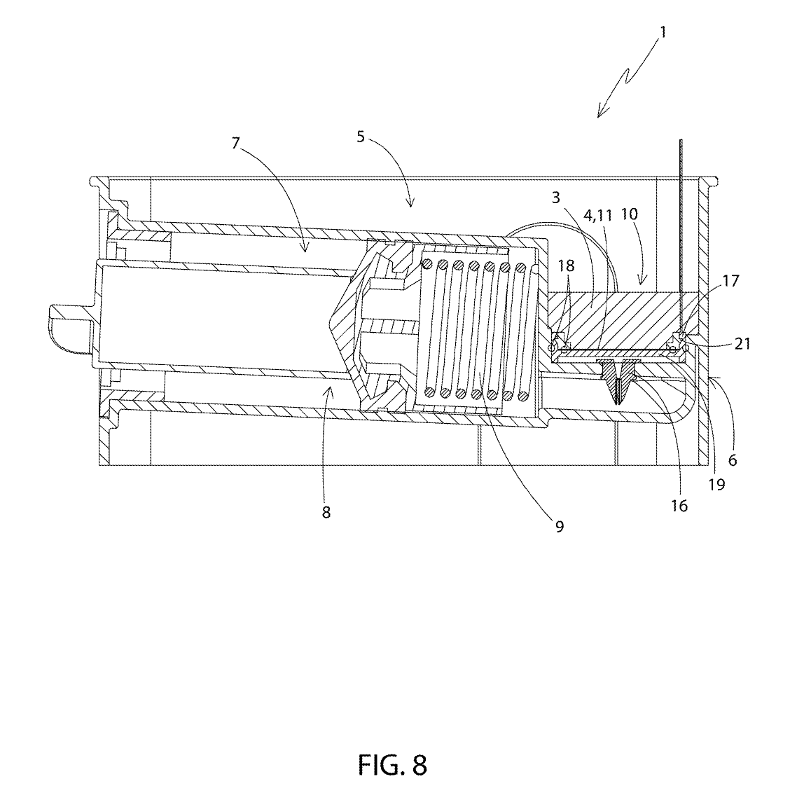

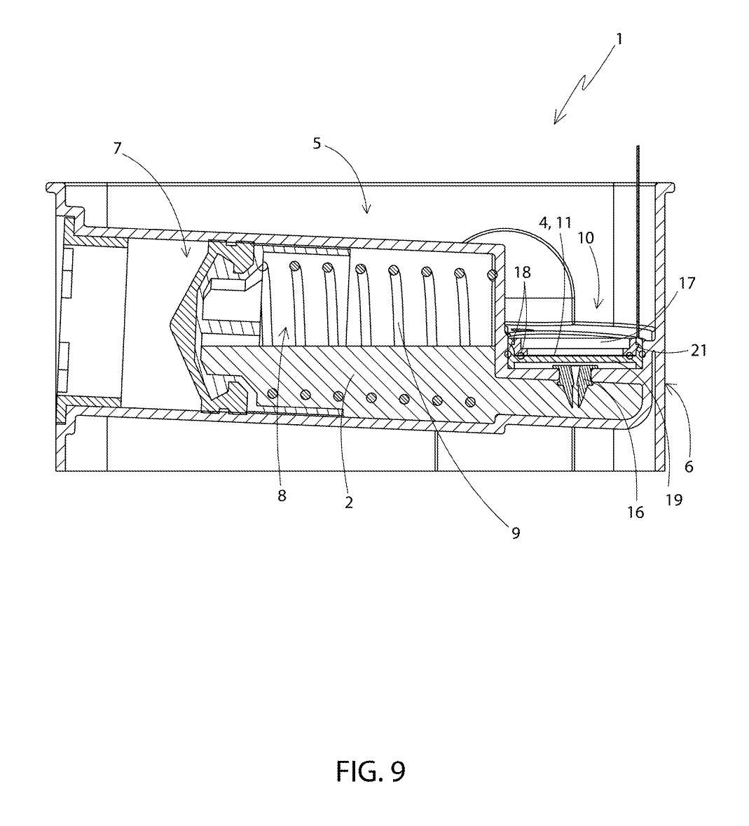

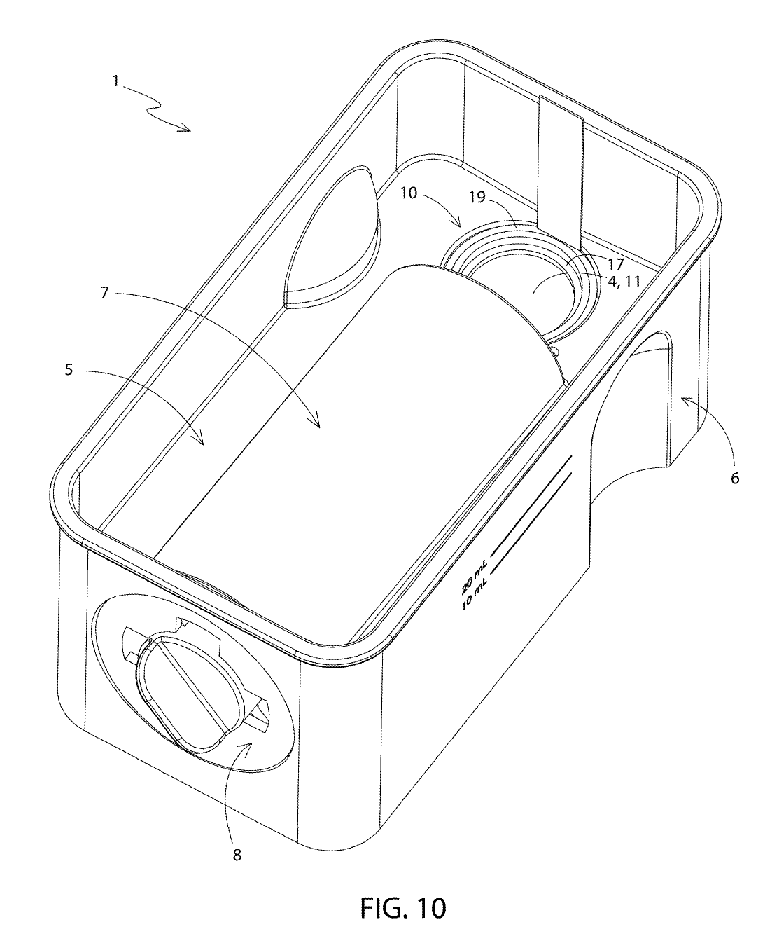

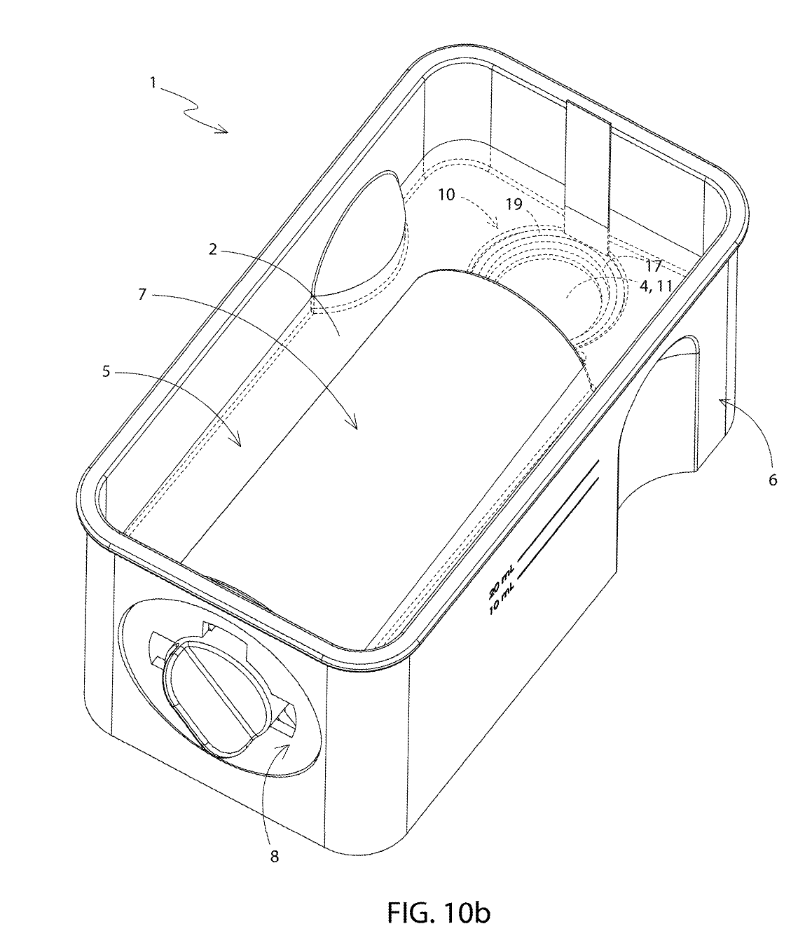

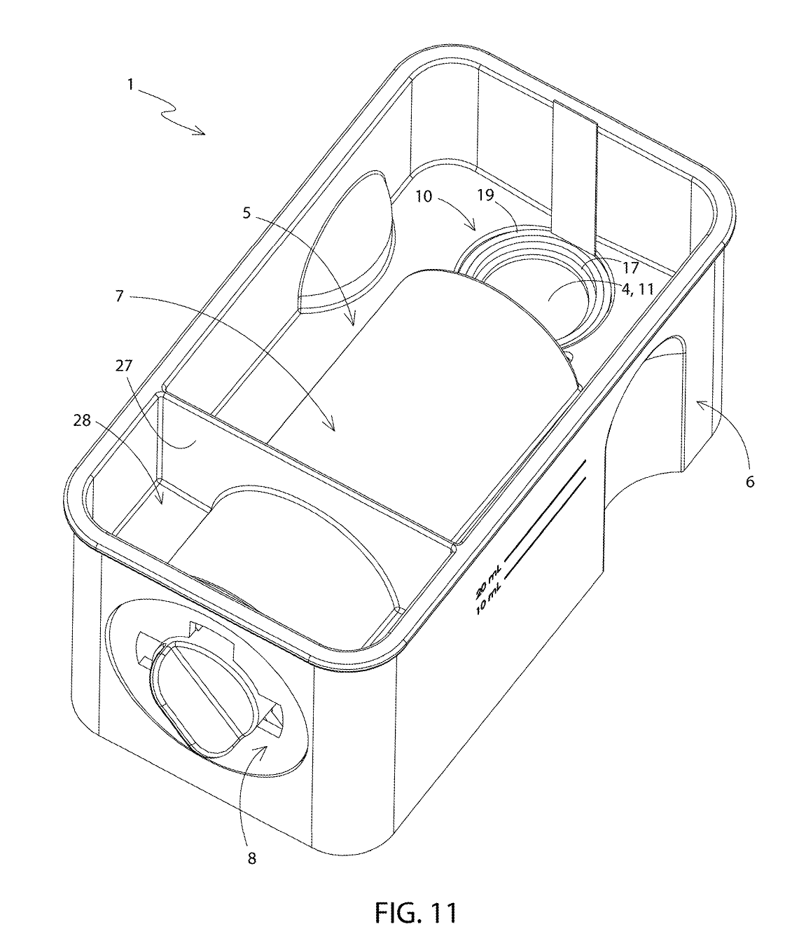

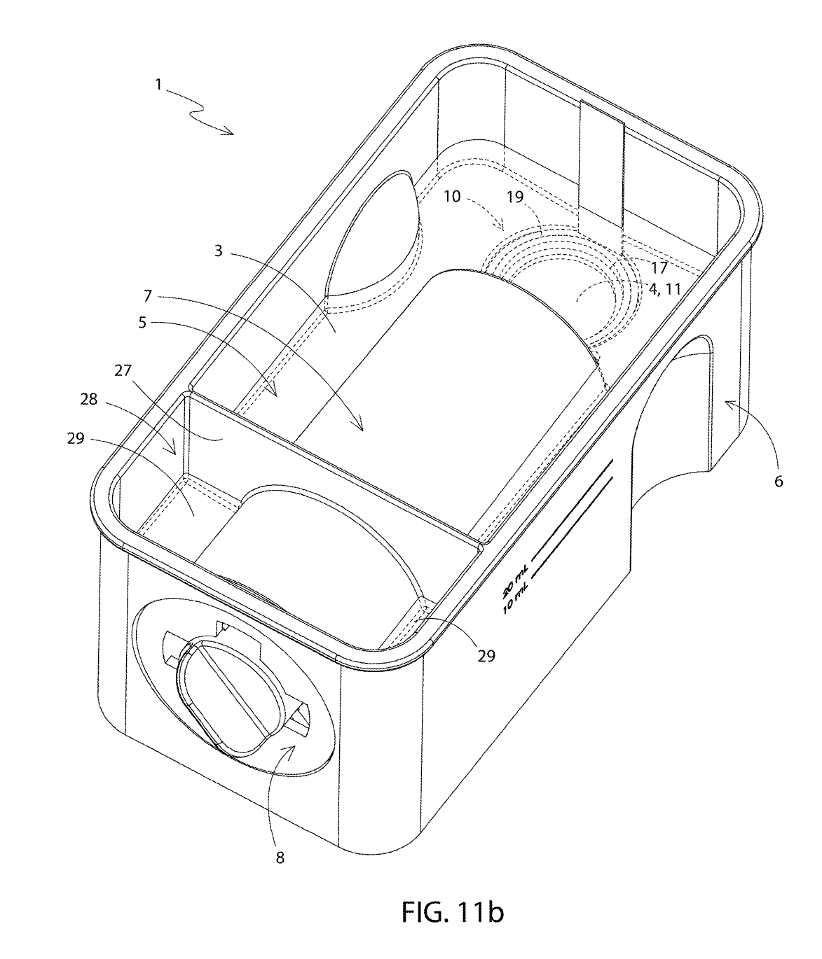

FIG. 6 shows an expanded view of a collection assembly (10). It is understood that the collection assembly (10) and the various parts making up the collection assembly (10) can be a variety of shapes and sizes.

The port (16) is at the bottom of the collection assembly (10). Anything in the sample that did not bind to any of the pre-solid substrates (22) or solid substrates (4) (filter, (11)) will flow through the port (16) into the second chamber (6) of the analyzer (1). The size of the opening in the port (16) can affect the flow rate in which sample is pulled through into the second chamber (6).

The collection assembly (10) is typically attached to the analyzer (1) such that there is a seal between the collection assembly (10) and the first chamber (5) and second chamber (6). This can be accomplished by a inert sealer (18), such as an O-ring.

The collection assembly (10) typically includes a solid substrate support (19) which can hold or support a solid substrate (4) which is used to support the solid substrate (4). The solid substrate support (19) is typically designed so that it can seal with a sealer (18) on both the above and below a support screen (20). In certain embodiments, the solid substrate (4) can be held against the support screen (20) through the use of a sealer (18) and a solid support lock (21). It is understood that in certain embodiments, the entire collection assembly (10) could be made in all one piece, or each part of the collection assembly (10) can be made separately, or in any combination producing a functional collection assembly (10). When made in separate pieces the pieces are designed to fit together such that a seal can be made which is liquid tight up to 30 lbs of pressure.

The solid substrate (4) rests on top of the solid substrate support (19). The solid substrate is described in further detail below.

A sealer (18) typically sits on top of the solid substrate (4) and acts as a seal. It not only holds the solid substrate in place but prevents the sample from being able to leak around the edges of the solid substrate (4) which would prevent analyte (2) binding to the substrate (4). A tight sealer (18) optionally comprises rubber, silicone, or plastic. Optionally, it is tight enough to seal 30 lbs of vacuum.

There is a solid support lock (21) that fits on top of the solid support (4). The solid support lock (21) fits securely into the solid support (4) by a variety of mechanisms. The solid support lock (21) can twist or screw into the solid support (4) or snap into the solid support, for example. In one embodiment, a second solid support (4) is attached to the top of the solid support lock (21) through for example, a sealer (18), solid substrate support (19), and solid substrate (4, 11). In this way the solid support lock (21) can function as a connector between various collection assemblies (10).

The solid support lock (21) can serve several purposes. In one embodiment, the solid support lock (21) serves to secure the fit of the sealer (18) on top of the solid substrate. In one embodiment, the connector allows the use of multiple solid substrates by allowing another solid substrate support (19) comprising a solid support (4, 11) to be attached on top of the solid support lock (21). Thus, there would be at least two solid substrate supports (19), each holding a solid substrate (4,11) which can be the same or different, that can allow for multiple analyte (2) analyses. In one embodiment, the second solid substrate support comprises a pre-solid substrate (22) to allow for enrichment or subtraction of the sample.

In one embodiment, the disclosed composition comprises at least one, at least two, at least three, at least four or at least five collection assemblies (10) with different or the same solid substrates (4). In one embodiment, the disclosed composition comprises at least one, at least two, at least three, at least four or at least five solid support locks (21).

In one embodiment, an additional piece, a slot blot adapter (24), can be incorporated above the solid substrate (4) and below the sealer (18) and the solid support lock (21). The slot blot adapter (24) is a solid piece of impermeable material with slots (e.g. openings) in it. The sample (3) can only contact the solid substrate (4), beneath the slot blot adapter (24), at the slots therefore analytes are localized to particular areas on the solid substrate (4). The slots can be all one shape and size or a variety of shapes and sizes. In one embodiment, the slot blot adapter (24) contains slots of identical shapes and identical sizes. In one embodiment, the slot blot adapter (24) contains slots of identical shapes but different sizes. In one embodiment, the slot blot adapter (24) contains slots of different shapes but identical sizes. In one embodiment, the slot blot adapter (24) contains slots of different shapes and different sizes.

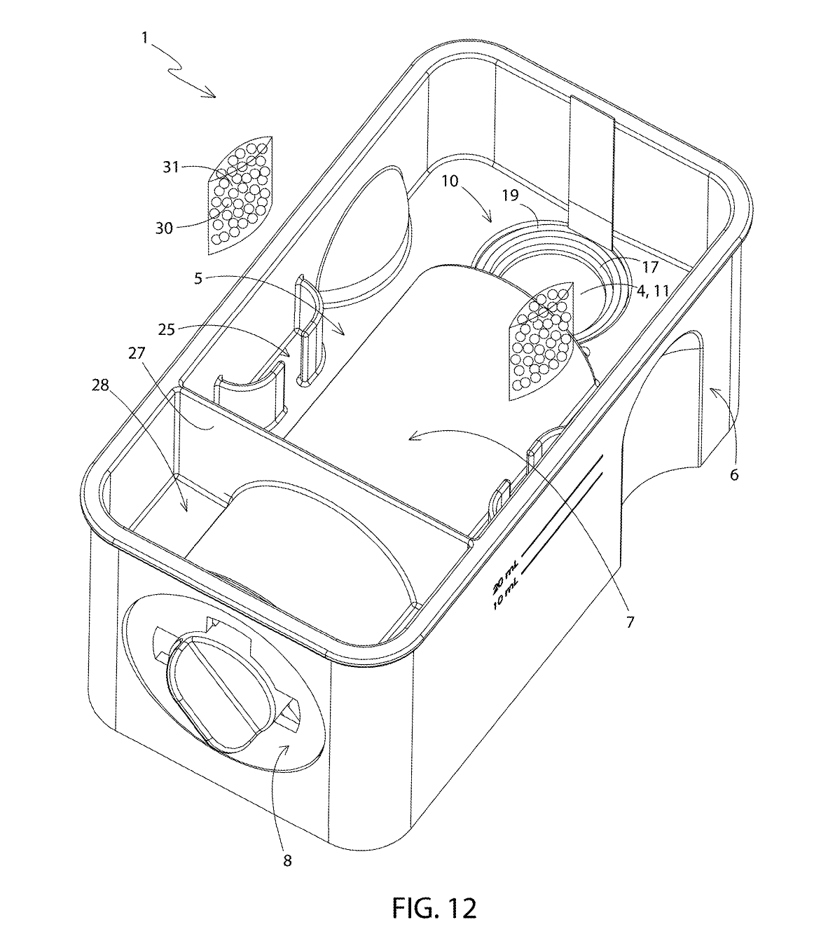

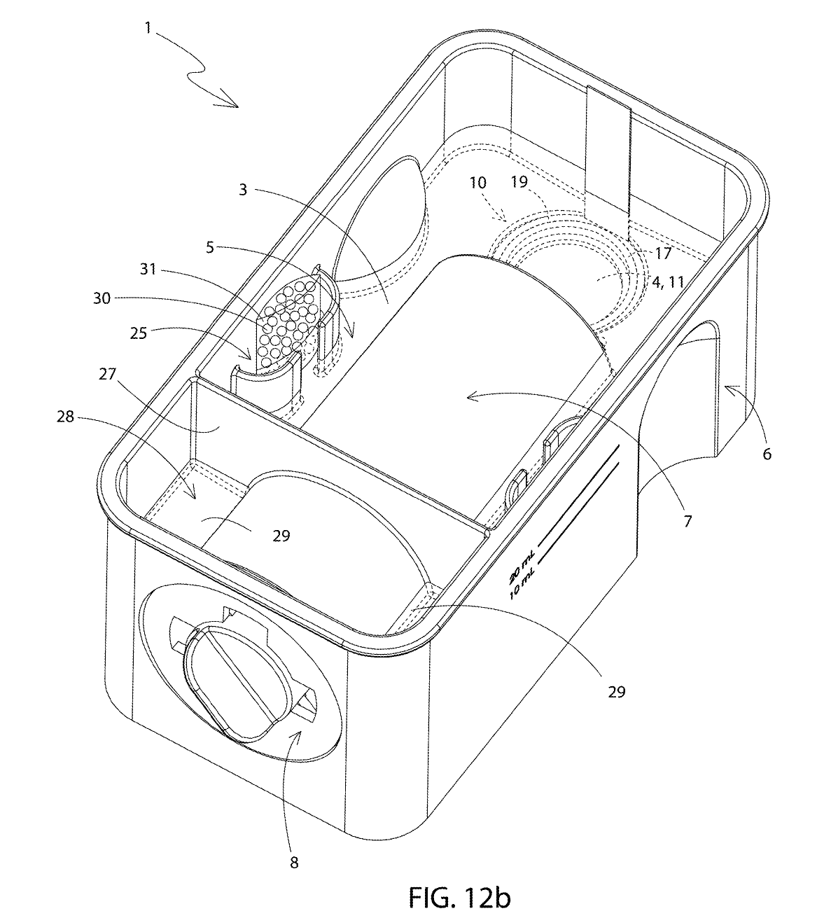

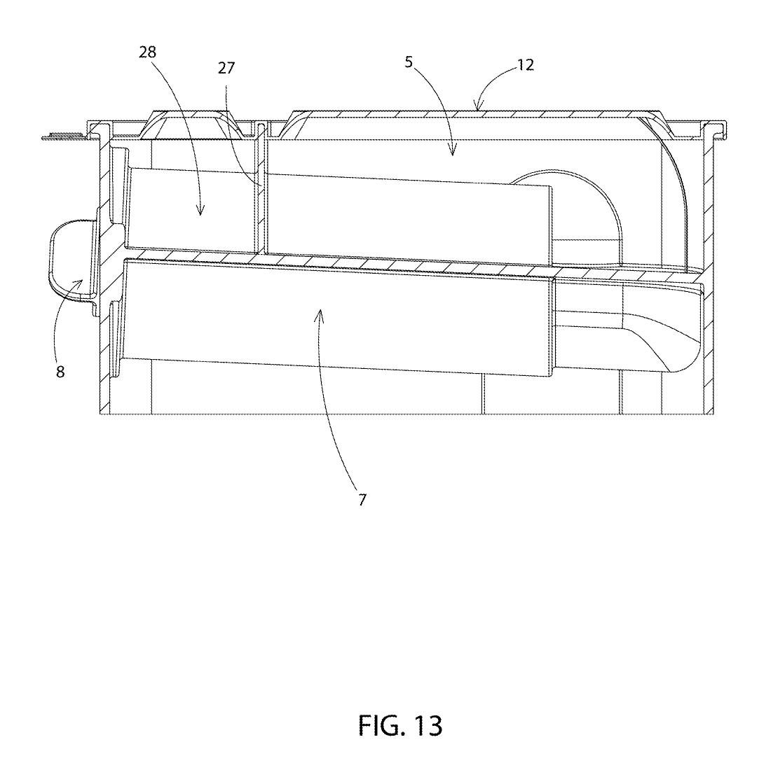

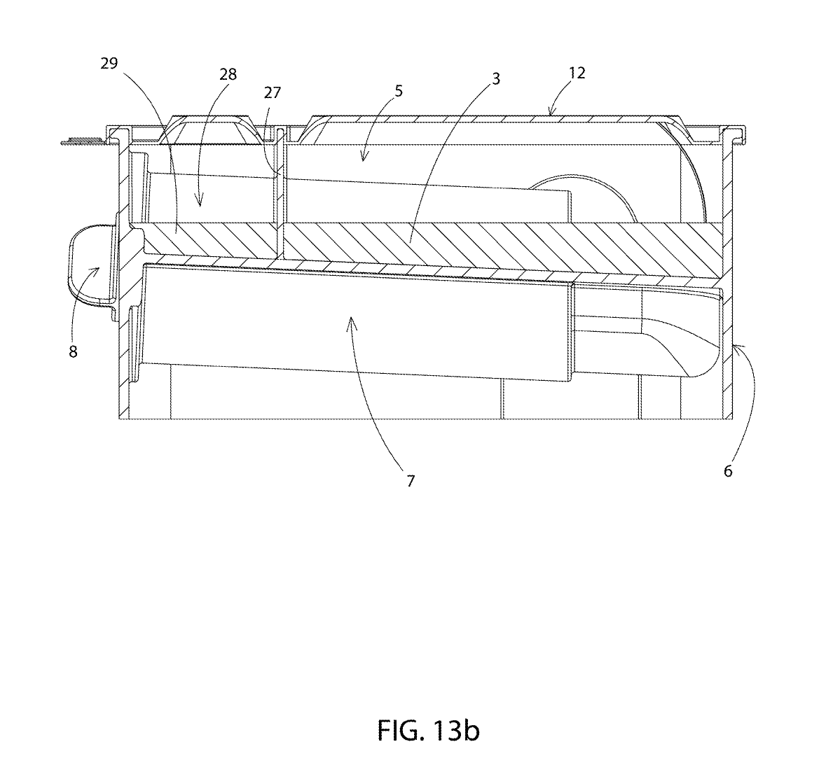

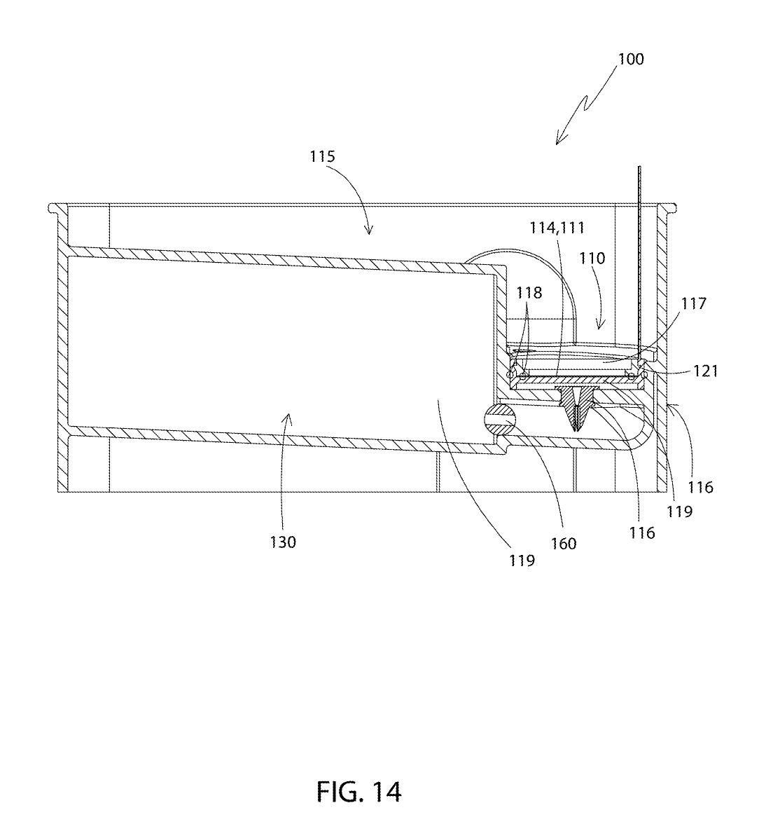

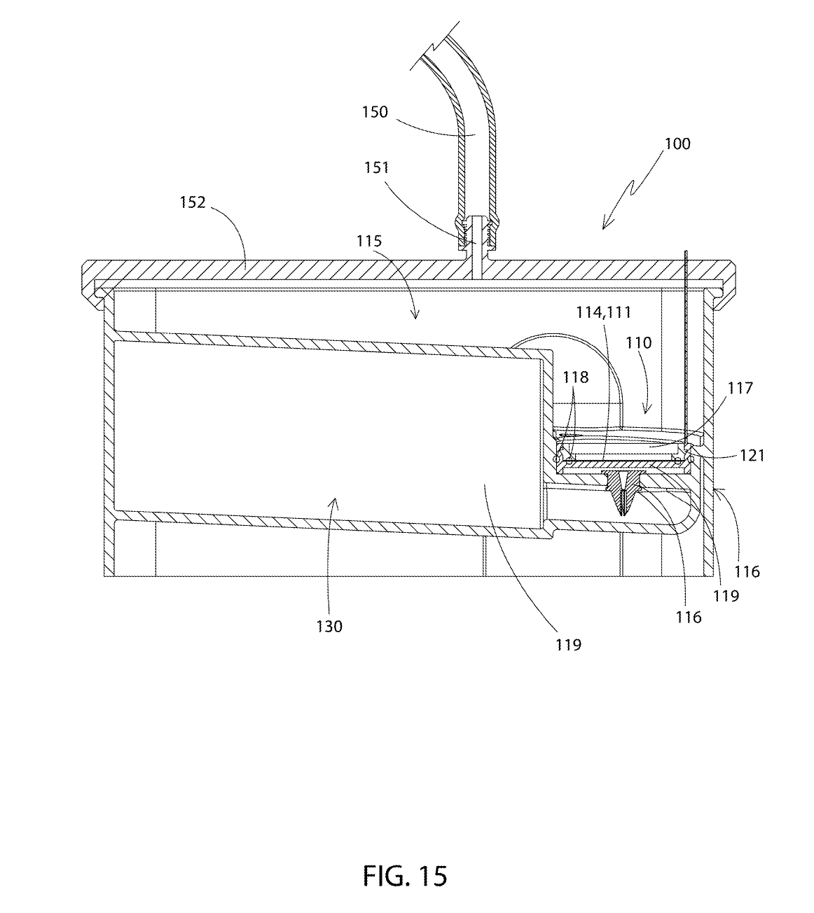

The analyzer can contain a fourth chamber in the first chamber (25) (FIG. 12) which can contain buffering salts, detergents, protease inhibitors, RNAase inhibitors, DNAase inhibitors, antioxidants or other reagents for either the preservation or analysis of the analytes or cells. These reagents are optionally in the form of a tablet or powder contained in a rapidly aqueous soluble (e.g., gelatin film) or porous container. Alternatively, the reagents could be in a liquid form that is added from an external container.

Valve is preferably a separate component from bottom. Preferably, valve is made of an elastomeric material. Such elastomeric materials include, but are not limited to, styrene butadiene copolymers, thermoplastic rubbers, isoprene, EPDM, olefin-based elastomers, acrylic-based elastomers, polyurethane, and silicone-based elastomers. Valve is a self-sealing valve. Once piercing member is removed, valve self seals and closes automatically stopping the transfer of specimen.

In certain embodiments, the vacuum can be “re-set” so that you can continue to pour sample through the same apparatus until all volume has been “sucked” through the membrane.

In certain embodiments it is possible to have an adjustable flow rate. In certain embodiments, flow rate will affect the binding of the analytes to the membrane. If the flow rate is too fast binding may not occur, if too slow non-specific binding may occur. The flow rate can be adjusted by the speed in which the spring pushes out or by the size of the hole in piece 1 in which the “flow through” is pulled through.

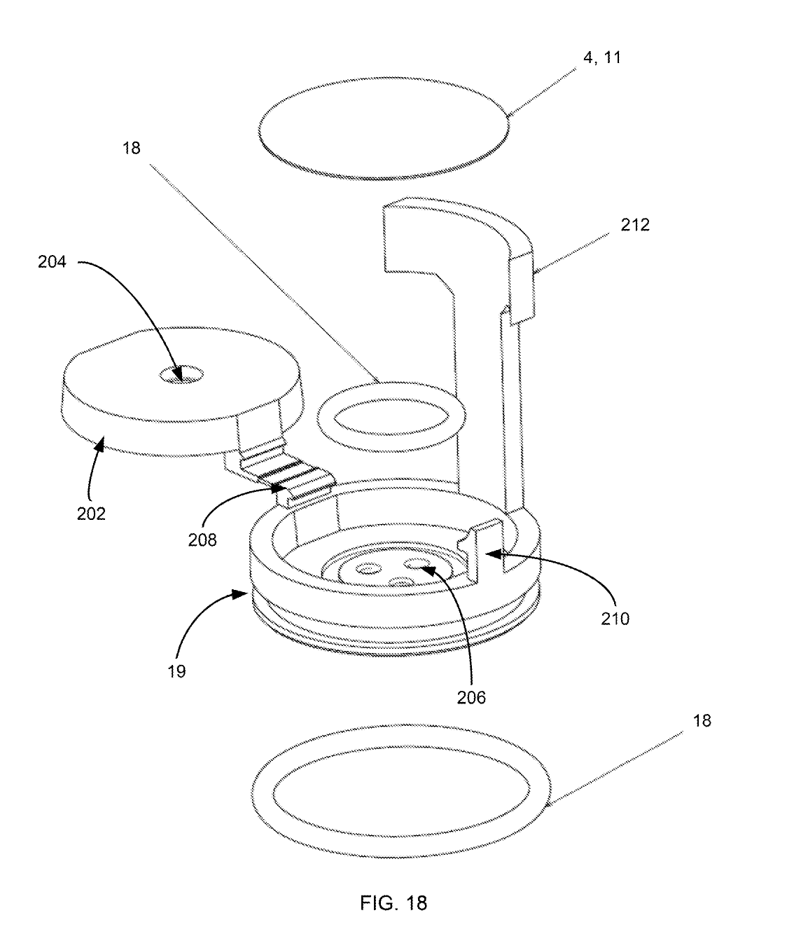

FIG. 18 illustrates an example collection assembly. The collection assembly can be used with the analyzer described herein, and, for example, in execution of the methods described herein. The collection assembly includes a substrate support 19 into which a solid substrate (4, 11), e.g. a filter, is positioned. The bottom of the substrate support includes at least one opening 206. The at least one opening 206 is configured to allow the passage of fluid. In operation, fluid may pass, or is drawn, through the solid substrate when it is positioned the substrate support 19 which results in the concentration of substances, e.g. analytes, for detection on the solid substrate. After passing through the solid substrate, the fluid may continue to flow out of the collection assembly through the at least one opening 206. This configuration allows sustained fluid flow through the collection assembly including the solid substrate. Because a volume of fluid is drawn through the filter over time, the substance or substances for detection are concentrated on the solid substrate.

The collection assembly illustrated in FIG. 18 also includes a concentrator apparatus 202 which, when in operation, limits the surface area of the solid substrate though which fluid flows. By limiting the surface of the solid substrate through which fluid flows, the concentrator further concentrates substances for detection on the portions where fluid is allowed to flow through the filter. Optionally, the concentrator 202 focuses the flow of fluid onto a specific portion of the filter, wherein the portion of the filter onto which the flow is directed is smaller in surface area than the surface area of the full filter. For example, the concentrator may reduce the surface area of the filter that is contacted by fluid by 1% or more. In some examples, the concentrator has a body which defines a conduit 204 that allows fluid to flow through to the filter, while portions of the concentrator peripheral to the conduit impede or eliminate fluid flow to the filter. Optionally, the conduit has a diameter of 1 mm or greater and has a diameter less than the diameter of the filter which is used. Optionally, the conduit has a diameter of 1 mm, 2 mm, 3 mm, 4 mm, 5 mm, 6 mm, 7 mm, 8 mm, 9 mm, 10 mm or any size there between. The conduit, however, is not limited in cross sectional shape and a variety of regular and irregular shaped conduits can be used.

Moreover, other example collection assemblies optionally include a plurality of conduits each focusing a portion of the total fluid flowed through the filter onto a distinct portion of the filter or onto distinct portions of multiple separate filters. In this regard, the total volume of fluid passed through the filter can result in the accumulation of substances for detection at different locations of one filter or at locations of multiple filters. Optionally, each filter, or the locations of the filter, onto which each conduit focuses fluid, is configured to accumulate a unique substrate from the other filters or locations. In this regard, multiple substrates can optionally be accumulated using a single collection assembly. In the collection assemblies described, a sealer 18, such as an o-ring may be positioned beneath the filter and in alignment with the conduit 204. If multiple conduits are used, a corresponding number of sealers may be used, with each sealer helping isolate the reduced area of the filter exposed to fluid by a given conduit.

The size of the conduits may be varied depending, for example, depending on the expected concentration of the substance for detection in the starting solution. For example, if the substance is expected to be very dilute in the starting solution, a smaller conduit can be used. The smaller conduit provides more reduction is surface area exposure than a larger conduit such that dilute analytes can be more concentrated on the solid substrate (e.g. filter). In addition, the size of the conduit may be varied depending on other factors such as the desired flow rate through the filter.

Optionally, the collection assembly includes a hinge mechanism 208 and a hook mechanism for positioning and securing the concentrator 202 over the filter.

Optionally, the collection assembly includes a handle 212 for grasping to improve removal and insertion of the collection assembly into the and out of the analyzer device.

### B. Methods

1. Collection

i. Sample Collection

The disclosed analyzers can be used in methods which involve sample collection. In the disclosed methods, a sample can be obtained from a subject or environment. A biological sample can be collected from the subject in the same laboratory, office, or area, in which the method is going to be performed or in another center and later sent to the laboratory for study. The samples can be collected by any conventional method, as can the tissue samples; examples include but are not limited to said samples being obtained with a syringe or by expelling sample into a container (e.g. urinating or spitting into container). Other samples may be collected in the operation rooms or radiology facility for example CT guided aspirate or fine needle aspirate. The subject can collect their own sample or another person (e.g. doctor or nurse) can collect the sample. The samples can be obtained from individuals (patients) previously diagnosed with a disease or disorder to be tested as follow-up management, or from individuals not diagnosed with said disorder (e.g. healthy subjects), or from patients under treatment for said disorder, or from patients who have previously been treated. Samples can be obtained from individuals and used for detection of drugs or steroids.

Samples can be pre-collected in other containers and then transferring the sample from the collection container to the analyzer. For example, urine specimens can be collected in pediatric urine collection bags and then transferred to the analyzer. The transfer of the sample can be performed a variety of ways which would be known to the skilled artisan. Non-limiting examples of transfer mechanisms include pouring, pipetting, funneling or using any other type of transfer vessel.

ii. Analyte Collection

The samples obtained in the disclosed methods and analyzers comprise analytes which can be detected with a variety of tests and can, among other things, serve to diagnose or monitor disease and identify the presence of drugs or microorganisms.

How analytes are collected is dependent on the detection method to be used. In the disclosed methods, analytes are collected in or transferred to the disclosed analyzer (1). The analytes can be collected on a variety of solid substrates.

In one embodiment of the disclosed methods, analyte collection is dependent on the spring activated piston (8) that causes suction in the second chamber (6) of the analyzer (1) and forces the sample through the solid substrate (4) which allows for binding/collection of the analytes (2) on the solid substrate (4).

In one embodiment, all analytes within a sample are collected on a single solid substrate or on multiple solid substrates. Collection on multiple solid substrates allows for solid substrates with different concentrations of analytes. For example, if three solid substrates are used, the first solid substrate (contacts sample first) would collect/bind as many analytes as possible, the next solid substrate would collect/bind any analytes that did not bind to the first solid substrate, and the last solid substrate would collect/bind any analytes remaining in the sample that were unable to bind to the first two solid substrates. Therefore, the first solid substrate would most likely have the highest concentration of analytes while the last solid substrate would have the lowest concentration of analytes.

In one embodiment, unwanted analytes or contaminants are removed prior to the sample contacting the solid substrate. The removal of unwanted analytes or contaminants can be achieved with a pre-solid substrate. A pre-solid substrate can be placed above the solid substrate and would collect/bind the unwanted analytes or contaminants prior to the sample contacting the solid substrate. The pre-solid substrate can be used as a subtraction method for collecting unwanted analytes from the sample which would increase to wanted analytes in the sample. The pre-solid substrate can be used as a pre-filter for collecting contaminants such as large particles from the sample.

Often the analytes are isolated because of binding to a capture tag, which is attached to the solid substrate. In other embodiments the analyte can be bound or retained by the solid substrate itself.

In one embodiment, only specific analytes are collected (described below in capture arrays and capture tags) on a single solid substrate or multiple solid substrates. Collection of specific analytes on multiple solid substrates allows one to use each solid substrate in a different analysis and thus study several things at one time. For example, if two solid substrates are used, the first solid substrate can be specific for nucleic acids and thus, any nucleic acid in the sample will collect/bind to the first solid substrate while all other analytes pass through to the second solid substrate. The second solid substrate may be specific for an autoimmune antigen and thus, that particular antigen will collect/bind to the second solid substrate and all other analytes will pass through. An analysis of the collected nucleic acids can be performed and an analysis of the autoimmune antigen can be performed. This can be extremely useful particularly if sample is scarce because multiple assays can be performed on the same sample.

In one embodiment, each filter can allow for capture of specific analytes. In one embodiment, monoclonal or polyclonal antibodies specific to the analyte can be immobilized on the filter. As the sample (i.e. urine) passes through the filter, analyte can bind to the antibody present on the filter. Controlled flow rate can allow analyte to be removed from the urine solution, thus allowing concentration of the analyte. Selection of appropriate flow rate, membrane type, and pore size are within the knowledge of those skilled in the art.

In another embodiment, monoclonal or polyclonal antibodies can be added to the buffered urine sample prior to release of the spring activated piston device. As the antibody-analyte complex moves from the first chamber to the second chamber, it will be concentrated on the filter present in the collection assembly.

Once the analytes are isolated, or bound, or interacting with the solid substrate, or for example, a capture tag associated with the solid substrate, the analytes are often detected using various detection mechanisms.

2. Detection

Any analyte, including the various compounds and compositions disclosed herein, can be detected. The detection of analytes as disclosed herein, typically will include the use of a detection agent and/or capture tag. For example, proteins and nucleic acids can be detected. Detection of analytes can be by, for example, detecting the level, amount, presence, or a combination, of the analyte in a sample or assay. Detection of the disclosed compounds and compositions can be accomplished in any of a variety of ways and using any of a variety of techniques. Many such detection techniques are known and can be readily adapted for use in the disclosed methods. In most cases, the disclosed methods do not depend on particular techniques of detection. However, certain techniques and reagents are useful for detecting different types of compounds or compositions. Those of skill in the art are aware of the selection of particular techniques for the detection of particular compounds and compositions. Detection can, but need not, involve an element of quantitation.

It is understood that in all cases where feasable, the detection methods disclosed herein, can be used directly with or in the analyzer, such as having detection occur directly on the solid substrate, or the methods can be performed in subsequent operations on a sample processed within a disclosed analyzer.

Detection can be of a class of compounds or compositions or of specific compounds or compositions. Although the disclosed methods generally involve detection of specific compounds and compositions, such as specific proteins, the disclosed methods can also be used to detect classes or groups of compounds or compositions, generally via one or more common properties. In other forms, multiple different specific compounds and/or compositions can be detected. Such detection accomplished in the same assay or run (or in separate assays of runs performed at the same time), can generally be referred to as multiplex detection.

Detection can involve or include, for example, measuring, sequencing, identification, or a combination. Measurement is useful for determining abundances and levels of an analyte in a sample. Sequencing is useful for identifying nucleic acid sequences and molecules. Uses and forms of detection in the context of the disclosed methods are also described elsewhere herein.

Also disclosed in the present methods, is the use of control samples. Positive and negative controls are essential in almost every assay. Those of skill in the art would understand what controls to use for different detection techniques and how to incorporate those controls into each assay.

Detection can involve a variety of forms. For example, antibody based assays, arrays, PCR, cytology assays, and lateral flow assays.

The detection of analytes in the disclosed methods is dependent on the sensitivity or detection limit of each individual detection method. In most detection methods, such as dipping a dipstick test into container of urine or direct urination onto a dipstick test, a primary limitation can be the binding of the analyte to the dipstick. This limitation occurs because nothing is forcing the analytes to come into direct contact with the dipstick test. For instance, when dipping a dipstick test into a container of urine, the analyte can be anywhere in the container and even gently agitation does not guarantee that the dipstick test with contact analytes in every area of the urine. Another example, direct urination on a dipstick test, can be a limitation of analyte binding. The volume of urine in contact with the dipstick is much lower than the volume of urine forced into contact with the solid substrate in the disclosed analyzer. Direct urination can not only lead to some of the urine never contacting the dipstick test but also, the pressure with which the urine hits the dipstick test and the amount of time in which the urine is in contact with the dipstick test can affect the analyte binding. In the disclosed compositions and methods, these factors are considered thus reducing or eliminating the limitation of poor analyte binding.

In one embodiment antibodies can be added to the sample prior to release of the spring activated piston device. As the antibody-analyte complex moves form the first chamber to the second chamber, it can be concentrated to a particular area of the membrane/filter of the collection assembly. An enzyme can be present on the membrane that will metabolize or interact with a conjugate on the antibody and generate a color as a method of detection.

3. Nucleic Acid Detection and Analysis

In many instances the methods can involve a nucleic analysis activity, step, or steps. This activity can be performed in conjunction with the isolation and analysis of the sample, such as a body fluid, for example, or it can be performed on at a later time on the isolated analytes from the method of using the disclosed analyzers. There are variety of actions that can be performed including polymerase chain reaction, reverse transcription PCR, real time PCR, hybridization-based detection, chemiluminescent detection, UV spectroscopy and ethidium bromide staining. Fluorimetric Quantitation (e.g., DNA-binding dye Hoechst 33258)

i. Polymerase Chain Reaction

Polymerase chain reaction, PCR, can be used for disease diagnosis, drug screening, genotyping individuals, phylogenetic classification, environmental surveillance, parental and forensic identification amongst other uses. Further, nucleic acids can be obtained from any source. For example, a test sample can be biological and/or environmental samples. Biological samples may be derived from human, other animals, or plants, body fluid, solid tissue samples, tissue cultures or cells derived there from and the progeny thereof, sections or smears prepared from any of these sources, or any other samples suspected to contain the target nucleic acids. Exemplary biological samples are body fluids as discussed herein. Environmental samples are derived from environmental material including but not limited to soil, water, sewage, cosmetic, agricultural, industrial samples, air filter samples, and air conditioning samples.

PCR reaction conditions typically comprise either two or three step cycles. Two step cycles have a denaturation step followed by a hybridization/elongation step. Three step cycles comprise a denaturation step followed by a hybridization step during which the primer hybridizes to the strands of DNA, followed by a separate elongation step. The polymerase reactions are incubated under conditions in which the primers hybridize to the target sequences and are extended by a polymerase. The amplification reaction cycle conditions are selected so that the primers hybridize specifically to the target sequence and are extended.

Successful PCR amplification requires high yield, high selectivity, and a controlled reaction rate at each step. Yield, selectivity, and reaction rate generally depend on the temperature, and optimal temperatures depend on the composition and length of the polynucleotide, enzymes and other components in the reaction system. In addition, different temperatures may be optimal for different steps. Optimal reaction conditions may vary, depending on the target sequence and the composition of the primer. PCR reactions are usually performed in thermal cyclers which can be programmed by selecting temperatures to be maintained, time durations for each cycle, number of cycles, rate of temperature change and the like.

Primers for amplification reactions can be designed according to known algorithms. For example, algorithms implemented in commercially available or custom software can be used to design primers for amplifying desired target sequences. Typically, primers can range are from least 12 bases, more often 15, 18, or 20 bases in length but can range up to 50+ bases in length. Primers are typically designed so that all of the primers participating in a particular reaction have melting temperatures that are within at least 5° C., and more typically within 2° C. of each other. Primers are further designed to avoid priming on themselves or each other. Primer concentration should be sufficient to bind to the amount of target sequences that are amplified so as to provide an accurate assessment of the quantity of amplified sequence. Those of skill in the art will recognize that the amount of concentration of primer will vary according to the binding affinity of the primers as well as the quantity of sequence to be bound. Typical primer concentrations will range from 0.01 μM to 0.50 μM.

ii. Reverse Transcription PCR

Revere transcription refers to the process by which mRNA is copied to cDNA by a reverse transcriptase (such as Moloney murine leukemia virus (MMLV) transcriptase Avian myeloblastosis virus (AMV) transcriptase or a variant thereof) composed using an oligo dT primer or a random oligomers (such as a random hexamer or octamer). In real-time PCR, a reverse transcriptase that has an endo H activity is typically used. This removes the mRNA allowing the second strand of DNA to be formed. Reverse transcription typically occurs as a single step before PCR. In one embodiment the RT reaction is performed in a thermal cycler by incubating an RNA sample, a transcriptase, the necessary buffers and components for about an hour at about 37° C., followed by incubation for about 15 minutes at about 45° C. followed by incubation at about 95° C. The cDNA product is then removed and used as a template for PCR. In an alternative embodiment the RT step is followed sequentially by the PCR step, for example in a one-step PCR protocol. In this embodiment all of the reaction components are present in the sample vessel for the RT step and the PCR step. However, the DNA polymerase is blocked from activity until it is activated by an extended incubation at 95° C. for 5-10 minutes. In one embodiment the DNA polymerase is blocked from activity by the presence of a blocking antibody that is permanently inactivated during the 95° C. incubation step.

iii. Real Time PCR

In molecular biology, real-time polymerase chain reaction, also called quantitative real time polymerase chain reaction (QRT-PCR) or kinetic polymerase chain reaction, is used to simultaneously quantify and amplify a specific part of a given DNA molecule. It is used to determine whether or not a specific sequence is present in the sample; and if it is present, the number of copies in the sample. It is the real-time version of quantitative polymerase chain reaction (Q-PCR), itself a modification of polymerase chain reaction.

The procedure follows the general pattern of PCR, but the DNA is quantified after each round of amplification; this is the “real-time” aspect of it. In one embodiment the DNA is quantified by the use of fluorescent dyes that intercalate with double-strand DNA. In an alternative embodiment modified DNA oligonucleotide probes that fluoresce when hybridized with a complementary DNA are used to quantify the DNA.

In another embodiment real-time polymerase chain reaction is combined with reverse transcription polymerase chain reaction to quantify low abundance messenger RNA (mRNA), enabling a researcher to quantify relative gene expression at a particular time, or in a particular cell or tissue type.

In certain embodiments, the amplified products are directly visualized with detectable label such as a fluorescent DNA-binding dye. In one embodiment the amplified products are quantified using an intercalating dye, including but not limited to SYBR green, SYBR blue, DAPI, propidium iodine, Hoeste, SYBR gold, ethidium bromide, acridines, proflavine, acridine orange, acriflavine, fluorcoumanin, ellipticine, daunomycin, chloroquine, distamycin D, chromomycin, homidium, mithramycin, ruthenium polypyridyls, anthramycin. For example, a DNA binding dye such as SYBR Green binds all double stranded (ds)DNA and an increase in fluorescence intensity is measured, thus allowing initial concentrations to be determined A standard PCR reaction cocktail is prepared as usual, with the addition of fluorescent dsDNA dye and added to a sample. The reaction is then run in a thermal cycler, and after each cycle, the levels of fluorescence are measured with a camera. The dye fluoresces much more strongly when bound to the dsDNA (i.e. PCR product). Because the amount of the dye intercalated into the double-stranded DNA molecules is typically proportional to the amount of the amplified DNA products, one can conveniently determine the amount of the amplified products by quantifying the fluorescence of the intercalated dye using the optical systems of the present invention or other suitable instrument in the art. When referenced to a standard dilution, the dsDNA concentration in the PCR can be determined In some embodiments the results obtained for a sequence of interest may be normalized against a stably expressed gene (“housekeeping gene”) such as actin, GAPDH, or 18s rRNA.

The term “label” or “dye” refers to any substance which is capable of producing a signal that is detectable by visual or instrumental means. Various labels suitable for use in the present invention include labels which produce signals through either chemical or physical means, such as fluorescent dyes, chromophores, electrochemical moieties, enzymes, radioactive moieties, phosphorescent groups, fluorescent moieties, chemiluminescent moieties, or quantum dots, or more particularly, radiolabels, fluorophore-labels, quantum dot-labels, chromophore-labels, enzyme-labels, affinity ligand-labels, electromagnetic spin labels, heavy atom labels, probes labeled with nanoparticle light scattering labels or other nanoparticles, fluorescein isothiocyanate (FITC), TRITC, rhodamine, tetramethylrhodamine, R-phycoerythrin, Cy-3, Cy-5, Cy-7, Texas Red, Phar-Red, allophycocyanin (APC), probes such as Taqman probes, TaqMan Tamara probes, TaqMan MGB probes or Lion probes (Biotools), fluorescent dyes such as Sybr Green I, Sybr Green II, Sybr gold, CellTracker Green, 7-AAD, ethidium homodimer I, ethidium homodimer II, ethidium homodimer III or ethidium bromide, epitope tags such as the FLAG or HA epitope, and enzyme tags such as alkaline phosphatase, horseradish peroxidase, I.sup.2-galactosidase, alkaline phosphatase, β-galactosidase, or acetylcholinesterase and hapten conjugates such as digoxigenin or dinitrophenyl, or members of a binding pair that are capable of forming complexes such as streptavidin/biotin, avidin/biotin, heparin/heparin binding proteins or an antigen/antibody complex including, for example, rabbit IgG and anti-rabbit IgG; fluorophores, a molecule containing a fluorescent moiety, such as umbelliferone, fluorescein, fluorescein isothiocyanate, rhodamine, tetramethyl rhodamine, eosin, green fluorescent protein, erythrosin, coumarin, methyl coumarin, pyrene, malachite green, stilbene, lucifer yellow, Cascade Blue, dichlorotriazinylamine fluorescein, dansyl chloride, phycoerythrin, fluorescent lanthanide complexes such as those including Europium and Terbium, Cy3, Cy5, molecular beacons and fluorescent derivatives thereof, a luminescent material such as luminol; light scattering or plasmon resonant materials such as gold or silver particles or quantum dots; or radioactive material including .sup.14C, .sup.123I, .sup.124I, .sup.125I, .sup.131I, Tc99m, .sup.35S or .sup.3H; or spherical shells, and probes labeled with any other signal generating label known to those of skill in the art. For example, detectable molecules include but are not limited to fluorophores as well as others known in the art as described, for example, in Principles of Fluorescence Spectroscopy, Joseph R. Lakowicz (Editor), Plenum Pub Corp, 2nd edition (July 1999) and the 6.sup.th Edition of the Molecular Probes Handbook by Richard P. Hoagland.

Intercalating dyes are also detected in these assays. Examples include but are not limited to phenanthridines and acridines (e.g., ethidium bromide, propidium iodide, hexidium iodide, dihydroethidium, ethidium homodimer-1 and -2, ethidium monoazide, and ACMA); some minor grove binders such as indoles and imidazoles (e.g., Hoechst 33258, Hoechst 33342, Hoechst 34580 and DAPI); and miscellaneous nucleic acid stains such as acridine orange (also capable of intercalating), 7-AAD, actinomycin D, LDS751, and hydroxystilbamidine. All of the aforementioned nucleic acid stains are commercially available from suppliers such as Molecular Probes, Inc.

Still other examples of nucleic acid stains include the following dyes from Molecular Probes: cyanine dyes such as SYTOX Blue, SYTOX Green, SYTOX Orange, POPO-1, POPO-3, YOYO-1, YOYO-3, TOTO-1, TOTO-3, JOJO-1, LOLO-1, BOBO-1, BOBO-3, PO-PRO-1, PO-PRO-3, BO-PRO-1, BO-PRO-3, TO-PRO-1, TO-PRO-3, TO-PRO-5, JO-PRO-1, LO-PRO-1, YO-PRO-1, YO-PRO-3, PicoGreen, OliGreen, RiboGreen, SYBR Gold, SYBR Green I, SYBR Green II, SYBR DX, SYTO-40, -41, -42, -43, -44, -45 (blue), SYTO-13, -16, -24, -21, -23, -12, -11, -20, -22, -15, -14, -25 (green), SYTO-81, -80, -82, -83, -84, -85 (orange), SYTO-64, -17, -59, -61, -62, -60, -63 (red). Other detectable markers include chemiluminescent and chromogenic molecules, optical or electron density markers, etc.

As noted above in certain embodiments, labels comprise semiconductor nanocrystals such as quantum dots (i.e., Qdots), described in U.S. Pat. No. 6,207,392. Qdots are commercially available from Quantum Dot Corporation. The semiconductor nanocrystals useful in the practice of the invention include nanocrystals of Group II-VI semiconductors such as MgS, MgSe, MgTe, CaS, CaSe, CaTe, SrS, SrSe, SrTe, BaS, BaSe, BaTe, ZnS, ZnSe, ZnTe, CdS, CdSe, CdTe, HgS, HgSe, and HgTe as well as mixed compositions thereof; as well as nanocrystals of Group III-V semiconductors such as GaAs, InGaAs, InP, and InAs and mixed compositions thereof. The use of Group IV semiconductors such as germanium or silicon, or the use of organic semiconductors, may also be feasible under certain conditions. The semiconductor nanocrystals may also include alloys comprising two or more semiconductors selected from the group consisting of the above Group III-V compounds, Group II-VI compounds, Group IV elements, and combinations of same.

In addition to various kinds of fluorescent DNA-binding dye, other luminescent labels such as sequence specific probes can be employed in the amplification reaction to facilitate the detection and quantification of the amplified product. Probe based quantitative amplification relies on the sequence-specific detection of a desired amplified product. Unlike the dye-based quantitative methods, it utilizes a luminescent, target-specific probe (e.g., TaqMan® probes) resulting in increased specificity and sensitivity. Methods for performing probe-based quantitative amplification are well established in the art and are taught in U.S. Pat. No. 5,210,015.

In another embodiment fluorescent oligonucleotide probes are used to quantify the DNA. Fluorescent oligonucleotides (primers or probes) containing base-linked or terminally-linked fluors and quenchers are well-known in the art. They can be obtained, for example, from Life Technologies (Gaithersburg, Md.), Sigma-Genosys (The Woodlands, Tex.), Genset Corp. (La Jolla, Calif.), or Synthetic Genetics (San Diego, Calif.). Base-linked fluors are incorporated into the oligonucleotides by post-synthesis modification of oligonucleotides that are synthesized with reactive groups linked to bases. One of skill in the art will recognize that a large number of different fluorophores are available, including from commercial sources such as Molecular Probes, Eugene, Oreg. and other fluorophores are known to those of skill in the art. Useful fluorophores include: fluorescein, fluorescein isothiocyanate (FITC), carboxy tetrachloro fluorescein (TET), NHS-fluorescein, 5 and/or 6-carboxy fluorescein (FAM), 5-(or 6-iodoacetamidofluorescein, 5-{[2(and 3)-5-(Acetylmercapto)-succinyl]amino}fluorescein (SAMSA-fluorescein), and other fluorescein derivatives, rhodamine, Lissamine rhodamine B sulfonyl chloride, Texas red sulfonyl chloride, 5 and/or 6 carboxy rhodamine (ROX) and other rhodamine derivatives, coumarin, 7-amino-methyl-coumarin, 7-Amino-4-methylcoumarin-3-acetic acid (AMCA), and other coumarin derivatives, BODIPY™ fluorophores, Cascade Blue™, fluorophores such as 8-methoxypyrene-1,3,6-trisulfonic acid trisodium salt, Lucifer yellow fluorophores such as 3,6-Disulfonate-4-amino-naphthalimide, phycobiliproteins derivatives, Alexa fluor dyes (available from Molecular Probes, Eugene, Oreg.) and other fluorophores known to those of skill in the art. For a general listing of useful fluorophores, see also Hermanson, G. T., BIOCONJUGATE TECHNIQUES (Academic Press, San Diego, 1996).

Embodiments using fluorescent reporter probes produce accurate and reliable results. Sequence specific RNA or DNA based probes are used to specifically quantify the probe sequence and not all double stranded DNA. This also allows for multiplexing—assaying for several genes in the same reaction by using specific probes with different-colored labels.

In one embodiment a RNA based probe with a fluorescent reporter and a quencher held in adjacent positions is used. The close proximity of the reporter to the quencher prevents its fluorescence, it is only after the breakdown of the probe that the fluorescence is detected. This process depends on the 5′ to 3′ exonuclease activity of the polymerase used in the PCR reaction cocktail.

Typically, the reaction is prepared as usual, with the addition of the sequence specific labeled probe the reaction commences. After denaturation of the DNA the labeled probe is able to bind to its complementary sequence in the region of interest of the template DNA. When the PCR reaction is heated to the proper extension temperature by the liquid metal or thermally conductive fluid block, the polymerase is activated and DNA extension proceeds. As the polymerization continues it reaches the labeled probe bound to the complementary sequence of DNA. The polymerase breaks the RNA probe into separate nucleotides, and separates the fluorescent reporter from the quencher. This results in an increase in fluorescence as detected by the optical assembly. As PCR progresses more and more of the fluorescent reporter is liberated from its quencher, resulting in a well defined geometric increase in fluorescence. This allows accurate determination of the final, and initial, quantities of DNA.

iv. In Situ Hybridization

In situ hybridization (ISH) is a type of hybridization that uses a labeled complementary DNA or RNA strand as a probe to localize a specific DNA or RNA sequence in a portion or section of tissue (in situ), or, if the tissue is small enough, the entire tissue (whole mount ISH). DNA ISH can be used to determine the structure of chromosomes. RNA ISH is used to measure and localize mRNAs and other transcripts within tissue sections or whole mounts. Sample cells and tissues are usually treated to fix the target transcripts in place and to increase access of the probe. The probe hybridizes to the target sequence at elevated temperature, and then the excess probe is washed away. The probe that was labeled with either radio-, fluorescent- or antigen-labeled bases is localized and quantitated in the tissue using either autoradiography, fluorescence microscopy or immunohistochemistry, respectively. ISH can also use two or more probes, labeled with radioactivity or the other non-radioactive labels, to simultaneously detect two or more transcripts. LNA-ISH can be used to measure microRNA.

a. Hybridization

The term hybridization typically means a sequence driven interaction between at least two nucleic acid molecules, such as a primer or a probe and a gene. Sequence driven interaction means an interaction that occurs between two nucleotides or nucleotide analogs or nucleotide derivatives in a nucleotide specific manner. For example, G interacting with C or A interacting with T are sequence driven interactions. Typically sequence driven interactions occur on the Watson-Crick face or Hoogsteen face of the nucleotide. The hybridization of two nucleic acids is affected by a number of conditions and parameters known to those of skill in the art. For example, the salt concentrations, pH, and temperature of the reaction all affect whether two nucleic acid molecules will hybridize. Nucleic acid molecules that hybridize can be said to be hybridized and can be referred to as a hybrid. For example, an RNA/DNA hybrid results from hybridization of an RNA molecule and a DNA molecule having complementary sequence.

Parameters for selective hybridization between two nucleic acid molecules are well known to those of skill in the art. For example, in some embodiments selective hybridization conditions can be defined as stringent hybridization conditions. For example, stringency of hybridization is controlled by both temperature and salt concentration of either or both of the hybridization and washing steps. For example, the conditions of hybridization to achieve selective hybridization may involve hybridization in high ionic strength solution (6×SSC or 6×SSPE) at a temperature that is about 12-25° C. below the Tm (the melting temperature at which half of the molecules dissociate from their hybridization partners) followed by washing at a combination of temperature and salt concentration chosen so that the washing temperature is about 5° C. to 20° C. below the Tm. The temperature and salt conditions are readily determined empirically in preliminary experiments in which samples of reference DNA immobilized on filters are hybridized to a labeled nucleic acid of interest and then washed under conditions of different stringencies. Hybridization temperatures are typically higher for DNA-RNA and RNA-RNA hybridizations. The conditions can be used as described above to achieve stringency, or as is known in the art. (Sambrook et al., Molecular Cloning: A Laboratory Manual, 2nd Ed., Cold Spring Harbor Laboratory, Cold Spring Harbor, N.Y., 1989; Kunkel et al. Methods Enzymol. 1987:154:367, 1987 which is herein incorporated by reference for material at least related to hybridization of nucleic acids). A preferable stringent hybridization condition for a DNA:DNA hybridization can be at about 68° C. (in aqueous solution) in 6×SSC or 6×SSPE followed by washing at 68° C. Stringency of hybridization and washing, if desired, can be reduced accordingly as the degree of complementarity desired is decreased, and further, depending upon the G-C or A-T richness of any area wherein variability is searched for. Likewise, stringency of hybridization and washing, if desired, can be increased accordingly as homology desired is increased, and further, depending upon the G-C or A-T richness of any area wherein high homology is desired, all as known in the art.

Another way to define selective hybridization is by looking at the amount (percentage) of one of the nucleic acids bound to the other nucleic acid. For example, in some embodiments selective hybridization conditions would be when at least about, 60, 65, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100 percent of the limiting nucleic acid is bound to the non-limiting nucleic acid. Typically, the non-limiting primer is in for example, 10 or 100 or 1000 fold excess. This type of assay can be performed at under conditions where both the limiting and non-limiting primer are for example, 10 fold or 100 fold or 1000 fold below their k_{d}, or where only one of the nucleic acid molecules is 10 fold or 100 fold or 1000 fold or where one or both nucleic acid molecules are above their k_{d}.

Another way to define selective hybridization is by looking at the percentage of primer that gets enzymatically manipulated under conditions where hybridization is required to promote the desired enzymatic manipulation. For example, in some embodiments selective hybridization conditions would be when at least about, 60, 65, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100 percent of the primer is enzymatically manipulated under conditions which promote the enzymatic manipulation, for example if the enzymatic manipulation is DNA extension, then selective hybridization conditions would be when at least about 60, 65, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100 percent of the primer molecules are extended. Preferred conditions also include those suggested by the manufacturer or indicated in the art as being appropriate for the enzyme performing the manipulation.

Just as with homology, it is understood that there are a variety of methods herein disclosed for determining the level of hybridization between two nucleic acid molecules. It is understood that these methods and conditions may provide different percentages of hybridization between two nucleic acid molecules, but unless otherwise indicated meeting the parameters of any of the methods would be sufficient. For example if 80% hybridization was required and as long as hybridization occurs within the required parameters in any one of these methods it is considered disclosed herein.

It is understood that those of skill in the art understand that if a composition or method meets any one of these criteria for determining hybridization either collectively or singly it is a composition or method that is disclosed herein.

b. Fluorescence In Situ Hybridization

In, situ hybridization is generally carried out on cells or tissue sections fixed to slides. In situ hybridization may be performed by several conventional methodologies [See for e.g. Leitch et al. In Situ Hybridization: a practical guide, Oxford BIOS Scientific Publishers, Micropscopy handbooks v. 27 (1994)]. In one in situ procedure, fluorescent dyes [such as fluorescein isothiocyanate (FITC) which fluoresce green when excited by an Argon ion laser] are used to label a nucleic acid sequence probe which is complementary to a target nucleotide sequence in the cell. Each cell containing the target nucleotide sequence will bind the labeled probe producing a fluorescent signal upon exposure, of the cells to a light source of a wavelength appropriate for excitation of the specific fluorochrome used.

Various degrees of hybridization stringency can be employed. As the hybridization conditions become more stringent, a greater degree of complementarity is required between the probe and target to form and maintain a stable duplex. Stringency is increased by raising temperature, lowering salt concentration, or raising formamide concentration. Adding dextran sulfate or raising its concentration may also increase the effective concentration of labeled probe to increase the rate of hybridization and ultimate signal intensity. After hybridization, slides are washed in a solution generally containing reagents similar to those found in the hybridization solution with washing time varying from minutes to hours depending on required stringency. Longer or more stringent washes typically lower nonspecific background but run the risk of decreasing overall sensitivity.

Probes used in the FISH analysis may be either RNA or DNA oligonucleotides or polynucleotides and may contain not only naturally occurring nucleotides but their analogs like digoxygenin dCTP, biotin dcTP 7-azaguanosine, azidothymidine, inosine, or uridine. Other useful probes include peptide probes and analogues thereof, branched gene DNA, peptidomimetics, peptide nucleic acid (PNA) and/or antibodies.

Probes should have sufficient complementarity to the target nucleic acid sequence of interest so that stable and specific binding occurs between the target nucleic acid sequence and the probe. The degree of homology required for stable hybridization varies with the stringency of the hybridization medium and/or wash medium. Preferably, completely homologous probes are employed in the present invention, but persons of skill in the art will readily appreciate that probes exhibiting lesser but sufficient homology can be used in the present invention [see for e.g. Sambrook, J., Fritsch, E. F., Maniatis, T., Molecular Cloning A Laboratory Manual, Cold Spring Harbor Press. (1989)].

One of skill in the art will appreciate that the choice of probe will depend on the genetic abnormality of interest. Genetic abnormalities that can be detected by this method include, but are not limited to, mutation, amplification, translocation, deletion, addition and the like. Examples of mutation include, but are not limited to BRCA1 and BRCA2 in breast and ovarian cancer, p16 and BRAF in melanoma, ras in pancreatic cancer, EGFR in lung cancer. Examples of amplification include, but are not limited to, HER2/neu in breast and ovarian cancer, N-myc in neuroblastoma, C-myc in small cell lung cancer. Examples of abnormal chromosome number include, but are not limited to, trisomy 8 in leukemia, monosomy 7 in myloproliferative disorders, and trisomy 12 in chronic lymphoblastic leukemia. Examples of translocations include, but are not limited to, bcr/abl [t (9;22)] translocation in chronic mylogenous leukemia and the t (15;17) translocation FAB-M3 (acute promyelocytic leukemia). Examples of deletions include EGFR vIII and p53. By way of example for evaluating HER2/neu amplification a probe spanning a 140 kb region on the long arm of chromosome 17 containing the HER2/neu gene (17q11.2-17q12) may be used. A probe for the .alpha.-satellite sequences in the centromeric region of chromosome 17(D1721) may be used to evaluate for aneusomy of chromosome 17 as a source or cause for HER2/neu amplification. For example, a cocktailed version of these probes may be obtained from Vysis, Inc. where each probe is directly labeled with easily distinguishable fluorophores, such as SPECTRUM ORANGE™ and SPECTRUM GREEN™.

Probes may also be generated and chosen by several means including, but not limited to, mapping by in situ hybridization, somatic cell hybrid panels, or spot blots of sorted chromosomes; chromosomal linkage analysis; or cloned and isolated from sorted chromosome libraries from human cell lines or somatic cell hybrids with human chromosomes, radiation somatic cell hybrids, microdissection of a chromosome region, or from yeast artificial chromosomes (YACs) identified by PCR primers specific for a unique chromosome locus or other suitable means like an adjacent YAC clone. Probes may be genomic DNA, cDNA, or RNA cloned in a plasmid, phage, cosmid, YAC, Bacterial Artificial Chromosomes (BACs), viral vector, or any other suitable vector. Probes may be cloned or synthesized chemically by conventional methods. When cloned, the isolated probe nucleic acid fragments are typically inserted into a vector, such as lambda phage, pBR322, M13, or vectors containing the SP6 or T7 promoter and cloned as a library in a bacterial host. [See for e.g. Sambrook, J., Fritsch, E. F., Maniatis, T., Molecular Cloning A Laboratory Manual, Cold Spring Harbor Press, (1989)].

Probes are preferably labeled with a fluorophor. Examples of fluorophores include, but are not limited to, rare earth chelates (europium chelates), Texas Red, rhodamine, fluorescein, dansyl, Lissamine, umbelliferone, phycocrytherin, phycocyanin, or commercially available fluorophors such SPECTRUM ORANGE® and SPECTRUM GREEN® and/or derivatives of any one or more of the above. Multiple probes used in the assay may be labeled with more than one distinguishable fluorescent or pigment color. These color differences provide a means to identify the hybridization positions of specific probes. Moreover, probes that are not separated spatially can be identified by a different color light or pigment resulting from mixing two other colors (e.g., light red+green=yellow) pigment (e.g., blue+yellow=green) or by using a filter set that passes only one color at a time.

Probes can be labeled directly or indirectly with the fluorophor, utilizing conventional methodology. Additional probes and colors may be added to refine and extend this general procedure to include more genetic abnormalities or serve as internal controls. By way of example the HER2/neu gene is in chromosome 17, and as an internal control a probe for α-satellite sequences specific for chromosome 17 (D17Z1) may be used (Vysis. Inc.) to prove diploidy in areas of non-malignant cells and/or to establish the presence or absence of chromosome 17 aneusomy in areas of HER2neu amplification.

After processing for FISH, the slides may be analyzed by standard techniques of fluorescence microscopy [see for e.g. Ploem and Tanke Introduction to Fluorescence Microscopy, New York, Oxford University Press (1987)]. Briefly, each slide is observed using a microscope equipped with appropriate excitation filters, dichromic, and barrier filters. Filters are chosen based on the excitation and emission spectra of the fluorochromes used. Photographs of the slides may be taken with the length of time of film exposure depending on the fluorescent label used, the signal intensity and the filter chosen. For FISH analysis the physical loci of the cells of interest determined in the morphological analysis are recalled and visually conformed as being the appropriate area for FISH quantification.

In order to correlate cellular morphology and/or IHC with FISH, one may use a computer-driven, motorized stage which stores location of co-ordinates. This may be used to evaluate the same area by two different analytical techniques. For example, color images of the morphologically stained areas may be captured and saved using a computer-assisted cooled CCD camera. The same section may be subsequently taken through the FISH procedure, the stored locations recalled, and the designated areas scored for the presence of fluorescent nuclear signals. A similar procedure for IHC followed by FISH is contemplated.

Typically, hundreds of cells are scanned in a tissue sample and quantification of the specific target nucleic acid sequence is determined in the form of fluorescent spots, which are counted relative to the number of cells. Deviation of the number of spots in a cell from a norm may be indicative of a malignancy or a predisposition to a malignancy, disease, or other abnormality. The relative number of abnormal cells to the total cell sample population may also indicative of the extent of the condition or abnormality. In addition, using family health histories and/or genetic screening, it is possible to estimate the probability that a particular subject has for developing certain types of cancer. Those subjects that have been identified as being predisposed to developing a particular form of cancer can be monitored or screened to detect early evidence of disease. Upon discovery of such evidence, early treatment can be undertaken to combat the disease. Similarly, those subjects who have already developed a malignancy and who have been treated to remove the cancer or are otherwise in remission are particularly susceptible to relapse and reoccurrence, including the metastasis of tumors. Such subjects can be monitored and screened using the presently disclosed methods to detect evidence of metastasis and upon discovery of such evidence, immediate treatment can be undertaken to combat the disease.

c. Chromogenic In Situ Hybridization

Chromogenic in situ hybridization (CISH) is a technique that allows in situ hybridization methods to be performed and detected with a bright-field microscope, instead of a fluorescence microscope as required for FISH. While FISH requires a modern and expensive fluorescence microscope equipped with high-quality 60× or 100× oil immersion objectives and multi-band-pass fluorescence filters (not used in most routine diagnostic laboratories), CISH allows detection with standard light (bright-field) microscopes (which are generally used in diagnostic laboratories). Also, with FISH, the fluorescence signals can fade within several weeks, and the hybridization results are typically recorded with an expensive CCD camera, while the results of CISH do not generally fade allowing the tissue samples to be archived and reviewed later. Generally, histological detail is better appreciated with bright-field detection, which is possible with CISH detection. A further advantage of CISH is that large regions of tissue section can be scanned rapidly after CISH counterstaining since morphological detail is readily apparent using low power objectives (e.g. 10.times. and 20.times.), while FISH detection generally requires substantially higher magnification (thus reducing the field of view).

General chromogenic/colorimetric in situ hybridization methods are described in WO0026415 to Fletcher et al. (herein incorporated by reference for material at least related to assays). Particular reagents and steps for performing CISH on formalin-fixed, paraffin-embedded (FFPE) tissue samples, as well as cell sample/metaphase chromosome samples are described in WO0026415 and the section presented below. Importantly the description detailed below provides an exemplary CISH method, procedure, and reagents, and is not to be construed as limiting the present invention.

d. Cell Sample or Metaphase Chromosome Sample

(A) Pretreatment

Initially, slides may be immersed in a pretreament buffer such as 2×SSC buffer (20×SSC buffer=0.3M Sodium Citrate, with 3M NaCl, ph 7.0), or Tris-EDTA, or Tris, at about 37 degrees Celsius for about 60 minutes. In some embodiments, the cell samples are treated with pepsin compositions (e.g. Zymed's SPOT LIGHT Cell Pretreatment Reagent) for about 5 minutes at about 37 degrees Celsius. Incubation time may be, for example, from about 1-10 minutes depending on cell type and slide-making conditions. Excessive pepsin digestion may cause loss of nuclei and chromosome structure. Inadequate digestion may result in loss of signal. Slides may then be washed (e.g. in dH.sub.20 or PBS) for two or three time, for two or three minutes each time at room temperature. In some embodiments, the slides may be immersed in buffered formalin (e.g. 10%) for about a minute at room temperature. The slides may then be washed (e.g. in dH.sub.20 or PBS) two or three times for about 1-3 minutes each time, at room temperature. The slides may then be dehydrated. For example, the slides may be dehydrated in 70%, 85%, 95%, and 100% ethanol for 2 minutes each, and then air dried. Slides may proceed to ISH procedures described below or stored (e.g. in 70% ethanol at −20 degrees Celsius).

(B) Denaturation and Hybridization

First, add the probe to the center of a cover slip (e.g. 22×22 mm coverslip, or 24×32 mm coverslip, or coverslips described in WO0138848 to Ventana Medical Systems Inc., herein incorporated by reference). In other embodiments, the probe is added directly to the tissue sample. In some embodiments, the liquid COVERSLIP from Ventana Medical Systems, Inc. is applied over the tissue sample (e.g. to create a humid reaction chamber on the slide). In other embodiments, the Zymed CISH UNDERCOVER slips are employed (available from Zymed Labs.). In some embodiments, the coverslip is then placed probe side down on the tissue sample. The edges of the coverslip may then be sealed, for example, with a thin layer of rubber cement to prevent evaporation during incubation. For denaturation, the slide with the tissue sample is then placed on a slide block of PCR machine or on a heating block with temperature display (or other heating device). Denaturation is conducted at approximately 80 degrees Celsius for about 2-5 minutes. The slides may then be placed in a dark humidity box (or other humidity chamber) or in the slide block of a PCR thermal cycler for about 16-24 hours at about 37 degrees Celsius.

(C) Stringency Wash

The remaining steps (e.g., stringency wash, immunodetection, counterstaining/coverslipping) are generally the same for both cell sample and FFPE. After hybridization, the rubber cement (or other sealant used, if a sealant is used) and cover slip (or other cover) is carefully removed. The tissue sample slides are then washed (e.g. in Coplin jar) in order to remove unhybridized probes. For example, the tissue sample slides may be washed in 0.5×SSC at 72° C. for about 5 minutes. The temperature may be adjusted up if more than one slide is being washed (e.g., add 1° C. per slide for more than 2 slides, but preferable no higher than 80° C. The slides are then washed again in, for example, dH₂O or PBS/Tween 20 buffer for about 2-3 minutes. This may be repeated two or three times.

Cytology-Based Assays

The use of a cytology-based assay allows for the integration of morphology with immunohistochemistry, making it possible to factor out the effect of contaminating cells (such as non-tumor cells).

In one embodiment, urine samples can be collected either in a conventional urine collection container that is suitable for different ages or genders and can then be transferred from the collection container to the disclosed device. In one embodiment, the urine can be collected directly into the disclosed device. The sample can be dispensed (directly or indirectly) into the top chamber (5) of the disclosed device.

The urine samples (3) can be filtered through the solid support filter to trap the cells while the urine, without cells, will flow into the second chamber (6). In one embodiment, the urine will flow into the second chamber by the suction force generated by the release of the spring activated piston. The flow through (14) can be discarded and, in one embodiment, the collection assembly removed for processing.

The filter cassette can be removed from the device. The cells on the filter cassette can be transferred directly to a microscope glass slide and fixed. In another embodiment, the cells can be fixed and stained directly on the support for cytological observation.

For cytogenetics (FISH) testing, metaphase prep can be hybridized with fluorescent-labeled probes and examined under the microscope.

5. Antibody-Based Assays

In other embodiments, an immunoassay can be used to detect and analyze different analytes in a sample. An immunoassay is an assay that uses an antibody to specifically bind an antigen (e.g., a biomarker). As disclosed herein, an antibody can be a detection agent and/or a capture tag. An immunoassay is characterized by the use of specific binding properties of a particular antibody to isolate, target, and/or quantify the antigen. Thus, under designated immunoassay conditions, the specified antibodies bind to a particular protein at least two times the background and do not substantially bind in a significant amount to other proteins present in the sample. Specific binding to an antibody under such conditions may require an antibody that is selected for its specificity for a particular protein. For example, polyclonal antibodies raised to a biomarker from specific species such as rat, mouse, or human can be selected to obtain only those polyclonal antibodies that are specifically reactive with that biomarker and not with other proteins, except for polymorphic variants and alleles of the biomarker. This selection may be achieved by subtracting out antibodies that cross-react with the biomarker molecules from other species.

Generally, a sample obtained from a subject can be contacted with the antibody that specifically binds the biomarker. Optionally, the antibody can be fixed to a solid support to facilitate washing and subsequent isolation of the complex, prior to contacting the antibody with a sample. Examples of solid supports include glass or plastic in the form of, e.g., a microtiter plate, a stick, a bead, or a microbead. Antibodies can also be attached to a probe substrate or a protein chip.

Methods for measuring the amount or presence of an antibody-biomarker complex include, for example, detection of fluorescence, luminescence, chemiluminescence, absorbance, reflectance, transmittance, birefringence or refractive index (e.g., surface plasmon resonance, ellipsometry, a resonant mirror method, a gating coupler waveguide method or interferometry). Optical methods include microscopy (both confocal and non-confocal), imaging methods and non-imaging methods. Electrochemical methods include voltametry and amperometry methods. Radio frequency methods include multipolar resonance spectroscopy. Useful assays are well known in the art, including, for example, an enzyme immune assay (EIA) such as enzyme-linked immunosorbent assay (ELISA), a radioimmune assay (RIA), immunoprecipitation, a Western blot assay, or a slot blot assay. These methods are also described in, e.g., Methods in Cell Biology: Antibodies in Cell Biology, volume 37 (Asai, ed. 1993); Basic and Clinical Immunology (Stites & Terr, eds., 7th ed. 1991); and Harlow & Lane, Antibodies: A Laboratory Manual (1988).

In one embodiment, the detection agent in an immunoassay is not an antibody, as commonly used, but can be a labeled molecule that is known to specifically bind to the analyte (e.g. biomarker). Also disclosed herein, the detection agent can be a protein with a specific or known binding affinity. For example, heparin can be used to identify heparin binding proteins.

Immunoassays can be used to determine presence or absence of a biomarker in a sample as well as the quantity of a biomarker in a sample. The amount of an antibody-biomarker complex can be determined by comparing to a standard. A standard can be, e.g., a known compound or another protein known to be present in a sample. It is understood that the test amount of biomarker need not be measured in absolute units, as long as the unit of measurement can be compared to a control.

Generally, data generated by desorption and detection of biomarkers can be analyzed with the use of a programmable digital computer. The computer program analyzes the data to indicate the number of biomarkers detected, and optionally the strength of the signal and the determined molecular mass for each biomarker detected. Data analysis can include steps of determining signal strength of a biomarker and removing data deviating from a predetermined statistical distribution. For example, the observed peaks can be normalized, by calculating the height of each peak relative to some reference. The reference can be background noise generated by the instrument and chemicals such as the energy absorbing molecule which is set as zero in the scale.

A computer can transform the resulting data into various formats for display. The standard spectrum can be displayed, but in one useful format only the peak height and mass information are retained from the spectrum view, yielding a cleaner image and enabling biomarkers with nearly identical molecular weights to be more easily seen, in another useful format, two or more spectra are compared, conveniently highlighting unique biomarkers and biomarkers that are up- or downregulated between samples. Using any of these formats, one can readily determine whether a particular biomarker is present in a sample.

i. Immunodetection

Generally, depending on the detection reagents used, the first step in preparation for immunodetection is peroxidase quenching and endogenous biotin blocking. For peroxidase quenching, slides may be submerged in 3% H₂O₂ in absolute methanol (e.g. add part 30% hydrogen peroxide to 9 parts absolute methanol) for about 10 minutes. The slide is then washed with PBS (e.g. 1×PBS (10 mM)/Tween 20 (0.025%)) for 2-3 minutes. This may be repeated two or three times. The tissue samples are then blocked. Blocking can be performed by adding 2 drops per slide (at room temperature) of CAS-BLOCK (which is 0.25% casein, 0.2% gelatin, and 10 mM PBS, pH 7.4). After about 10 minutes, the blocking reagent is blotted off.

Next, the labeled probe library is detected. The probe may be detected by first adding an anti-labeled primary antibody (e.g. a mouse antibody or antibody with a label such as FITC). In certain preferred embodiments, the probe is labeled with digoxigenin, and the primary antibody is an FITC-anti-dig antibody. In other preferred embodiments, the primary antibody is unlabelled, but is from a particular species such as rat, mouse or goat. In other embodiments, the primary antibody is linked (e.g. conjugated) to an enzyme (e.g. horseradish peroxidase (HRP) or alkaline phosphatase (AP)) able to act on a chromogenic substrate, and does not require the secondary antibody described below. Generally, about two drops of the primary antibody solution is added to the tissue at room temperature for about 30-60 minutes. The tissue sample is then rinsed/washed, for example, with PBS (e.g., 1.times.PBS/Tween 20 (0.025%) for about 2-3 minutes. This may be repeated two to three times.

In preferred embodiments, a secondary antibody is added to the tissue sample that is able to bind to the primary antibody. For example, if the primary antibody is labeled with FITC, the secondary antibody may be an anti-FITC antibody. Also for example, if the primary antibody is an unlabeled mouse antibody, the secondary antibody may be an anti-mouse antibody (e.g. goat anti-mouse antibody). Generally, the secondary antibody is linked (e.g. conjugated) to an enzyme (e.g. HRP or AP) able to act upon a chromogenic substrate (or chemiluminescent substrate). Generally, about 2 drops of the secondary antibody is added to the tissue sample at room temperature for about 30-60 minutes. The tissue sample is then rinsed, for example, with PBS (e.g., 1.times.PBS/Tween 20 (0.025%) for about 2-3 minutes. This may be repeated two to three times. Additional antibodies (e.g. tertiary, quaternary antibodies) may be used if desired.

In certain preferred embodiments, the secondary antibody is linked to a polymer that is itself linked to many enzyme molecules (e.g. polymerized HRP or polymerized AP). This allows each individual antibody to connect (via the polymer) to many enzyme molecules in order to increase signal intensity. Such polymerized enzymes are known in the art, and are commercially available from, for example, Nichirei Inc. (Tokyo, Japan) and ImmunoVision.

Once the antibody (or other detection molecule) which is linked to an enzyme (e.g. a secondary or tertiary antibody conjugated to AP or HRP), is added to the biological sample, a substrate for the enzyme is then added. In preferred embodiments, the substrate is a chromogen. Examples of suitable chromogens include, but are not limited to, DAB, FAST RED, AEC, BCIP/NBT, BCIP/INT, TMB, APPurple, ULTRABLUE, TMBlue, and VEGA RED. In other embodiments, the substrate is a chemiluminescent molecule (e.g. BOLD APS 540 chemiluminescent substrate, BOLD APS 450 chemiluminescent substrate, or BOLD APB chemiluminescent substrate, all commercially available from INTERGEN Co.). Therefore, the next step, for example in developing the slide, is to mix DAB (or other substrate), buffer, and hydrogen peroxide (e.g. 0.6%) in a tube, then to add 3 drops per slide to the tissue sample for about 30 minutes. In certain embodiments, chromogen enhancers are added to increase signal intensity (e.g. AEC enhancer, FAST RED enhancer, and DAB enhancer available from INNOVEX Biosciences, ZYMED Labs, etc.). The tissue sample may then be washed (e.g., with running tap water) for about two minutes. In certain embodiments, the immunohistochemistry steps are automated or partially automated. For example, the ZYMED ST 5050 Automated Immunostainer may be employed to automate this process.

a. Counterstaining and Coverslipping

In some embodiments, a step is a counterstaining and coverslipping step. This step may be performed by counterstaining the tissue sample. For example, the tissue sample may be counterstained with hematoxylin or other counterstain. This procedure may be performed for about 6 seconds to about 1 minutes, depending on the type of tissue being stained. Preferably, overly dark counterstaining is avoided so as not to obscure the positive signal. The slides may then be washed (e.g. with running tap water) for a couple of minutes, and then, in some embodiments, dehydrated with graded EtOH (e.g. 70%, 85%, 95%, 100%, 100% for about 2 minutes each, repeated two times). In some embodiments, the dehydration is not performed with EtOH, when, for example, FAST RED is the substrate (e.g. a water soluble substrate). The slides may then be exposed to Xylene for about two minutes (this may be repeated at least once). The tissue sample may then be coverslippped (e.g. with HISTOMOUNT, Cytoseal 6.0, cat. #8310-16, Stephen Scientific). In some embodiments, CLEARMOUNT is employed instead (e.g. when FAST RED is one of the substrates).

b. Microscopy and Interpretation of Results

Importantly, the slides may be visualized using standard bright-field microscopy using a bright-field microscope (e.g. OLYMPUS, NIKON, LEITZ, etc.). Generally, probes are visible with about 20× magnification (e.g. 15×-25×). In preferred embodiments, probes are visualized with about 30×, or 40× (e.g. 28×-43×) magnification. Higher powers (e.g. 60×, 80×, and 100×) may be employed, but are generally not necessary (and may reduce the field of view).

In some embodiments, for evaluating translocation results, a 100× oil lens is employed. In other embodiments, for evaluating amplification and centromere probes, 40× lens is employed.

c. Quality Control Procedures

In some embodiments, quality control procedures are used. Quality control over the accuracy of the above procedures may, in some embodiments, be assured by using positive and negative controls.

ii. Enzyme-Linked Immunosorbent Assay (ELISA)

ELISA, or more generically termed EIA (Enzyme ImmunoAssay), is an immunoassay that can detect an antibody, or in certain modified forms, any detection agent, specific for an analyte, such as a protein. In such an assay, a detectable label bound to either an antibody-binding or antigen-binding reagent is an enzyme. When exposed to its substrate, this enzyme reacts in such a manner as to produce a chemical moiety which can be detected, for example, by spectrophotometric, fluorometric or visual means. Enzymes which can be used to detectably label reagents useful for detection include, but are not limited to, horseradish peroxidase, alkaline phosphatase, glucose oxidase, β-galactosidase, ribonuclease, urease, catalase, malate dehydrogenase, staphylococcal nuclease, asparaginase, yeast alcohol dehydrogenase, alpha.-glycerophosphate dehydrogenase, triose phosphate isomerase, glucose-6-phosphate dehydrogenase, glucoamylase and acetylcholinesterase. For descriptions of ELISA procedures, see Voller, A. et al., J. Clin. Pathol. 31:507-520 (1978); Butler, J. E., Meth. Enzymol. 73:482-523 (1981); Maggio, E. (ed.), Enzyme Immunoassay, CRC Press, Boca Raton, 1980; Butler, J. E., In: Structure of Antigens, Vol. 1 (Van Regenmortel, M., CRC Press, Boca Raton, 1992, pp. 209-259; Butler, J. E., In: van Oss, C. J. et al., (eds), Immunochemistry, Marcel Dekker, Inc., New York, 1994, pp. 759-803; Butler, J. E. (ed), Immunochemistry of Solid-Phase Immunoassay, CRC Press, Boca Raton, 1991); Crowther, “ELISA: Theory and Practice,” In: Methods in Molecule Biology, Vol. 42, Humana Press; New Jersey, 1995;U.S. Pat. No. 4,376,110, each of which is incorporated herein by reference in its entirety and specifically for teachings regarding ELISA methods.

Variations of ELISA techniques are know to those of skill in the art. In one variation, antibodies that can bind to analytes, such as proteins can be immobilized onto a selected surface exhibiting protein affinity, such as a well in a polystyrene microtiter plate. Then, a test composition suspected of containing a marker antigen can be added to the wells. After binding and washing to remove non-specifically bound immunocomplexes, the bound antigen can be detected. Detection can be achieved by the addition of a second antibody specific for the target protein, which is linked to a detectable label. This type of ELISA is a simple “sandwich ELISA.” Detection also can be achieved by the addition of a second antibody, followed by the addition of a third antibody that has binding affinity for the second antibody, with the third antibody being linked to a detectable label.

Another variation is a competition ELISA. In competition ELISA's, test samples compete for binding with known amounts of labeled antigens or antibodies. The amount of reactive species in the sample can be determined by mixing the sample with the known labeled species before or during incubation with coated wells. The presence of reactive species in the sample acts to reduce the amount of labeled species available for binding to the well and thus reduces the ultimate signal.

Regardless of the format employed, ELISAs have certain features in common, such as coating, incubating or binding, washing to remove non-specifically bound species, and detecting the bound immune complexes. Antigen or antibodies can be linked to a solid support, such as in the form of plate, beads, dipstick, membrane or column matrix, and the sample to be analyzed applied to the immobilized antigen or antibody. In coating a plate with either antigen or antibody, one will generally incubate the wells of the plate with a solution of the antigen or antibody, either overnight or for a specified period of hours. The wells of the plate can then be washed to remove incompletely adsorbed material. Any remaining available surfaces of the wells can then be “coated” with a nonspecific protein that is antigenically neutral with regard to the test antisera. These include bovine serum albumin (BSA), casein and solutions of milk powder. The coating allows for blocking of nonspecific adsorption sites on the immobilizing surface and thus reduces the background caused by nonspecific binding of antisera onto the surface.

In ELISAs, a secondary or tertiary detection means, rather than a direct procedure, can also be used. Thus, after binding of a protein or antibody to the well, coating with a non-reactive material to reduce background, and washing to remove unbound material, the immobilizing surface is contacted with the control clinical or biological sample to be tested under conditions effective to allow immune complex (antigen/antibody) formation. Detection of the immune complex then requires a labeled secondary binding agent or a secondary binding agent in conjunction with a labeled third binding agent.

“Under conditions effective to allow immune complex (antigen/antibody) formation” means that the conditions include diluting the antigens and antibodies with solutions such as BSA, bovine gamma globulin (BGG) and phosphate buffered saline (PBS)/Tween so as to reduce non-specific binding and to promote a reasonable signal to noise ratio. The suitable conditions also mean that the incubation is at a temperature and for a period of time sufficient to allow effective binding. Incubation steps can typically be from about 1 minute to twelve hours, at temperatures of about 20° to 30° C., or can be incubated overnight at about 0° C. to about 10° C.

Following all incubation steps in an ELISA, the contacted surface can be washed so as to remove non-complexed material. A washing procedure can include washing with a solution such as PBS/Tween or borate buffer. Following the formation of specific immune complexes between the test sample and the originally bound material, and subsequent washing, the occurrence of even minute amounts of immune complexes can be determined.

To provide a detecting means, the second or third antibody can have an associated label to allow detection, as described above. This can be an enzyme that can generate color development upon incubating with an appropriate chromogenic substrate. Thus, for example, one can contact and incubate the first or second immune complex with a labeled antibody for a period of time and under conditions that favor the development of further immune complex formation (e.g., incubation for 2 hours at room temperature in a PBS-containing solution such as PBS-Tween).

After incubation with the labeled antibody, and subsequent to washing to remove unbound material, the amount of label can be quantified, e.g., by incubation with a chromogenic substrate such as urea and bromocresol purple or 2,2′-azido-di-(3-ethyl-benzthiazoline-6-sulfonic acid [ABTS] and H₂O₂, in the case of peroxidase as the enzyme label. Quantitation can then be achieved by measuring the degree of color generation, e.g., using a visible spectra spectrophotometer.

iii. Immunoblots

In one embodiment of the disclosed methods, immunoblot assays can be used to analyze different analytes in the disclosed samples.

In general, the sample would be placed in contact with a membrane, such as nitrocellulose, PVDF or nylon, via the disclosed composition (collection device), and analytes (e.g. proteins) would bind to the membrane. The membrane is then processed as disclosed below with western blots. Basically, unbound or loosely bound analytes are washed away and remaining available binding sites on the membrane are blocked with a blocking agent (e.g. casein, BSA, etc.). A detection agent is then used to bind to the analytes of interest, membrane is washed and then a second detection agent comprising a label moiety is put in contact with the membrane. In one embodiment, the first detection agent can be conjugated to a label moiety and thus, a second detection agent is not necessary. Lastly, the label moiety is detected by common procedures to those known in the art depending on what the label moiety is.

In one embodiment, an immunoblot contains some, most or all of the analytes from a sample. The analytes can be bound on the entire membrane or in specific locations on the membrane (western or slot blots). The western blot separates proteins based on size (molecular weight) whereas a slot blot simply provides a specific location on the membrane for all proteins, regardless of size.

a. Western Blot

Disclosed herein are methods of detecting analytes by using western blot analysis. Western Blotting, if performed, would occur if the analytes are collected after isolation in the Analyzer. The analyte would be removed from the support using methods for protein extraction known to those skilled in the art. For example, the proteins can be eluted from the solid substrate using non-denaturing or denaturing conditions (Sambrook et al. Manual for Molecular Biology). The distinguishing factor of a western blot is the capability of not only identifying an analyte based on its interaction with a specific detection agent but also identifying an analyte based on its size.

Western blot analysis generally comprises preparing protein samples, electrophoresis of the protein samples in a polyacrylamide gel (e.g., 8%-20% SDS-PAGE depending on the molecular weight of the antigen), transferring the protein sample from the polyacrylamide gel to a membrane such as nitrocellulose, PVDF or nylon, blocking the membrane in blocking solution (e.g., PBS with 3% BSA or non-fat milk), washing the membrane in washing buffer (e.g., PBS-Tween 20), blocking the membrane with primary antibody (the antibody of interest) diluted in blocking buffer, washing the membrane in washing buffer, blocking the membrane with a secondary antibody (which recognizes the primary antibody, e.g., an anti-human antibody) conjugated to an enzymatic substrate (e.g., horseradish peroxidase or alkaline phosphatase) or radioactive molecule (e.g., .sup.32P or .sup.125I) diluted in blocking buffer, washing the membrane in wash buffer, and detecting the presence of the antigen. One of skill in the art would be knowledgeable as to the parameters that can be modified to increase the signal detected and to reduce the background noise. For further discussion regarding western blot protocols see, e.g., Ausubel et al, eds, 1994, Current Protocols in Molecular Biology, Vol. 1, John Wiley & Sons, Inc., New York at 10.8.1.

In one embodiment, western blot analysis can be done using a non-denaturing gel in order to keep the proteins in their native state.

b. Slot Blot Assay

Slot blot assays, also known as dot blots, are similar to western blots without the beginnings steps of electrophoresis. Samples are administered directly to the membrane and the blocking, washing and detection steps would be the same as disclosed for western blots. In the disclosed methods, a slot blot assay can be performed in certain embodiments, directly in the analyzer, or on the solid substrate that was used in an analyzer.

In one embodiment, a slot blot adapter is incorporated above the solid substrate. The sample (i.e., urine) can be added to the first chamber of the analyzer and the suction from the vacuum generator forces the sample to contact the solid substrate (i.e., membrane) in designated areas. For example, the sample will only contact the solid substrate at each opening in the slot blot adapter. The direction of the sample to specific areas allows for concentration of analytes in these areas and thus can lead to better or easier analyte detection. For example if specific analytes, which are in low concentrations in the sample, are spread out across an entire membrane the detection limit may prevent one from seeing a signal at the precise location of the analyte on the membrane. However, if these rare analytes are all bound in a specific location on the membrane, there would be enough analyte to be within the detection limit and thus the analyte would be detected.

iv. Arrays

In various embodiments of the disclosed methods the many detection agents may be operatively coupled to a solid substrate. When using arrays, an array can be in conjunction with the solid substrate or it can be used separately after isolation on the solid substrate and collection. They arrays can be an array of polypeptides, proteins (e.g., antibodies), nucleic acids, synthetic mimetics of such detection agents, etc. The solid substrate is something onto which a detection agent can be provided, (e.g., by attachment, deposition, coupling and other known methods). One or more detection agents may be immobilized on solid substrates including, but not limited to glass (e.g., a chemically-modified glass slide), latex, plastic, membranes, microtiter, wells, mass spectrometer plates, beads (e.g., cross-linked polymer beads) or the like.

An array can include, but is not limited to a plate, a chip, and/or a population of beads. A variety of array formats are known in the art and can be adapted to the inventive methods based on the descriptions provided in this application.

Arrays utilized in this invention may include between or at least or less than about 2, 3, 4, 5, 6, 7, 8, 9, 10, 11, 12, 13, 14, 15, 16, 17, 18, 19, 20, 100, 1,000, 2,000, 3,000, 4,000, 5,000, 6,000, 7,000, 8,000, 9,000, 10,000, 12,500 to 25,000, 50,000, 75,000, to about 100,000 distinct random ligands or binding elements, including values and ranges there between. Often when there are large numbers, such as a 100, these arrays are used subsequent to isolation of the analytes, such as cells, in the analyzer.

a. Antibody Arrays

In one embodiment, microarrays can be composed of previously characterized antibodies. These microarrays have a variety of uses, one of which is cell profiling. For example, an array can be composed of antibodies that recognize a set of antigens known to be present in activated T-cells but not in resting T-cells. A population of T-cells can then be lysed and the lysate contacted with the array to determine if the population has the profile of activated or resting T-cells.

In another example, the disclosed arrays are useful for detecting proteins from pathogens, such as bacteria, parasites, viruses, and the like. A sample (such as blood or urine) which contains (or possibly contains) the pathogen can be used to contact an antibody array to identify antibodies recognizing pathogen-specific proteins. These antibodies have utility as diagnostic agents as well as potential therapeutics.

Microarrays and the methods disclosed herein can be used in methods of diagnosing particular disorders. For example, a collection of antibodies specific for a range of antigens associated with one or more disorders can be arrayed and contacted with a bodily fluid containing antigens whose presence, or absence, would indicate a particular disorder. The advantage of using a microarray over a conventional immunoassay is the ability to include a population of antibodies diagnostic for a variety of disorders on a single surface, significantly reducing time, costs and materials needed to affect a diagnosis.

For example, if a subject presents with symptoms that are characteristic of several distinct disorders which can be distinguished on the basis of the presence or absence of one or more proteins, a single microarray assay could be used to make a specific diagnosis, thus allowing the patient to be properly treated. Patients suffering from stroke or brain infarcts release several proteins into cerebrospinal fluid, examples of which are neuron specific enolyse (NSE) from neuronal cells and S-100 from glial cells and astrocytes. Such proteins are not released in conditions that may have similar symptoms, such as drug reactions, making proper diagnosis more difficult. A diagnostic array could readily detect these and other proteins in the CSF, leading to a rapid clinical diagnosis and treatment.

b. Nucleic Acid Arrays

In another aspect of the disclosed methods microarrays are employed to characterize nucleic acids present in the samples. Briefly, known nucleic acid molecules are applied to a solid support using a microarray format. The arrayed nucleic acids are then contacted with the sample (e.g., bodily fluid). The sample is left in contact with the array for an amount of time sufficient to allow sample:nucleic acid complexes to form, then the unbound sample is washed away under suitable conditions (see, for example, Ausubel, et al, Short Protocols in Molecular Biology, 3rd ed. 1995 and the examples below). Bound sample (e.g. analyte) is detected at one or more known nucleic acid spots using one of a variety of detection methods.

Methods for producing arrays of oligonucleotides on solid substrates are also known. Examples of such techniques are described in U.S. Pat. No. 5,871,928 to Fodor et al., U.S. Pat. No. 5,654,413 to Brenner, U.S. Pat. No. 5,429,807, and U.S. Pat. No. 5,599,695 to Pease et al.

c. Protein Arrays

In one embodiment, protein microarrays can be used for analyzing expression of polypeptides associated with certain conditions. In this aspect of the invention, standard techniques of microarray technology are utilized to assess expression of the polypeptides associated with certain conditions and/or identify biological constituents that bind such polypeptides. The constituents of biological samples include proteins, nucleic acids, antibodies and the like. Protein microarray technology, which is also known by other names including: protein chip technology and solid-phase protein array technology, is well known to those of ordinary skill in the art and is based on, but not limited to, obtaining an array of identified peptides or proteins on a fixed substrate, binding target molecules or biological constituents to the peptides, and evaluating such binding. See, e.g., G. MacBeath and S. L. Schreiber, “Printing Proteins as Microarrays for High-Throughput Function Determination,” Science 289(5485):1760-1763, 2000.

d. Capture Array

A capture array includes a plurality of capture tags immobilized at identified or predetermined locations on the array. In this context, plurality of capture tags refers to multiple capture tags each having a different structure. Each predetermined location on the array (referred to herein as an array element) has one type of capture tag (that is, all the capture tags at that location have the same structure). Each location will have multiple copies of the capture tag. The spatial separation of capture tags of different structure in the array allows separate detection and identification of target molecules that become associated with the capture tags. If a decoding tag is detected at a given location in a capture array, it indicates that the target molecule corresponding to that array element was present in the target sample.

Reporter molecules and detector tags can also be immobilized in arrays. Different modes of the disclosed method can be performed with different components immobilized, labeled, or tagged. Arrays of reporter molecules and decoding tags can be made and used as described below and elsewhere herein for capture tags.

Solid substrates for use in capture arrays can include any solid material to which capture tags can be coupled, directly or indirectly. This includes materials such as acrylamide, cellulose, nitrocellulose, glass, polystyrene, polyvinylidene fluoride (PVDF), filter paper (Whatman), Glass fiber filters (GFC) (A,B,C), polyethylimine coated GFCs, porous mylar or other transparent porous films, cellulose nitrate (CN) membrane, mixed cellulose ester membrane, cellulose acetate membrane, polyethersulfone (PES) membrane, PTFE membrane, ultrafiltration membranes of poly(vinyl chloride) (PVC), carboxylated poly(vinyl chloride) (CPVC), polystyrene, polyethylene vinyl acetate, polypropylene, polymethacrylate, polyethylene, polyethylene oxide, glass, polysilicates, polycarbonates, teflon, fluorocarbons, nylon, silicon rubber, polyanhydrides, polyglycolic acid, polylactic acid, polyorthoesters, polypropylfumerate, collagen, glycosaminoglycans, and polyamino acids. Solid substrates can have any useful form including thin films or membranes, beads, bottles, dishes, fibers, woven fibers, shaped polymers, particles and microparticles. Preferred forms for a solid substrate are beads, membranes and a microtiter dish. The most preferred form of microtiter dish is the standard 96-well type.

Planar array technology has been utilized for many years (Shalon, D., S. J. Smith, and P. O. Brown, A DNA microarray system for analyzing complex DNA samples using two-color fluorescent probe hybridization. Genome Res, 1996. 6(7): p. 639-45, Singh-Gasson, S., et al., Maskless fabrication of light-directed oligonucleotide microarrays using a digital micromirror array. Nat Biotechnol, 1999. 17(10): p. 974-8, Southern, E. M., U. Maskos, and J. K. Elder, Analyzing and comparing nucleic acid sequences by hybridization to arrays of oligonucleotides: evaluation using experimental models. Genomics, 1992. 13(4): p. 1008-17, Nizetic, D., et al., Construction, arraying, and high-density screening of large insert libraries of human chromosomes X and 21: their potential use as reference libraries. Proc Natl Acad Sci USA, 1991. 88(8): p. 3233-7, Van Oss, C. J., R. J. Good, and M. K. Chaudhury, Mechanism of DNA (Southern) and protein (Western) blotting on cellulose nitrate and other membranes. J Chromatogr, 1987. 391(1): p. 53-65, Ramsay, G., DNA chips: state-of-the art. Nat Biotechnol, 1998. 16(1): p. 40-4, Schena, M., et al., Parallel human genome analysis: microarray-based expression monitoring of 1000 genes. Proc Natl Acad Sci USA, 1996. 93(20): p. 10614-9, Lipshutz, R. J., et al., High density synthetic oligonucleotide arrays. Nat Genet, 1999. 21(1 Suppl): p. 20-4, Pease, A. C., et al., Light-generated oligonucleotide arrays for rapid DNA sequence analysis. Proc Natl Acad Sci USA, 1994. 91(11): p. 5022-6, Maier, E., et al., Application of robotic technology to automated sequence fingerprint analysis by oligonucleotide hybridisation. J Biotechnol, 1994. 35(2-3): p. 191-203, Vasiliskov, A. V., et al., Fabrication of microarray of gel-immobilized compounds on a chip by copolymerization. Biotechniques, 1999. 27(3): p. 592-4, 596-8, 600 passim, and Yershov, G., et al., DNA analysis and diagnostics on oligonucleotide microchips. Proc Natl Acad Sci USA, 1996. 93(10): p. 4913-8). Such arrays may be constructed upon non permeable or permeable supports of a wide variety of support composition, for example nylon, cellulose, glass, polymer on glass, and many others. The array spot sizes and density of spot packing vary over a tremendous range depending upon the process(es) and material(s) used.

Although preferred, it is not required that a given capture array be a single unit or structure. The set of capture tags may be distributed over any number of solid supports. For example, at one extreme, each capture tag may be immobilized in a separate reaction tube or container.

Oligonucleotide capture tags in arrays can also be designed to have similar hybrid stability. This would make hybridization of fragments to such capture tags more efficient and reduce the incidence of mismatch hybridization. The hybrid stability of oligonucleotide capture tags can be calculated using known formulas and principles of thermodynamics (see, for example, Santa Lucia et al., Biochemistry 35:3555-3562 (1996); Freier et al., Proc. Natl. Acad. Sci. USA 83:9373-9377 (1986); Breslauer et al., Proc. Natl. Acad. Sci. USA 83:3746-3750 (1986)). The hybrid stability of the oligonucleotide capture tags can be made more similar (a process that can be referred to as smoothing the hybrid stabilities) by, for example, chemically modifying the capture tags (Nguyen et al., Nucleic Acids Res. 25(15):3059-3065 (1997); Hohsisel, Nucleic Acids Res. 24(3):430-432 (1996)). Hybrid stability can also be smoothed by carrying out the hybridization under specialized conditions (Nguyen et al., Nucleic Acids Res. 27(6):1492-1498 (1999); Wood et al., Proc. Natl. Acad. Sci. USA 82(6):1585-1588 (1985)).

Another means of smoothing hybrid stability of the oligonucleotide capture tags is to vary the length of the capture tags. This would allow adjustment of the hybrid stability of each capture tag so that all of the capture tags had similar hybrid stabilities (to the extent possible). Since the addition or deletion of a single nucleotide from a capture tag will change the hybrid stability of the capture tag by a fixed increment, it is understood that the hybrid stabilities of the capture tags in a capture array will not be equal. For this reason, similarity of hybrid stability as used herein refers to any increase in the similarity of the hybrid stabilities of the capture tags (or, put another way, any reduction in the differences in hybrid stabilities of the capture tags).

The efficiency of hybridization and ligation of oligonucleotide capture tags to sample fragments can also be improved by grouping capture tags of similar hybrid stability in sections or segments of a capture array that can be subjected to different hybridization conditions. In this way, the hybridization conditions can be optimized for particular classes of capture tags.

e. Luminex Platform Technology

Luminex platform are based on xMAP technology (multi-analyte profiling beads) enabling the detection and quantitation of multiple nucleic acid or protein targets simultaneously. The xMAP system combines a flow cytometer, fluorescent-dyed microspheres (beads), lasers and digital signal processing to allow multiplexing of up to 100 unique assays within a single sample. Each bead is coded for identification and can be coated with a reagent specific to a particular analyte therefore allowing for detection of multiple analytes in one reaction. After the sample has contacted the beads, a detection agent is used to identify any bound analytes. The detection agent as well as the coded bead can then be identified thus the target analyte is detected. A broad range of assays can be used with the Luminex platform such as RNA, Human, Mouse and Rat cytokines and chemokines. Concentrated soluble proteins, nucleic acids, hormones or protein extracted from the cellular fractions of biological fluids such as CSF, urine, bronchoalveolar lavage (BAL), and synovial fluid can be subjected to muliplex testing using the luminex platform.

v. Gram Staining

In one embodiment the present compositions, articles, and methods can be used to detect certain bacteria in a sample. Gram-positive and Gram-negative bacteria are differentiated by the Gram stain. A Gram-positive species retains the primary stain (crystal violet) when treated with a decolorizing agent (alcohol or acetone) whereas a Gram-negative bacterium loses the primary stain. The staining difference reflects the structural differences in the cell walls of Gram-negative and Gram-positive bacteria. The Gram-positive cell wall consists of a relatively thick peptidoglycan layer and teichoic acids whereas the Gram-negative cell wall consists of a relatively thin peptidoglycan layer, and an outer membrane consisting of a lipid bilayer containing phospholipids, lipopolysaccharide, lipoproteins and proteins. Knowing whether bacteria is Gram-positive or Gram-negative can allow one to determine what type of treatment (e.g. antibiotic) to pursue.

Gram staining can occur directly on the solid substrate in certain embodiments, and in other embodiments, the analytes, such as cells, can be isolated from the solid substrate and further processed by gram staining.

Bacterial dyes such as the Gram stain (crystal violet) can be used to identify and quantify bacteria. Additional bacterial dyes which can be used include the fluorescent stain acridine orange that can be combined with antibodies to increase sensitivity.

The Gram-positive bacteria include the causative agents of the diseases diphtheria, anthrax, tetanus, scarlet fever, and certain forms of pneumonia and tonsillitis. Gram-negative bacteria include organisms that cause typhoid fever, dysentery, gonorrhea and whooping cough.

vi. Mass Spectrometry

Targeted analytes may be detected using Mass Spectrometry such as MALDI/TOF (time-of-flight), SELDI/TOF, liquid chromatography-mass spectrometry (LC-MS), gas chromatography-mass spectrometry (GC-MS), high performance liquid chromatography-mass spectrometry (HPLC-MS), capillary electrophoresis-mass spectrometry, nuclear magnetic resonance spectrometry, or tandem mass spectrometry (e.g., MS/MS, MS/MS/MS, ESI-MS/MS, etc.). See for example, U.S. Patent Application Nos: 20030199001, 20030134304, 20030077616, which are herein incorporated by reference.

Mass spectrometry methods are well known in the art and have been used to quantify and/or identify biomolecules, such as proteins (see, e.g., Li et al. (2000) Tibtech 18:151-160; Rowley et al. (2000) Methods 20: 383-397; and Kuster and Mann (1998) Curr. Opin. Structural Biol. 8: 393-400). Further, mass spectrometric techniques have been developed that permit at least partial de novo sequencing of isolated proteins. Chait et al., Science 262:89-92 (1993); Keough et al., Proc. Natl. Acad. Sci. USA. 96:7131-6 (1999); reviewed in Bergman, EXS 88:133-44 (2000).

In certain embodiments, a gas phase ion spectrophotometer is used. In other embodiments, laser-desorption/ionization mass spectrometry is used to analyze the sample. Modern laser desorption/ionization mass spectrometry (“LDI-MS”) can be practiced in two main variations: matrix assisted laser desorption/ionization (“MALDI”) mass spectrometry and surface-enhanced laser desorption/ionization (“SELDI”). In MALDI, the analyte is mixed with a solution containing a matrix, and a drop of the liquid is placed on the surface of a substrate. The matrix solution then co-crystallizes with the biological molecules. The substrate is inserted into the mass spectrometer. Laser energy is directed to the substrate surface where it desorbs and ionizes the biological molecules without significantly fragmenting them. However, MALDI has limitations as an analytical tool. It does not provide means for fractionating the sample, and the matrix material can interfere with detection, especially for low molecular weight analytes. See, e.g., U.S. Pat. No. 5,118,937 (Hillenkamp et al.), and U.S. Pat. No. 5,045,694 (Beavis & Chait).

In SELDI, the substrate surface is modified so that it is an active participant in the desorption process. In one variant, the surface is derivatized with adsorbent and/or capture reagents that selectively bind the protein of interest. In another variant, the surface is derivatized with energy absorbing molecules that are not desorbed when struck with the laser. In another variant, the surface is derivatized with molecules that bind the protein of interest and that contain a photolytic bond that is broken upon application of the laser. In each of these methods, the derivatizing agent generally is localized to a specific location on the substrate surface where the sample is applied. See, e.g., U.S. Pat. No. 5,719,060 and WO 98/59361. The two methods can be combined by, for example, using a SELDI affinity surface to capture an analyte and adding matrix-containing liquid to the captured analyte to provide the energy absorbing material.

For additional information regarding mass spectrometers, see, e.g., Principles of Instrumental Analysis, 3rd edition., Skoog, Saunders College Publishing, Philadelphia, 1985; and Kirk-Othmer Encyclopedia of Chemical Technology, 4.sup.th ed. Vol. 15 (John Wiley & Sons, New York 1995), pp. 1071-1094.

Detection of the presence of a marker or other substances will typically involve detection of signal intensity. This, in turn, can reflect the quantity and character of a polypeptide bound to the substrate. For example, in certain embodiments, the signal strength of peak values from spectra of a first sample and a second sample can be compared (e.g., visually, by computer analysis etc.), to determine the relative amounts of particular biomolecules. Software programs such as the Biomarker Wizard program (Ciphergen Biosystems, Inc., Fremont, Calif.) can be used to aid in analyzing mass spectra. The mass spectrometers and their techniques are well known to those of skill in the art.

Any person skilled in the art understands, any of the components of a mass spectrometer, e.g., desorption source, mass analyzer, detect, etc., and varied sample preparations can be combined with other suitable components or preparations described herein, or to those known in the art. For example, in some embodiments a control sample may contain heavy atoms, e.g. sup.13C, thereby permitting the test sample to be mixed with the known control sample in the same mass spectrometry run.

In one preferred embodiment, a laser desorption time-of-flight (TOF) mass spectrometer is used. In laser desorption mass spectrometry, a substrate with a bound marker is introduced into an inlet system. The marker is desorbed and ionized into the gas phase by laser from the ionization source. The ions generated are collected by an ion optic assembly, and then in a time-of-flight mass analyzer, ions are accelerated through a short high voltage field and let drift into a high vacuum chamber. At the far end of the high vacuum chamber, the accelerated ions strike a sensitive detector surface at a different time. Since the time-of-flight is a function of the mass of the ions, the elapsed time between ion formation and ion detector impact can be used to identify the presence or absence of molecules of specific mass to charge ratio.

In some embodiments the relative amounts of one or more biomolecules present in a first or second sample is determined, in part, by executing an algorithm with a programmable digital computer. The algorithm identifies at least one peak value in the first mass spectrum and the second mass spectrum. The algorithm then compares the signal strength of the peak value of the first mass spectrum to the signal strength of the peak value of the second mass spectrum of the mass spectrum. The relative signal strengths are an indication of the amount of the biomolecule that is present in the first and second samples. A standard containing a known amount of a biomolecule can be analyzed as the second sample to provide better quantify the amount of the biomolecule present in the first sample. In certain embodiments, the identity of the biomolecules in the first and second sample can also be determined.

vii. Surface Plasmon Resonance

Methods of detecting analytes also include the use of surface plasmon resonance (SPR). In such assays an antibody the binds the target analyte need not be detectably labeled and can be used without a second antibody that binds to the specific polypeptide. For example, an antibody specific for biomarker may be bound to an appropriate solid substrate and then exposed to the sample. Binding of the biomarker to the antibody on the solid substrate may be detected by exploiting the phenomenon of surface plasmon resonance, which results in a change in the intensity of surface plasmon resonance upon binding that can be detected qualitatively or quantitatively by an appropriate instrument, e.g., a Biacore apparatus (Biacore International AB, Rapsgatan, Sweden). Optical biosensors are also contemplated for use in embodiments of the invention.

The SPR biosensing technology has been combined with MALDI-TOF mass spectrometry for the desorption and identification of biomolecules. In a chip-based approach to BIA-MS, a ligand, e.g., prohibitin antibody, is covalently immobilized on the surface of a chip. Proteins from a sample are routed over the chip, and the relevant are bound by the ligand. After a washing step, the eluted proteins are analyzed by MALDI-TOF mass spectrometry. The system may be a fully automated process and is applicable to detecting and characterizing proteins present in complex biological fluids and cell extracts at low- to subfemtomol levels.

6. Enrichment and Subtraction

Some forms of the disclosed method can involve enrichment or substraction of analytes prior to detection. This can be useful for increasing the sensitivity and accuracy of the detection, quantitation, and/or measuring of specific analytes. For example, if a sample includes many proteins (or other compositions) besides the target protein, it can be useful to reduce the amount of non-target proteins prior to detection of the target protein. This can reduce nonspecific and/or probe-depleting binding of the detection agent to non-target compositions. Nonspecific binding can occur due to cross-reactivity of the detection agent (i.e. antibody) with proteins other than the target protein.

Enrichment of the target analyte in the disclosed methods can be accomplished by targeting only the protein of interest to the filter. For example, antibodies specific to the target protein can be coated on the filter in order to prevent binding of unrelated proteins and thus enrich for the target protein.

Subtraction methods can be used in the disclosed methods and are particularly useful for measuring the level of rare proteins. Subtraction methods can be added to any form of the disclosed methods. In some forms, subtraction antibodies are introduced to deplete proteins in the sample that are to be removed in order to increase the relative numbers of any rarer proteins that need to be measured. Subtraction methods can be used, for example, to measure specific proteins in a urine sample (due, for example, to exacerbated disease state). For instance, during most types of kidney failure, albumin is a common protein found in the urine. In one embodiment of the disclosed methods, a pre-solid substrate (22) can be used to eliminate, or subtract, the albumin. This allows for a rarer protein to be more easily identified. The pre-solid substrate (22) would eliminate any known analytes that may be present in abundance in the sample. Thus, in one embodiment, the pre-solid substrate (22) would not be used in the disclosed detection methods but would rather be discarded.

In one embodiment, subtraction methods can eliminate large particles that may bind to the solid substrate and prevent analyte binding. For example, the pre-solid substrate can comprise a large particle filter (23) which prevents certain particles from passing through. In one embodiment, the filter acts by size exclusion and therefore, large clumps cannot pass through and thus, cannot bind/collect on the solid substrate preventing specific analytes from binding.

7. Diagnosing and Monitoring

Also provided herein are compositions and methods for diagnosing and/or monitoring a condition or disease or treatment of same.

Disclosed are systems, methods, and devices, that can be used to diagnose or monitor diseases/disorders of the kidney. For example, systemic diseases that may cause chronic renal disease include but are not limited to diabetes mellitus, hypertension, systemic lupus erythematosis, multiple myeloma, vasculitis, amylodosis, Wegener's granulomatosis, analgesic nephropathy, hypercalcemia, nonsteoidal antiinflamatory drugs, and scleroderma. There are also many intrinsic diseases of the kidney such as glomerulosclerosis, nephrotic syndrome, medullary cystic disease, and polycystic kidney disease that cause chronic renal disease. There are also systemic causes of acute renal failure that include for example systemic hypotension, heavy metal poisoning, and kidney stones. These lists are not meant to be comprehensive, but rather illustrative of some of the causes of kidney disease. The diagnosis and monitoring of the progression and severity of the kidney disease can be conveniently performed by collecting urine specimens from the patients. The urine specimen can then be analyzed for specific biomarkers for renal disease. For example, many renal diseases are associated with an increase in the amount of one or more proteins in the urine. There are also many other biomarkers of renal disease that are either peptides, proteins, cells, sugars or enzymes. These substances may be cytokines or other markers of inflammatory diseases or may be a biomarker specific for the etiology of the renal disease. Thus, a device as described herein can perform urinalysis to detect impending renal disease or disease progression.

Several other diseases/disorders result in kidney failure. For instance, Goodpasture syndrome, glomerulonephritis, Rhabdomyolysis, Benign Prostatic hypertrophy or prostate cancer, kidney stones, abdominal tumors, Reflux nephropathy, prostate disease, kidney disease, dehydration, infection, heart failure, extremely low blood pressure, atherosclerosis, Hemolytic uremic syndrome, IgA nephropathy, ureter or bladder obstruction and some medications can all lead to kidney failure. Thus, these disorders, and many more, can be diagnosed and/or monitored by the presence (or absence) of specific analytes in a sample (e.g. urine).

### C. Definitions

It is understood that the disclosed method and compositions are not limited to the particular methodology, protocols, and reagents described as these may vary. It is also to be understood that the terminology used herein is for the purpose of describing particular embodiments only, and is not intended to limit the scope of the present invention which will be limited only by the appended claims.

Unless defined otherwise, all technical and scientific terms used herein have the same meanings as commonly understood by one of skill in the art to which the disclosed method and compositions belong. Although any methods and materials similar or equivalent to those described herein can be used in the practice or testing of the present method and compositions, the particularly useful methods, devices, and materials are as described. Publications cited herein and the material for which they are cited are hereby specifically incorporated by reference. Nothing herein is to be construed as an admission that the present invention is not entitled to antedate such disclosure by virtue of prior invention. No admission is made that any reference constitutes prior art. The discussion of references states what their authors assert, and applicants reserve the right to challenge the accuracy and pertinence of the cited documents. It will be clearly understood that, although a number of publications are referred to herein, such reference does not constitute an admission that any of these documents forms part of the common general knowledge in the art.

1. A

As used in the specification and the appended claims, the singular forms “a,” “an” and “the” or like terms include plural referents unless the context clearly dictates otherwise. Thus, for example, reference to “a PDE inhibitor” includes mixtures of two or more such inhibitors, and the like.

2. Abbreviations

Abbreviations, which are well known to one of ordinary skill in the art, may be used (e.g., “h” or “hr” for hour or hours, “g” or “gm” for gram(s), “mL” for milliliters, and “rt” for room temperature, “nm” for nanometers, “M” for molar, and like abbreviations).

3. About

About modifying, for example, the quantity of an ingredient in a composition, concentrations, volumes, process temperature, process time, yields, flow rates, pressures, and like values, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or ingredients used to carry out the methods; and like considerations. The term “about” also encompasses amounts that differ due to aging of a composition or formulation with a particular initial concentration or mixture, and amounts that differ due to mixing or processing a composition or formulation with a particular initial concentration or mixture. Whether modified by the term “about” the claims appended hereto include equivalents to these quantities.

4. Analytes

Analytes are any target molecule to be detected or measured. That is, any molecule of interest can be a target molecule. Useful target molecules can include, for example, proteins, nucleic acids, drugs, hormones, macromolecules, microorganisms and cells.

A variety of analytes can be detected or quantified by present invention. The analyte may be an infectious agent or indicative of an infected state. The analyte may be a drug (for example a drug of abuse), a hormone, a protein, a nucleic acid molecule, an etiological agent, or a specific binding pair member. The term “drug of abuse” refers to a drug that is taken for non-medicinal reasons (usually for mind-altering effects). Legal drugs that are taken for medical reasons, but on which overdose can easily occur may also be tested for with the present invention, for example, tricyclic antidepressants (imipramine and the like) and over the counter products containing acetaminophen.

Another example of an analyte that can be detected in the present invention is creatinine. Typically, the detection of creatinine is used as a calorimetric indicator to confirm that a urine sample is sufficiently concentrated for detection of other compounds, such as urinary steroids, fertility hormones and urinary proteins indicative of bone resorption or bone deposition. These other compounds can also be detected with the present invention. Examples of fertility hormones include estrogen, progesterone, and their metabolites such as estradiol, estrone, estriol, or pregnendiol glucuronide (PDG). Another analyte suitable for detection using the methods of the invention is pancreatic amylase. For instance, immunoassays can be used for assessing abnormal levels of pancreatic amylase in serum and urine which are indicative, for example, of pancreatitis, acute alcohol ingestion or poisoning, renal malfunction or advanced cystic fibrosis.

5. Analyzer Parts

i. Flow Through (15)

The flow through is the solution that is present in the second chamber of the analyzer. The flow through can comprise analytes. The analytes in the flow through can be the analyte(s) of interest but more commonly the flow through will primarily contain analytes other than the analyte(s) of interest. In general, the flow through is anything from the sample that passes through the solid substrate but does not bind to the solid substrate.

ii. Pre Solid Substrate (22)

The pre-solid substrate can be placed above the solid substrate. The pre-solid substrate can be positioned directly on top of the solid support lock. The pre-solid substrate can be comprised of the same materials as the solid substrate. The purpose of the pre-solid substrate is to eliminate any unwanted analytes from the sample before the sample contacts the solid substrate. Thus, the pre-solid substrate can be used as a subtraction method.

The pre-solid substrate can be comprised of a pre-filter(s). The pre-filter(s) can be a variety of filter types. They can be positioned above the solid substrate, most commonly on top of the solid support lock. The pre-filter(s) serve to eliminate substances from the sample that could interfere with the target analytes binding to the solid substrate. Pre-filters are primarily used for large particles such as cells, tissue, hair or fibers.

There can be a first, second or third pre-solid substrate. The multiple pre-solid substrates can serve several functions. The first pre-solid substrate can be comprised of a pre-filter in which it collects large particles from the sample. The second and third pre-solid substrates can be comprised of beads conjugated to an antibodies specific for an unwanted analytes. This allows for simultaneous (i.e. in one step opposed to multiple steps) removal or collection of unwanted contaminants or analytes.

iii. Solid Substrate

Solid substrates for use in the disclosed methods can include any solid material to which components of the disclosed methods, such as capture tags and capture docks can be coupled, directly or indirectly. This includes materials such as acrylamide, cellulose, nitrocellulose, glass, polystyrene, polyvinylidene fluoride (PVDF), filter paper (Whatman), Glass fiber filters (GFC) (A,B,C), polyethylimine coated GFCs, porous mylar or other transparent porous films, cellulose nitrate (CN) membrane, mixed cellulose ester membrane, cellulose acetate membrane, polyethersulfone (PES) membrane, PTFE membrane, ultrafiltration membranes of poly(vinyl chloride) (PVC), carboxylated poly(vinyl chloride) (CPVC), polystyrene, polyethylene vinyl acetate, polypropylene, polymethacrylate, polyethylene, polyethylene oxide, glass, polysilicates, polycarbonates, teflon, fluorocarbons, nylon, silicon rubber, polyanhydrides, polyglycolic acid, polylactic acid, polyorthoesters, polypropylfumerate, collagen, glycosaminoglycans, and polyamino acids.

Glass fiber filters (GFC) (A,B,C), polyethylimine coated GFCs, porous mylar or other transparent porous films, cellulose nitrate (CN) membrane, mixed cellulose ester membrane, cellulose acetate membrane, polyethersulfone (PES) membrane, PTFE membrane, ultrafiltration membranes of poly(vinyl chloride) (PVC), carboxylated poly(vinyl chloride) (CPVC), polystyrene, polyethylene vinyl acetate, polypropylene, polymethacrylate, polyethylene, polyethylene oxide, glass, polysilicates, polycarbonates, teflon, fluorocarbons, nylon, silicon rubber, polyanhydrides, polyglycolic acid, polylactic acid, polyorthoesters, polypropylfumerate, collagen, glycosaminoglycans, and polyamino acids.

Solid substrates can have any useful form including thin films or membranes, beads, columns, dishes, fibers, tubes, slides, woven fibers, shaped polymers, particles and microparticles. Preferred forms of the solid substrate are membranes and beads. The beads can be magnetic or coupled to capture docks such as protein G.

The solid substrates, such as porous mylar or other transparent porous films can be used to trap cells, provide support for cells to be stained and/or fixed and subjected to light microscopy. Filter paper CN membrane is the most popular membrane used in analytical and laboratory filtration due to its excellent wetting properties and fast flow rates with aqueous solutions. Mixed Cellulose Ester membrane provides a more uniform and smoother surface compared to pure nitrocellulose membrane. This membrane is typically used to count or analyze particles contained in liquids or captured from aerosols. Cellulose Acetate membrane is a mixture of cellulose triacetate and diacetate that creates a strong membrane in both lateral and longitudinal directions. In addition, the membrane has a low static charge, a very low aqueous extractability, and good solvent resistance to low molecular weight alcohols. Nylon membrane is strong, inherently hydrophilic, and compatible with a broad range of aqueous solutions including alcohols and solvents used in HPLC work. Polyethersulfone (PES) membrane is hydrophilic and low protein binding. No external wetting agents are required, resulting in low extractables. PES membrane generally offers a fast flow rate and better chemical resistance than cellulose acetate membranes. PTFE membrane is strong, highly porous, and inert to most chemically aggressive solvents, strong acids, and bases. Chemical and thermal limitations are imposed by the backing material.

Detection agents, capture tags, and capture docks, or other molecules can be conjugated to a solid substrate. Capture substrates are solid substrates to which capture tags or docks have been covalently or non-covalently linked. Detection substrates are substrates to which a detection agent has been conjugated covalently or non-covalently linked.

Detection agents and capture docks can be directly or indirectly conjugated to the solid substrate. Direct conjugation to the solid substrate can be achieved via reactive groups. In some embodiments, the material comprising the solid support has reactive groups such as carboxy, amino, hydroxy, etc., which are used for covalent or non-covalent attachment of the specific binding agents. Suitable polymers may include, but are not limited to, polystyrene, polyethylene glycol tetraphthalate, polyvinyl acetate, polyvinyl chloride, polyvinyl pyrrolidone, polyacrylonitrile, polymethyl methacrylate, polytetrafluoroethylene, butyl rubber, styrenebutadiene rubber, natural rubber, polyethylene, polypropylene, (poly)tetrafluoroethylene, (poly)vinylidenefluoride, polycarbonate and polymethylpentene. Other polymers include those outlined in U.S. Pat. No. 5,427,779 to Elsner, H. et al., hereby expressly incorporated by reference.

Indirect conjugation to the solid substrate can be achieved in a variety of ways. Generally, indirect conjugation is conjugation via or through one or more intervening components. For example, detection agents and capture molecules can be conjugated with biotin and the solid support can be conjugated with avidin or streptavidin, or vice versa. Biotin binds selectively to streptavidin and thus, the specific binding agent can be conjugated with the solid support in this indirect manner. Alternatively, to achieve indirect conjugation of the detection agent with the solid support, the specific binding agent is conjugated with a small hapten (e.g., digoxin) and one of the solid support is conjugated with an anti-hapten polypeptide variant (e.g., anti-digoxin antibody). Thus, indirect conjugation of the detection agent with the solid support can be achieved (Hermanson, G. (1996) in Bioconjugate Techniques Academic Press, San Diego).

There can be multiple solid substrates. For instance, there can be a first, second or third solid substrate wherein each solid substrate binds either the same analyte or different analytes of interest. Each of the first, second, or third solid substrate can be supported by a separate solid substrate support.

iv. Solid Support Lock (21)

The solid support lock can be comprised of a variety of materials. It can fit into the solid substrate support with several mechanisms, most commonly it can either snap or screw into the solid substrate support. The solid support lock sits above a sealer which is usually present between the solid support lock and the solid substrate support. The solid support lock can secure the solid substrate between the solid substrate support and the sealer in order to prevent or limit the sample from bypassing the solid substrate and leaking around the edges of the solid substrate (i.e. membrane).

v. Support Screen (20)

The support screen can be positioned in the solid substrate support. The primary function of the support screen is to support the solid substrate. The screen can be comprised of a variety of materials. It comprises pores or openings that allow the sample to flow through.

vi. First Chamber (5)

The first chamber is the open area in the top half of the analyzer. The first chamber holds the sample before processing. It can be a variety of shapes and sizes. The first chamber can be separated from the second chamber via the vacuum generator (7) and the chamber (10).

vii. Unbound Analytes (14)

The unbound analytes can be either the target analytes that did not bind to the solid substrate or they can be other analytes that were not targeted during sample processing. The unbound analytes can be found in the flow through in the second chamber of the analyzer. Thus, unbound analytes can be any analyte present in the flow through.

6. Antibodies

Antibodies can be used for a variety of purposes including as detection agents in the disclosed methods. Antibodies can be either monoclonal or polyclonal antibodies. Mixtures of monoclonal and polyclonal antibodies can also be used. The disclosed methods can make use of antibodies produced with specific binding properties. For example, antibodies can be used to bind specific analytes, such as proteins. For instance, monoclonal or polyclonal antibodies that specifically bind to a particular protein can be produced and used in the disclosed methods to bind to the specific protein in the disclosed methods. Such binding can be used in a variety of ways in the disclosed methods, such as for enrichment of a specific protein, for detecting a specific protein, and for removing unwanted molecules from the sample before detecting target molecules.

i. Antibodies Generally

The term “antibodies” is used herein in a broad sense and includes both polyclonal and monoclonal antibodies. In addition to intact immunoglobulin molecules, also included in the term “antibodies” are fragments or polymers of those immunoglobulin molecules, and human or humanized versions of immunoglobulin molecules or fragments thereof, as described herein. Antibodies can be tested for their desired activity using the in vitro assays described herein, or by analogous methods.

As used herein, the term “antibody” encompasses, but is not limited to, whole immunoglobulin (i.e., an intact antibody) of any class. Native antibodies are usually heterotetrameric glycoproteins, composed of two identical light (L) chains and two identical heavy (H) chains. Typically, each light chain is linked to a heavy chain by one covalent disulfide bond, while the number of disulfide linkages varies between the heavy chains of different immunoglobulin isotypes. Each heavy and light chain also has regularly spaced intrachain disulfide bridges. Each heavy chain has at one end a variable domain (V (H)) followed by a number of constant domains. Each light chain has a variable domain at one end (V (L)) and a constant domain at its other end; the constant domain of the light chain is aligned with the first constant domain of the heavy chain, and the light chain variable domain is aligned with the variable domain of the heavy chain. Particular amino acid residues are believed to form an interface between the light and heavy chain variable domains. The light chains of antibodies from any vertebrate species can be assigned to one of two clearly distinct types, called kappa (κ) and lambda (λ), based on the amino acid sequences of their constant domains. Depending on the amino acid sequence of the constant domain of their heavy chains, immunoglobulins can be assigned to different classes. There are five major classes of human immunoglobulins: IgA, IgD, IgE, IgG and IgM, and several of these may be further divided into subclasses (isotypes), e.g., IgG-1, IgG-2, IgG-3, and IgG-4; IgA-1 and IgA-2. One skilled in the art would recognize the comparable classes for mouse. The heavy chain constant domains that correspond to the different classes of immunoglobulins are called alpha, delta, epsilon, gamma, and mu, respectively.

The term “variable” is used herein to describe certain portions of the variable domains that differ in sequence among antibodies and are used in the binding and specificity of each particular antibody for its particular antigen. However, the variability is not usually evenly distributed through the variable domains of antibodies. It is typically concentrated in three segments called complementarity determining regions (CDRs) or hypervariable regions both in the light chain and the heavy chain variable domains. The more highly conserved portions of the variable domains are called the framework (FR). The variable domains of native heavy and light chains each comprise four FR regions, largely adopting a beta-sheet configuration, connected by three CDRs, which form loops connecting, and in some cases forming part of, the beta-sheet structure. The CDRs in each chain are held together in close proximity by the FR regions and, with the CDRs from the other chain, contribute to the formation of the antigen binding site of antibodies (see Kabat E. A. et al., “Sequences of Proteins of Immunological Interest,” National Institutes of Health, Bethesda, Md. (1987)). The constant domains are not involved directly in binding an antibody to an antigen, but exhibit various effector functions, such as participation of the antibody in antibody-dependent cellular toxicity.

As used herein, the term “antibody or fragments thereof” encompasses chimeric antibodies and hybrid antibodies, with dual or multiple antigen or epitope specificities, and fragments, such as scFv, sFv, F (ab′)2, Fab′, Fab and the like, including hybrid fragments. Thus, fragments of the antibodies that retain the ability to bind their specific antigens are provided. For example, fragments of antibodies which, for example, maintain protein binding activity are included within the meaning of the term “antibody or fragment thereof” Such antibodies and fragments can be made by techniques known in the art and can be screened for specificity and activity according to the methods set forth in the Examples and in general methods for producing antibodies and screening antibodies for specificity and activity (See Harlow and Lane. Antibodies, A Laboratory Manual. Cold Spring Harbor Publications, New York, (1988)).

Also included within the meaning of “antibody or fragments thereof” are conjugates of antibody fragments and antigen binding proteins (single chain antibodies) as described, for example, in U.S. Pat. No. 4,704,692, the contents of which are hereby incorporated by reference.

The fragments, whether attached to other sequences or not, can also include insertions, deletions, substitutions, or other selected modifications of particular regions or specific amino acids residues, provided the activity of the antibody or antibody fragment is not significantly altered or impaired compared to the non-modified antibody or antibody fragment. These modifications can provide for some additional property, such as to remove/add amino acids capable of disulfide bonding, to increase its bio-longevity, to alter its secretory characteristics, etc. In any case, the antibody or antibody fragment must possess a bioactive property, such as specific binding to its cognate antigen. Functional or active regions of the antibody or antibody fragment may be identified by mutagenesis of a specific region of the protein, followed by expression and testing of the expressed polypeptide. Such methods are readily apparent to a skilled practitioner in the art and can include site-specific mutagenesis of the nucleic acid encoding the antibody or antibody fragment. (Zoller, M. J. Curr. Opin. Biotechnol. 3:348-354, 1992).

ii. Monoclonal Antibodies

The term monoclonal antibody as used herein refers to an antibody obtained from a substantially homogeneous population of antibodies, i.e., the individual antibodies within the population are identical except for possible naturally occurring mutations that may be present in a small subset of the antibody molecules. The monoclonal antibodies herein specifically include “chimeric” antibodies in which a portion of the heavy and/or light chain is identical with or homologous to corresponding sequences in antibodies derived from a particular species or belonging to a particular antibody class or subclass, while the remainder of the chain (s) is identical with or homologous to corresponding sequences in antibodies derived from another species or belonging to another antibody class or subclass, as well as fragments of such antibodies, as long as they exhibit the desired antagonistic activity (See, U.S. Pat. No. 4,816,567 and Morrison et al., Proc. Natl. Acad. Sci. USA, 81:6851-6855 (1984)).

Monoclonal antibodies of the invention can be prepared using hybridoma methods, such as those described by Kohler and Milstein, Nature, 256:495 (1975). In a hybridoma method, a mouse or other appropriate host animal is typically immunized with an immunizing agent to elicit lymphocytes that produce or are capable of producing antibodies that will specifically bind to the immunizing agent. Alternatively, the lymphocytes may be immunized in vitro, e.g., using the complexes described herein.

Transgenic animals (e.g., mice) that are capable, upon immunization, of producing a full repertoire of human antibodies in the absence of endogenous immunoglobulin production can be employed. For example, it has been described that the homozygous deletion of the antibody heavy chain joining region (J (H)) gene in chimeric and germ-line mutant mice results in complete inhibition of endogenous antibody production. Transfer of the human germ-line immunoglobulin gene array in such germ-line mutant mice will result in the production of human antibodies upon antigen challenge (see, e.g., Jakobovits et al., Proc. Natl. Acad. Sci. USA, 90:2551-255 (1993); Jakobovits et al., Nature, 362:255-258 (1993); Bruggemann et al., Year in Immuno., 7:33 (1993)). Human antibodies can also be produced in phage display libraries (Hoogenboom et al., J. Mol. Biol., 227:381 (1991); Marks et al., J. Mol. Biol., 222:581 (1991)). The techniques of Cote et al. and Boerner et al. are also available for the preparation of human monoclonal antibodies (Cole et al., Monoclonal Antibodies and Cancer Therapy, Alan R. Liss, p. 77 (1985); Boerner et al., J. Immunol., 147 (1):86-95 (1991)).

Generally, either peripheral blood lymphocytes (“PBLs”) are used in methods of producing monoclonal antibodies if cells of human origin are desired, or spleen cells or lymph node cells are used if non-human mammalian sources are desired. The lymphocytes are then fused with an immortalized cell line using a suitable fusing agent, such as polyethylene glycol, to form a hybridoma cell (Goding, “Monoclonal Antibodies: Principles and Practice” Academic Press, (1986) pp. 59-103) Immortalized cell lines are usually transformed mammalian cells, including myeloma cells of rodent, bovine, equine, and human origin. Usually, rat or mouse myeloma cell lines are employed. The hybridoma cells may be cultured in a suitable culture medium that preferably contains one or more substances that inhibit the growth or survival of the unfused, immortalized cells. For example, if the parental cells lack the enzyme hypoxanthine guanine phosphoribosyl transferase (HGPRT or HPRT), the culture medium for the hybridomas typically will include hypoxanthine, aminopterin, and thymidine (“HAT medium”), which substances prevent the growth of HGPRT-deficient cells. Preferred immortalized cell lines are those that fuse efficiently, support stable high level expression of antibody by the selected antibody-producing cells, and are sensitive to a medium such as HAT medium. More preferred immortalized cell lines are murine myeloma lines, which can be obtained, for instance, from the Salk Institute Cell Distribution Center, San Diego, Calif. and the American Type Culture Collection, Rockville, Md. Human myeloma and mouse-human heteromyeloma cell lines also have been described for the production of human monoclonal antibodies (Kozbor, J. Immunol., 133:3001 (1984); Brodeur et al., “Monoclonal Antibody Production Techniques and Applications” Marcel Dekker, Inc., New York, (1987) pp. 51-63). The culture medium in which the hybridoma cells are cultured can then be assayed for the presence of monoclonal antibodies directed against RNA/DNA hybrids, for example. Preferably, the binding specificity of monoclonal antibodies produced by the hybridoma cells is determined by immunoprecipitation or by an in vitro binding assay, such as radioimmunoassay (RIA) or enzyme-linked immunoabsorbent assay (ELISA). Such techniques and assays are known in the art, and are described further in the Examples below or in Harlow and Lane “Antibodies, A Laboratory Manual” Cold Spring Harbor Publications, New York, (1988).

After the desired hybridoma cells are identified, the clones may be subcloned by limiting dilution or FACS sorting procedures and grown by standard methods. Suitable culture media for this purpose include, for example, Dulbecco's Modified Eagle's Medium and RPMI-1640 medium. Alternatively, the hybridoma cells may be grown in vivo as ascites in a mammal.

The monoclonal antibodies secreted by the subclones may be isolated or purified from the culture medium or ascites fluid by conventional immunoglobulin purification procedures such as, for example, protein A-Sepharose, protein G, hydroxylapatite chromatography, gel electrophoresis, dialysis, or affinity chromatography.

The monoclonal antibodies may also be made by recombinant DNA methods, such as those described in U.S. Pat. No. 4,816,567 (Cabilly et al.). DNA encoding the monoclonal antibodies of the invention can be readily isolated and sequenced using conventional procedures (e.g., by using oligonucleotide probes that are capable of binding specifically to genes encoding the heavy and light chains of murine antibodies). Libraries of antibodies or active antibody fragments can also be generated and screened using phage display techniques, e.g., as described in U.S. Pat. No. 5,804,440 to Burton et al. and U.S. Pat. No. 6,096,441 to Barbas et al.

In vitro methods are also suitable for preparing monovalent antibodies. Digestion of antibodies to produce fragments thereof, particularly, Fab fragments, can be accomplished using routine techniques known in the art. For instance, digestion can be performed using papain. Examples of papain digestion are described in WO 94/29348 published Dec. 22, 1994 and U.S. Pat. No. 4,342,566. Papain digestion of antibodies typically produces two identical antigen binding fragments, called Fab fragments, each with a single antigen binding site, and a residual Fc fragment. Pepsin treatment yields a fragment that has two antigen combining sites and is still capable of cross-linking antigen.

iii. Antibody Fragments

Also disclosed are fragments of antibodies which have binding activity. The polypeptide fragments of the present invention can be recombinant proteins obtained by cloning nucleic acids encoding the polypeptide in an expression system capable of producing the polypeptide fragments thereof, such as an adenovirus or baculovirus expression system. For example, amino acids found to not contribute to either the activity or the binding specificity or affinity of the antibody can be deleted without a loss in the respective activity. For example, in various embodiments, amino or carboxy-terminal amino acids are sequentially removed from either the native or the modified non-immunoglobulin molecule or the immunoglobulin molecule and the respective activity assayed in one of many available assays. In another example, a fragment of an antibody comprises a modified antibody wherein at least one amino acid has been substituted for the naturally occurring amino acid at a specific position, and a portion of either amino terminal or carboxy terminal amino acids, or even an internal region of the antibody, has been replaced with a polypeptide fragment or other moiety, such as biotin, which can facilitate in the purification of the modified antibody. For example, a modified antibody can be fused to a maltose binding protein, through either peptide chemistry or cloning the respective nucleic acids encoding the two polypeptide fragments into an expression vector such that the expression of the coding region results in a hybrid polypeptide. The hybrid polypeptide can be affinity purified by passing it over an amylose affinity column, and the modified antibody receptor can then be separated from the maltose binding region by cleaving the hybrid polypeptide with the specific protease factor Xa. (See, for example, New England Biolabs Product Catalog, 1996, pg. 164.). Similar purification procedures are available for isolating hybrid proteins from eukaryotic cells as well.

The fragments, whether attached to other sequences or not, include insertions, deletions, substitutions, or other selected modifications of particular regions or specific amino acids residues, provided the activity of the fragment is not significantly altered or impaired compared to the nonmodified antibody or antibody fragment. These modifications can provide for some additional property, such as to remove or add amino acids capable of disulfide bonding, to increase its bio-longevity, to alter its secretory characteristics, etc. In any case, the fragment must possess a bioactive property, such as binding activity, regulation of binding at the binding domain, etc. Functional or active regions of the antibody may be identified by mutagenesis of a specific region of the protein, followed by expression and testing of the expressed polypeptide. Such methods are readily apparent to a skilled practitioner in the art and can include site-specific mutagenesis of the nucleic acid encoding the antigen. (Zoller M J et al. Nucl. Acids Res. 10:6487-500 (1982).

A variety of immunoassay formats may be used to select antibodies that selectively bind with a particular protein, variant, or fragment. For example, solid-phase ELISA immunoassays are routinely used to select antibodies selectively immunoreactive with a protein, protein variant, or fragment thereof. See Harlow and Lane. Antibodies, A Laboratory Manual. Cold Spring Harbor Publications, New York, (1988), for a description of immunoassay formats and conditions that could be used to determine selective binding. The binding affinity of a monoclonal antibody can, for example, be determined by the Scatchard analysis of Munson et al., Anal. Biochem., 107:220 (1980).

7. Assaying

Assaying, assay, or like terms refers to an analysis to determine a characteristic of a substance, such as a molecule or a cell, such as for example, the presence, absence, quantity, extent, kinetics, dynamics, or type of cell activity or detector agent and detector target interaction.

8. Body Fluid

The term “body fluid,” as used herein is intended to include body fluids or excretions that may be extracted, isolated or sampled including fluids naturally occurring in the body (for example, urine, stool, blood—whole serum or plasma—, spinal fluid, cerebrospinal fluid, ocular lens liquid, semen, synovial fluid, peritoneal fluid, pleural fluid, sputum, lymph fluid, saliva, amniotic fluid, pus, lavage fluid, sweat, bile, tears, exosomes, nanoparticles, nanotubes, vomit, cerumen (earwax), gastric juice, pancreatic juice, breast milk, mucus, sebum (skin oil), vaginal secretion, aqueous humour, pericardial fluid, lymph, chyme, prostatic fluid.). Body fluid is also intended to include an artificial solution of fluid that has been equilibrated with the blood (or otherwise mixed with a naturally occurring body fluid) and thus taken up considerable fluid and solutes from the body. For example, in certain embodiments peritoneal fluid may be considered a body fluid. Peritoneal fluid is, for example, fluid found in the peritoneal cavity of an individual, often due to insertion of peritoneal dialysis buffer into the peritoneal cavity or secondary to liver failure leading to ascities.

9. Buffers and Detergents

Disclosed are detergents and buffers used in the present invention. The reagents can be used during analyte binding to substrate or detection agent. The reagents can enhance analyte binding, decrease non-specific binding, lyse cells, buffer the fluid by altering the pH or help protect the analyte of interest. The reagents can be used in a variety of forms such as tablet or liquid.

Detergents include sodium dodecyl sulfate, CHAPS, octyl glucoside, digitonin, IGEPAL, Triton X-100, tween 20, Nonidet-P40. Other detergent can be used such as ASB-14 (Zwitterionic amidosulfobetaine detergents useful for solubilizing proteins visualized by 2D-electrophoresis), ASB-C80 (zwitterionic detergent containing an aromatic core that stabilizes and solubilizes integral membrane proteins by breaking aggregates; reported to be superior to CHAPS in solubilizing both an anion-channel and a G-protein coupled receptor), and ASB ZWITTERGENT (1 g each of: ASB-14, ASB-16, and ASB-C80).

Also disclosed are ionic detergents and bile salts including Cetyltrimethylammonium bromide; Chenodeoxycholic Acid, Free Acid; Chenodeoxycholic Acid, Sodium Salt; Cholic Acid, Sodium Salt; Deoxycholic Acid, Sodium Salt; Glycocholic Acid, Sodium Salt; Glycoursodeoxycholic Acid, Sodium Salt; Lauroylsarcosine, Sodium Salt; LPD-12; Sodium n-Dodecyl Sulfate; Taurochenodeoxycholic Acid, Sodium Salt; Taurocholic Acid, Sodium Salt; Taurodeoxycholic Acid, Sodium Salt; Tauroursodeoxycholic Acid, Sodium Salt; Ursodeoxycholic Acid, Sodium Salt.

Also disclosed are non-detergent sulfobetaines (NDSB) such as NDSB-195 480001, NDSB-201 480005, NDSB-211 480013, NDSB-221 480014, NDSB-256 480010, NDSB-256-4T 480011.

Further disclosed are non-ionic detergents including APO-10; APO-12; Big CHAP; Big CHAP, Deoxy; BRIJ® 35 Detergent; C12E8; C12E8, PROTEIN GRADE® Detergent; Cyclohexyl-n-hexyl-b-D-maltoside; n-Decanoylsucros; n-Decyl-b-D-maltopyranoside; Digitonin, Alcohol-Soluble; Digitonin; n-Dodecanoylsucrose; n-Dodecyl-b-D-glucopyranoside; n-Dodecyl-b-D-maltoside; ELUGENT™ Detergent, 50% Solution 324707; GENAPOL® C-100, PROTEIN GRADE® Detergent, 10% Solution, Sterile-Filtered 345794; GENAPOL® X-080, PROTEIN GRADE® Detergent, 10% Solution, Sterile-Filtered 345796; GENAPOL® X-100, PROTEIN GRADE® Detergent, 10% Solution, Sterile-Filtered 345798; HECAMEG® 373272; n-Heptyl-b-D-glucopyranoside 375655; n-Heptyl-b-D-thioglucopyranoside, ULTROL® Grade, 10% Solution 375659; n-Hexyl-b-D-glucopyranoside 376965; MEGA-8, ULTROL® Grade 444926; MEGA-9, ULTROL® Grade 444930; MEGA-10, ULTROL® Grade 444934 n-Nonyl-b-D-glucopyranoside 488285; NP-40 Alternative 492016; NP-40 Alternative, PROTEIN GRADE® Detergent, 10% Solution, Sterile-Filtered 492018; n-Octanoylsucrose 494466; n-Octyl-b-D-glucopyranoside 494459; n-Octyl-b-D-glucopyranoside, ULTROL® Grade 494460; n-Octyl-b-D-maltopyranoside 494465; n-Octyl-b-D-thioglucopyranoside, ULTROL® Grade 494461; PLURONIC® F-127, PROTEIN GRADE® Detergent, 10% Solution, Sterile-Filtered 540025; TRITON® X-100 Detergent 648462; TRITON® X-100 Detergent, Hydrogenated 648465; TRITON® X-114, PROTEIN GRADE® Detergent, 10% Solution, Sterile-Filtered 648468; TRITON® X-100 Detergent, Molecular Biology Grade 648466; TRITON® X-100, Hydrogenated, PROTEIN GRADE® Detergent, 10% Solution, Sterile-Filtered 648464; TWEEN® 20 Detergent 655205; TWEEN® 20 Detergent, Molecular Biology Grade 655204; TWEEN® 20, PROTEIN GRADE® Detergent, 10% Solution, Sterile-Filtered 655206; TWEEN® 80, PROTEIN GRADE® Detergent, 10% Solution, Sterile-Filtered 655207.

Also disclosed in the present invention are Zwitterionic detergents. These include ASB ZWITTERGENT® Set 182753; ASB-14 182750; ASB-14-4 182751; ASB-16 182755; ASB-C6Ø 182728; ASB-C7BzO 182729; ASB-C8Ø 182730; CHAPS 220201; CHAPSO 220202; DDMAB 252000; DDMAU 252005; PMAL-B-100 528200; ZWITTERGENT® 3-08 Detergent 693019; ZWITTERGENT® 3-10 Detergent 693021; ZWITTERGENT® 3-12 Detergent 693015; ZWITTERGENT® 3-14 Detergent 693017; ZWITTERGENT® 3-16 Detergent 693023; ZWITTERGENT® Test Kit 693030.

Other disclosed detergents include those available from Sigma-Aldrich. Examples include 1-Octanesulfonic acid sodium salt; SigmaUltra O8380 1-Octanesulfonic acid sodium salt ˜98%; B2156 Benzethonium hydroxide solution ˜1.0 M in methanol (by HCl titration); P4391 Brij® 30; 235989 Brij® 30 average Mₙ˜362; 16001 Brij® 30 main component: tetraethylene glycol dodecyl ether; 16012 Brij® 35 P solution BioChemika, ˜10% in H₂O; 16005 Brij® 35 P BioChemika, main component: tricosaethylene glycol dodecyl ether; B4184 Brij® 35 solution 30% (w/v); P1254 Brij® 35 suitable for Stein-Moore chromatography; C3023 CHAPS ≧98% (TLC); C5070 CHAPS SigmaUltra, ≧98% (TLC); C9426 CHAPS for electrophoresis, ≧98% (TLC); C1129 Cholic acid from ox or sheep bile, ≧98%; 30472 DCN 90 solution concentrate; P9769 Decaethylene glycol monododecyl ether; D141 Digitonin; D5628 Digitonin ˜50% (TLC); D1685 Docusate sodium meets USP testing specifications; 52350 Hexadecylpyridinium chloride monohydrate Ph Eur; H5882 Hexadecyltrimethylammonium bromide ≧98%, powder; H9151 Hexadecyltrimethylammonium bromide SigmaUltra, ˜99%; H6269 Hexadecyltrimethylammonium bromide for molecular biology, ˜99%; 238562 IGEPAL® CA-210 average Mₙ˜294; 238570 IGEPAL® CA-520 average Mₙ˜427; 17771 IGEPAL® CA-630 for electrophoresis, suitable for 2-D electrophoresis; 18896 IGEPAL® CA-630 for molecular biology; 13021 IGEPAL® CA-630 viscous liquid; 238589 IGEPAL® CA-720 average Mₙ˜735; L4632 Lithium dodecyl sulfate ≧98.5% (GC); L5901 Lithium dodecyl sulfate SigmaUltra, ≧98.5% (GC); L2274 Lithium dodecyl sulfate for electrophoresis, suitable for denatured polyacrylamide gel electrophoresis, especially at lower temperature conditions, ˜99% (GC); L9781 Lithium dodecyl sulfate for molecular biology, ˜99% (GC); 40232 N-Dodecyl-N,N-dimethyl-3-ammonio-1-propanesulfonate BioChemika, ≧97.0% (dried material, CHN); L5000 N-Lauroylsarcosine, neat ≧95%; 74385 Nonidet™ P 40 Substitute BioChemika, mixture of 15 homologues; O3757 Octyl β-D-glucopyranoside solution for electrophoresis, 50% (w/v) in H₂O; O8001 Octyl β-D-glucopyranoside ≧98% (GC); O9882 Octyl β-D-glucopyranoside SigmaUltra, >98% (GC); P6667 Poly(ethylene glycol) average mol wt 10,000; P3015 Poly(ethylene glycol) average mol wt 200; P8942 Polyoxyethylene (20) sorbitan monolaurate solution 10% in H₂O; P2690 Polyoxyethylene (20) sorbitan monolaurate solution 70% in H₂O; 93774 Polyoxyethylene (20) sorbitan monolaurate solution BioChemika, ampule, ˜10% in H₂O; 95754 Polysorbat 60 Ph Eur; 44112 Polysorbate 20 Ph Eur; 59924 Polysorbate 80 Ph Eur; 83462 RBS® 50 solution concentrate; 83465 RBS® Viro concentrate; 84510 Saponin BioChemika; 47036 Saponin BioChemika, for molecular biology; D3412 Sodium 1-decanesulfonate ˜98%; H2766 Sodium 1-heptanesulfonate; H8901 Sodium 1-heptanesulfonate SigmaUltra; C1254 Sodium cholate hydrate from ox or sheep bile, ≧99%; D5670 Sodium deoxycholate monohydrate SigmaUltra, ≧99% (titration); D6750 Sodium deoxycholate ≧97% (titration); 30970 Sodium deoxycholate BioChemika, ≧98.0% (dry matter, NT); L4522 Sodium dodecyl sulfate solution for molecular biology, 10% in 18 megohm water; 62862 Sodium dodecyl sulfate ≧90%; 436143 Sodium dodecyl sulfate ACS reagent, ≧99.0%; 71729 Sodium dodecyl sulfate BioChemika, ≧98.0% (GC); L4509 Sodium dodecyl sulfate ReagentPlus®, ≧98.5% (GC); L6026 Sodium dodecyl sulfate SigmaUltra, ≧99.0% (GC); 71717 Sodium dodecyl sulfate USP/NF, mixture of sodium alkyl sulfates consisting mainly of sodium dodecyl sulfate; L3771 Sodium dodecyl sulfate for electrophoresis, ≧98.5% (GC); L4390 Sodium dodecyl sulfate for molecular biology, ≧98.5% (GC); L5750 Sodium dodecyl sulfate ˜95% based on total alkyl sulfate content basis; G0759 Sodium glycochenodeoxycholate ≧97% (TLC) G7132 Sodium glycocholate hydrate ≧97% (TLC); H9026 Sodium hexanesulfonate SigmaUltra; H5269 Sodium hexanesulfonate ˜98%; O4003 Sodium octyl sulfate ˜95%; P0299 Sodium pentanesulfonate ≧95% (elemental analysis); P8199 Sodium pentanesulfonate SigmaUltra; T0875 Sodium taurodeoxycholate hydrate ≧95% (TLC); 85192 Sodium thiosulfate solution BioChemika, Silver stain kit component; P6585 TWEEN® 20 Low-peroxide; Low-carbonyls; P8341 TWEEN® 20 Low-peroxide; Low-carbonyls; P7949 TWEEN® 20 SigmaUltra; 274348 TWEEN® 20 average Mₙ˜1,228; P5927 TWEEN® 20 for electrophoresis, suitable for solubilizing agent of membrane proteins and as a blocking reagent in immunoblotting; P9416 TWEEN® 20 for molecular biology, viscous liquid; 93773 TWEEN® 20 viscosity 250-450 mPa·s (25° C.); P1379 TWEEN® 20 viscous liquid; P2287 TWEEN® 20 viscous liquid, cell culture tested; P2565 TWEEN® 21; P8192 TWEEN® 80 solution 10%, Low peroxide; P8074 TWEEN® 80 SigmaUltra; P4780 TWEEN® 80 cell culture tested, viscous liquid; P5188 TWEEN® 80 for molecular biology, syrup; P6224 TWEEN® 80 from non-animal source; P4675 TWEEN® 80 insect cell culture tested, viscous liquid; 93781 TWEEN® 80 viscosity 375-480 mPa·s (25° C.); P1754 TWEEN® 80 viscous liquid; P6349 TWEEN® 80 viscous liquid, Low Peroxide; P6474 TWEEN® 80 viscous liquid, Preservative Free, Low-peroxide; Low-carbonyls; T4009 Taurocholic acid hydrate sodium salt ≧95% (TLC); T7505 Tetramethylammonium hydroxide pentahydrate ≧97%; 93427 Triton® X-100 solution BioChemika, ampule, ˜10% in H₂O; X100PC Triton® X-100 Peroxide- and carbonyl, free; T9284 Triton® X-100 SigmaUltra; T8532 Triton® X-100 for electrophoresis; T8787 Triton® X-100 for molecular biology; X100 Triton® X-100 laboratory grade; X102 Triton® X-102; 93428 Triton® X-114 solution BioChemika, ampule, ˜10% in H₂O; 93422 Triton® X-114 BioChemika X114 Triton® X-114 laboratory grade; X15 Triton® X-15; X165 Triton® X-165 solution 70% in H₂O; X305 Triton® X-305 solution 70% in H₂O; X405 Triton® X-405 solution 70% in H₂O; T8761 Tyloxapol Reagent Grade; D4641 n-Dodecyl β-D-maltoside ≧98% (GC).

10. Buffer Capsule

A buffer capsule is a capsule containing one or more buffers, which when dissolved in a solution will buffer the solution.

11. Buffer Container

A buffer container is a container containing one or more buffers, which when dissolved in a solution will buffer the solution. Often the buffer container sequesters the buffer, such as stores the buffer, until an appointed moment when the buffer contents of the buffer container are allowed to mix with a surrounding liquid or substance.

12. Capsule

Other examples for materials included in the capsules are protease or phosphatase inhibitors, phospholipase inhibitors and glycosylase inhibitors. ###check

13. Capture Tag:Capture Dock

Detection agents can also be used as or be linked to a capture tag to bind to capture molecules, which allow the detection agent to be captured by, adhered to, or coupled to a solid substrate. This can allow any molecule bound to or conjugated with the capture tag to be captured by, adhered to, or coupled to a solid substrate. Capture tags can also bind to or be conjugated with a solid substrate. For example, a capture tag specific for a particular protein can be conjugated to a solid substrate (directly or via a capture molecule, for example), which allows the capture of the protein on the solid substrate. As another example, a capture tag specific for nucleic acids can bind to a solid substrate (directly or via a capture molecule, for example), which allows the capture of nucleic acids on the solid substrate. Thus, in some embodiments, detection agents can include capture tags and one portion of the detection agent can bind to an analyte, such as a protein or nucleic acid found in the disclosed samples, and another portion can bind to a solid substrate. Such capture allows simplified washing and handling of the analyte.

A capture tag is any compound that can be used to separate compounds or complexes having the capture tag from those that do not. Preferably, a capture tag is an antibody, nucleic acid or compound, such as a ligand or hapten, that binds to or interacts with another compound, such as ligand-binding molecule or an antibody. It is also preferred that such interaction between the capture tag and the capturing component (i.e. analyte) be a specific interaction, such as between a hapten and an antibody or a ligand and a ligand-binding molecule.

Capture tags can also be antibodies. The capture tag antibody can bind to the analyte of interest and allow for the capturing of the analyte on a solid substrate. The antibody can either be directly or indirectly conjugated to the solid substrate. The antibody can have a moiety that aids in the adherence of the antibody (capture tag) to a capture dock which is attached to the solid substrate. The moiety can be a variety of things for example, biotin, avidin, and strepavidin.

Capturing analytes on a solid substrate may be accomplished in several ways. In one embodiment, capture docks are adhered or coupled to the solid substrate. Capture docks are compounds or moieties that mediate adherence of an analyte by binding to, or interacting with, a capture tag which is bound to the analyte. Capture docks immobilized on a substrate allow capture of the analyte on the substrate. Such capture provides a convenient means of washing away reaction components that might interfere with subsequent steps. Capture docks can be biotin, avidin, strepavidin, antibodies (i.e. anti-antibody antibody or any antibody that binds the capture tag) or nucleic acids.

In one embodiment, the capture dock is an oligonucleotide. Methods for immobilizing and coupling oligonucleotides to substrates are well established. For example, suitable attachment methods are described by Pease et al., Proc. Natl. Acad. Sci. USA 91(11):5022-5026 (1994), and Khrapko et al., Mol Biol (Mosk) (USSR) 25:718-730 (1991). A method for immobilization of 3′-amine oligonucleotides on casein-coated slides is described by Stimpson et al., Proc. Natl. Acad. Sci. USA 92:6379-6383 (1995). A preferred method of attaching oligonucleotides to solid substrates is described by Guo et al., Nucleic Acids Res. 22:5456-5465 (1994).

In another embodiment, the capture dock is an antibody. Methods for immobilizing antibodies to substrates are well established. Immobilization can be accomplished by attachment, for example, to aminated surfaces, carboxylated surfaces or hydroxylated surfaces using standard immobilization chemistries. Examples of attachment agents are cyanogen bromide, succinimide, aldehydes, tosyl chloride, avidin-biotin, photocrosslinkable agents, epoxides and maleimides. A preferred attachment agent is glutaraldehyde. These and other attachment agents, as well as methods for their use in attachment, are described in Protein immobilization: fundamentals and applications, Richard F. Taylor, ed. (M. Dekker, New York, 1991), Johnstone and Thorpe, Immunochemistry In Practice (Blackwell Scientific Publications, Oxford, England, 1987) pages 209-216 and 241-242, and Immobilized Affinity Ligands, Craig T. Hermanson et al., eds. (Academic Press, New York, 1992). Antibodies can be attached to a substrate by chemically cross-linking a free amino group on the antibody to reactive side groups present within the substrate. For example, antibodies may be chemically cross-linked to a substrate that contains free amino or carboxyl groups using glutaraldehyde or carbodiimides as cross-linker agents. In this method, aqueous solutions containing free antibodies are incubated with the solid-state substrate in the presence of glutaraldehyde or carbodiimide. For crosslinking with glutaraldehyde the reactants can be incubated with 2% glutaraldehyde by volume in a buffered solution such as 0.1 M sodium cacodylate at pH 7.4. Other standard immobilization chemistries are known by those of skill in the art.

In one embodiment, capture tags, described in the context of nucleic acid probes, are described by Syvnen et al., Nucleic Acids Res., 14:5037 (1986). Preferred capture tags include a biotin labeled detection agent. Biotin can be incorporated into nucleic acids. In the disclosed method, a biotin label can allow the capture tags (to which the biotin is incorporated in) to be captured by, adhered to, or coupled to a substrate. Such capture allows simplified washing and handling of the analytes.

Capturing analytes on a solid substrate can be accomplished in several ways. In some forms, capture tags can be adhered or coupled to the solid substrate (either directly or indirectly via capture docks). Capture tags are a form of detection agent that mediate adherence of an analyte to a solid substrate by binding to, or interacting with, with the analyte and directly or indirectly with the solid substrate. For example, capture tags immobilized on a solid substrate allow capture of analytes (i.e. proteins, nucleic acids) on the solid substrate via capture tags that bind to both the analyte and to either the capture docks or solid substrate. Such capture provides a convenient means of separating analytes, such as specific proteins or nucleic acids, from other molecules in a sample, and of washing away reaction components that might interfere with subsequent steps.

The disclosed capture tags can also include one or more capture tags. For example, the capture tag can be two or more different detection agents.

14. Cell

Cell or like term refers to a small usually microscopic mass of protoplasm bounded externally by a semipermeable membrane, optionally including one or more nuclei and various other organelles, capable alone or interacting with other like masses of performing all the fundamental functions of life, and forming the smallest structural unit of living matter capable of functioning independently including synthetic cell constructs, cell model systems, and like artificial cellular systems.

A cell can include different cell types, such as a cell associated with a specific disease, a type of cell from a specific origin, a type of cell associated with a specific target, or a type of cell associated with a specific physiological function. A cell can also be a native cell, an engineered cell, a transformed cell, an immortalized cell, a primary cell, an embryonic stem cell, an adult stem cell, a cancer stem cell, or a stem cell derived cell.

Humans consist of about 210 known distinct cell types. The numbers of types of cells can almost unlimited, considering how the cells are prepared (e.g., engineered, transformed, immortalized, or freshly isolated from a human body) and where the cells are obtained (e.g., human bodies of different ages or different disease stages, etc).

15. Cell Culture

“Cell culture” or “cell culturing” refers to the process by which either prokaryotic or eukaryotic cells are grown under controlled conditions. “Cell culture” not only refers to the culturing of cells derived from multi-cellular eukaryotes, especially animal cells, but also the culturing of complex tissues and organs.

16. Components

Also disclosed are materials, compositions, and components that can be used for, can be used in conjunction with, can be used in preparation for, or are products of the disclosed method and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. For example, if a detection method is disclosed and discussed and a number of modifications that can be made to a number of compositions with the detection method are discussed, each and every combination and permutation of the detection and the modifications that are possible are specifically contemplated unless specifically indicated to the contrary. Thus, if a class of molecules A, B, and C are disclosed as well as a class of molecules D, E, and F and an example of a combination molecule, A-D is disclosed, then even if each is not individually recited, each is individually and collectively contemplated. Thus, is this example, each of the combinations A-E, A-F, B-D, B-E, B-F, C-D, C-E, and C-F are specifically contemplated and should be considered disclosed from disclosure of A, B, and C; D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all aspects of this application including, but not limited to, steps in methods of making and using the disclosed compositions. Thus, if there are a variety of additional steps that can be performed it is understood that each of these additional steps can be performed with any specific embodiment or combination of embodiments of the disclosed methods, and that each such combination is specifically contemplated and should be considered disclosed.

17. Compounds and Compositions

Compounds and compositions have their standard meaning in the art. It is understood that wherever, a particular designation, such as a molecule, substance, marker, cell, or reagent compositions comprising, consisting of, and consisting essentially of these designations are disclosed. Thus, where the particular designation marker is used, it is understood that also disclosed would be compositions comprising that marker, consisting of that marker, or consisting essentially of that marker. Where appropriate wherever a particular designation is made, it is understood that the compound of that designation is also disclosed. For example, if particular biological material, such as a PDE4 inhibitor, is disclosed, the PDE4 inhibitor in its compound form is also disclosed.

18. Comprise

Throughout the description and claims of this specification, the word “comprise” and variations of the word, such as “comprising” and “comprises,” means “including but not limited to,” and is not intended to exclude, for example, other additives, components, integers or steps.

19. Consisting Essentially Of

“Consisting essentially of” in embodiments refers to, for example, a surface composition, a method of making or using a surface composition, formulation, or composition on the surface of the biosensor, and articles, devices, or apparatus of the disclosure, and can include the components or steps listed in the claim, plus other components or steps that do not materially affect the basic and novel properties of the compositions, articles, apparatus, and methods of making and use of the disclosure, such as particular reactants, particular additives or ingredients, a particular agents, a particular cell or cell line, a particular surface modifier or condition, a particular ligand candidate, or like structure, material, or process variable selected. Items that may materially affect the basic properties of the components or steps of the disclosure or may impart undesirable characteristics to the present disclosure include, for example, decreased affinity of the cell for the biosensor surface, aberrant affinity of a stimulus for a cell surface receptor or for an intracellular receptor, anomalous or contrary cell activity in response to a ligand candidate or like stimulus, and like characteristics.

20. Characterizing

Characterizing or like terms refers to gathering information about any property of a substance, such as a ligand, molecule, marker, or cell, such as obtaining a profile for the ligand, molecule, marker, or cell.

21. Contacting

Contacting or like terms means bringing into proximity such that a molecular interaction can take place, if a molecular interaction is possible between at least two things, such as molecules, cells, at least a compound or composition, or at least two compositions, or any of these with an article(s) or with a machine. For example, contacting refers to bringing at least two compositions, molecules, articles, or things into contact, i.e. such that they are in proximity to mix or touch. For example, having a solution of composition A and cultured cell B and pouring solution of composition A over cultured cell B would be bringing solution of composition A in contact with cell culture B. Contacting a cell with a ligand would be bringing a ligand to the cell to ensure the cell has access to the ligand.

It is understood that anything disclosed herein can be brought into contact with anything else. For example, a cell can be brought into contact with a molecule, a detection agent, and a detection target and so forth.

22. Control

The terms control or “control levels” or “control cells” or like terms are defined as the standard by which a change is measured, for example, the controls are not subjected to the experiment, but are instead subjected to a defined set of parameters, or the controls are based on pre- or post-treatment levels. They can either be run in parallel with or before or after a test run, or they can be a pre-determined standard. For example, a control can refer to the results from an experiment in which the subjects or objects or reagents etc are treated as in a parallel experiment except for omission of the procedure or agent or variable etc under test and which is used as a standard of comparison in judging experimental effects. Thus, the control can be used to determine the effects related to the procedure or agent or variable etc. For example, if the effect of a test molecule on a cell was in question, one could a) simply record the characteristics of the cell in the presence of the molecule, b) perform a and then also record the effects of adding a control molecule with a known activity or lack of activity, or a control composition (e.g., the assay buffer solution (the vehicle)) and then compare effects of the test molecule to the control. In certain circumstances once a control is performed the control can be used as a standard, in which the control experiment does not have to be performed again and in other circumstances the control experiment should be run in parallel each time a comparison will be made.

23. Detection Agent

A detection agent is any substance, such as a molecule, such as a protein that can bind or interact specifically with a particular molecule or a particular class or type of compound or composition. For example, a detection agent can be an antibody that specifically binds to a molecule or analyte, such as protein or cocaine. As another example, a detection agent can be a molecule, such as a ligand, that specifically binds to or interacts with another compound, such as a ligand-binding molecule or an antibody. As another example, a detection agent can be a molecule that specifically binds to different analytes. The interaction between the detection agent and the bound component (i.e. detection target) can be a specific interaction, such as between an antigen and an antibody or a ligand and a ligand-binding molecule, such as a receptor.

A detection agent can comprise proteins, functional nucleic acids, carbohydrates, lipids, carbohydrate containing molecules, lipid containing molecules, aptamers, or peptidomimetics.

Detection agents can be used alone or in sets. Sets of detection agents are useful, for example, for detecting and measuring multiple detection targets. For example, a plurality of detection agents can be brought into contact with a sample, where each of the plurality of detection agents can be for a different detection target. For example, the different detection agents can each have a different label moiety which can result in detection of several detection targets in one assay.

Detection agents in a set can have a variety of relationships, which can be related to the intended use of the set of detection agents. For example, the different detection agents can be specific for different detection targets or can be specific for the same detection target but different epitopes (epitope: detection agent recognition motif, structure which reproduces specific contact between the detection agent and the detection target) of the same molecule. Targeting different epitopes of the same detection target can be important, particularly for urine proteins, because many proteins are cleaved/degraded in the urine and thus, different epitopes may need to be targeted.

Various detection agents are referred to herein as being “for” target molecules or detection targets. By this is meant that a given detection agent is intended to bind to the indicated target molecule or detection target.

Sets of detection agents can include any number of different detection agents. For example, sets of detection agents can have at least 2, 3, 4, 5, 6, 7, 8, 9 or 10 detection agents. Unless the context clearly indicates otherwise, reference to multiple detection agents refers to multiple different detection agents where the different detection agents have some difference in structure. Generally, the different detection agents will differ in binding specificity from each other. It should also be understood that the disclosed methods generally make use of multiple copies of any given component, such as an individual detection agent. Thus, for example, numerous identical copies of each of the different detection agents can be present.

A detection agent that interacts specifically with a particular analyte is said to be specific for that analyte. For example, where the detection agent is an antibody that binds to a particular antigen, the detection agent is said to be specific for that antigen. Specific binding or interaction can be specific for a class or group of molecules and is not limited to specific binding or interaction of one particular molecule (although many detection agents are specific for a particular molecule). Specificity of binding need not, and often will not, be absolute. Rather, specific binding or specific interaction refers to a preference for the detection agent for its target molecule. Such preference can be categorized as binding with, for example, at least 2, 3, 4, 5, 6, 7, 8, 9, 10, 11, 12, 13, 14, 15, 16, 17, 18, 19, 20, 30, 40, 50, 60, 70, 80, 90, 100, 200, 300, 400, 500, 600, 700, 800, 900, 10³, 10⁴, 10⁵, 10⁶ or 10⁷ greater affinity for the detection target than other molecules that are present. Useful detection agents, described in the context of nucleic acid probes, are described by Syvnen et al., Nucleic Acids Res., 14:5037 (1986). In the disclosed methods, detection agents can, for example, bind to analytes such as proteins or nucleic acids. Useful examples of detection agents can be proteins, such as antibodies and receptors, such as protein A, Protein G, avidin, streptavidin, or neutravidin, functional nucleic acids such as antisense or aptamers, as well as other macromolecules, such as carbohydrates or lipids or carbohydrate or lipid containing molecules or peptide mimetics.

A detection agent can be a capture tag and can be attached either covalently or non-covalently to a solid substrate. The detection agent can also be attached to other detection agents, as well as other molecules, such as a capture tag.

24. Detection Agent Capsule

A detection agent capsule is a capsule which contains a detection agent.

25. Fluorescent

The term fluorescent as used herein can be defined as a molecule having luminescence that is caused by the absorption of radiation at one wavelength followed by nearly immediate re-radiation usually at a different wavelength and that ceases almost at once when the incident radiation stops, as understood in the art.

26. Fluorescent Labeled Molecule

A fluorescent labeled molecule or like terms is a molecule containing a fluorophore moiety.

27. Fluorescent Moieties

Useful fluorescent moieties include fluorescein isothiocyanate (FITC), 5,6-carboxymethyl fluorescein, Texas red, nitrobenz-2-oxa-1,3-diazol-4-yl (NBD), coumarin, dansyl chloride, rhodamine, amino-methyl coumarin (AMCA), Eosin, Erythrosin, BODIPY®, Cascade Blue®, Oregon Green®, pyrene, lissamine, xanthenes, acridines, oxazines, phycoerythrin, macrocyclic chelates of lanthanide ions such as quantum Dye™, fluorescent energy transfer dyes, such as thiazole orange-ethidium heterodimer, and the cyanine dyes Cy3, Cy3.5, Cy5, Cy5.5 and Cy7. Examples of other specific fluorescent labels include 3-Hydroxypyrene 5,8,10-Tri Sulfonic acid, 5-Hydroxy Tryptamine (5-HT), Acid Fuchsin, Alizarin Complexon, Alizarin Red, Allophycocyanin, Aminocoumarin, Anthroyl Stearate, Astrazon Brilliant Red 4G, Astrazon Orange R, Astrazon Red 6B, Astrazon Yellow 7 GLL, Atabrine, Auramine, Aurophosphine, Aurophosphine G, BAO 9 (Bisaminophenyloxadiazole), BCECF, Berberine Sulphate, Bisbenzamide, Blancophor FFG Solution, Blancophor SV, Bodipy F1, Brilliant Sulphoflavin FF, Calcien Blue, Calcium Green, Calcofluor RW Solution, Calcofluor White, Calcophor White ABT Solution, Calcophor White Standard Solution, Carbostyryl, Cascade Yellow, Catecholamine, Chinacrine, Coriphosphine O, Coumarin-Phalloidin, CY3.1 8, CY5.1 8, CY7, Dans (1-Dimethyl Amino Naphaline 5 Sulphonic Acid), Dansa (Diamino Naphtyl Sulphonic Acid), Dansyl NH—CH3, Diamino Phenyl Oxydiazole (DAO), Dimethylamino-S-Sulphonic acid, Dipyrrometheneboron Difluoride, Diphenyl Brilliant Flavine 7GFF, Dopamine, Erythrosin ITC, Euchrysin, FIF (Formaldehyde Induced Fluorescence), Flazo Orange, Fluo 3, Fluorescamine, Fura-2, Genacryl Brilliant Red B, Genacryl Brilliant Yellow 10GF, Genacryl Pink 3G, Genacryl Yellow 5GF, Gloxalic Acid, Granular Blue, Haematoporphyrin, Indo-1, Intrawhite Cf Liquid, Leucophor PAF, Leucophor SF, Leucophor WS, Lissamine Rhodamine B200 (RD200), Lucifer Yellow CH, Lucifer Yellow VS, Magdala Red, Marina Blue, Maxilon Brilliant Flavin 10 GFF, Maxilon Brilliant Flavin 8 GFF, MPS (Methyl Green Pyronine Stilbene), Mithramycin, NBD Amine, Nitrobenzoxadidole, Noradrenaline, Nuclear Fast Red, Nuclear Yellow, Nylosan Brilliant Flavin EBG, Oxadiazole, Pacific Blue, Pararosaniline (Feulgen), Phorwite AR Solution, Phorwite BKL, Phorwite Rev, Phorwite RPA, Phosphine 3R, Phthalocyanine, Phycoerythrin R, Polyazaindacene Pontochrome Blue Black, Porphyrin, Primuline, Procion Yellow, Pyronine, Pyronine B, Pyrozal Brilliant Flavin 7GF, Quinacrine Mustard, Rhodamine 123, Rhodamine 5 GLD, Rhodamine 6G, Rhodamine B, Rhodamine B 200, Rhodamine B Extra, Rhodamine BB, Rhodamine BG, Rhodamine WT, Serotonin, Sevron Brilliant Red 2B, Sevron Brilliant Red 4G, Sevron Brilliant Red B, Sevron Orange, Sevron Yellow L, SITS (Primuline), SITS (Stilbene Isothiosulphonic acid), Stilbene, Snarf 1, sulpho Rhodamine B Can C, Sulpho Rhodamine G Extra, Tetracycline, Thiazine Red R, Thioflavin S, Thioflavin TCN, Thioflavin 5, Thiolyte, Thiozol Orange, Tinopol CBS, True Blue, Ultralite, Uranine B, Uvitex SFC, Xylene Orange, and XRITC.

Particularly useful fluorescent labels include fluorescein (5-carboxyfluorescein-N-hydroxysuccinimide ester), rhodamine (5,6-tetramethyl rhodamine), and the cyanine dyes Cy3, Cy3.5, Cy5, Cy5.5 and Cy7. The absorption and emission maxima, respectively, for these fluors are: FITC (490 nm; 520 nm), Cy3 (554 nm; 568 nm), Cy3.5 (581 nm; 588 nm), Cy5 (652 nm: 672 nm), Cy5.5 (682 nm; 703 nm) and Cy7 (755 nm; 778 nm), thus allowing their simultaneous detection. Other examples of fluorescein dyes include 6-carboxyfluorescein (6-FAM), 2′,4′,1,4,-tetrachlorofluorescein (TET), 2′,4′,5′,7′,1,4-hexachlorofluorescein (HEX), 2′,7′-dimethoxy-4′,5′-dichloro-6-carboxyrhodamine (JOE), 2′-chloro-5′-fluoro-7′,8′-fused phenyl-1,4-S dichloro-6-carboxyfluorescein (NED), and 2′-chloro-7′-phenyl-1,4-dichloro-6-carboxyfluorescein (VIC). Fluorescent labels can be obtained from a variety of commercial sources, including Amersham Pharmacia Biotech, Piscataway, N.J.; Molecular Probes, Eugene, Oreg.; and Research Organics, Cleveland, Ohio. Fluorescent probes and there use are also described in Handbook of Fluorescent Probes and Research Products by Richard P. Haugland.

Further examples of radioactive label moieties include gamma emitters, e.g., the gamma emitters In-111, I-125 and I-131, Rhenium-186 and 188, and Br-77 (see. e.g., Thakur, M. L. et al., Throm Res. Vol. 9 pg. 345 (1976); Powers et al., Neurology Vol. 32 pg. 938 (1982); and U.S. Pat. No. 5,011,686); positron emitters, such as Cu-64, C-11, and O-15, as well as Co-57, Cu-67, Ga-67, Ga-68, Ru-97, Tc-99m, In-113m, Hg-197, Au-198, and Pb-203. Other radioactive detectable agents can include, for example tritium, C-14 and/or thallium, as well as Rh-105, 1-123, Nd-147, Pm-151, Sm-153, Gd-159, Tb-161, Er-171 and/or T1-201.

The use of Technitium-99m (Tc-99m) is preferable and has been described in other applications, for example, see U.S. Pat. No. 4,418,052 and U.S. Pat. No. 5,024,829. Tc-99m is a gamma emitter with single photon energy of 140 keV and a half-life of about 6 hours, and can readily be obtained from a Mo-99/Tc-99 generator.

In some embodiments, compositions comprising radioactive label moieties can be prepared by coupling radioisotopes suitable for detection to the disclosed components and compositions. Coupling can be, for example, via a chelating agent such as diethylenetriaminepentaacetic acid (DTPA), 4,7,10-tetraazacyclododecane-N,N′,N″,N′″-tetraacetic acid (DOTA) and/or metallothionein, any of which can be covalently attached to the disclosed components, compounds, and compositions. In some embodiments, an aqueous mixture of technetium-99m, a reducing agent, and a water-soluble ligand can be prepared and then allowed to react with a disclosed component, compound, or composition. Such methods are known in the art, see e.g., International Publication No. WO 99/64446. In some embodiments, compositions comprising radioactive iodine, can be prepared using an exchange reaction. For example, exchange of hot iodine for cold iodine is well known in the art. Alternatively, a radio-iodine labeled compound can be prepared from the corresponding bromo compound via a tributylstannyl intermediate.

Magnetic label moieties include paramagnetic contrasting agents, e.g., gadolinium diethylenetriaminepentaacetic acid, e.g., used with magnetic resonance imaging (MRI) (see, e.g., De Roos, A. et al., Int. J. Card. Imaging Vol. 7 pg. 133 (1991)). Some preferred embodiments use as the detectable agent paramagnetic atoms that are divalent or trivalent ions of elements with an atomic number 21, 22, 23, 24, 25, 26, 27, 28, 29, 42, 44, 58, 59, 60, 61, 62, 63, 64, 65, 66, 67, 68, 69, or 70. Suitable ions include, but are not limited to, chromium(III), manganese(II), iron(II), iron(III), cobalt(II), nickel(II), copper(II), praseodymium(III), neodymium(III), samarium(III) and ytterbium(III), as well as gadolinium(III), terbiurn(III), dysoprosium(III), holmium(III), and erbium(III). Some preferred embodiments use atoms with strong magnetic moments, e.g., gadolinium(III).

In some embodiments, compositions comprising magnetic label moieties can be prepared by coupling the disclosed components, compounds, and compositions with a paramagnetic atom. For example, the metal oxide or a metal salt, such as a nitrate, chloride or sulfate salt, of a suitable paramagnetic atom can be dissolved or suspended in a water/alcohol medium, such as methyl, ethyl, and/or isopropyl alcohol. The mixture can be added to a solution of an equimolar amount of the disclosed components, compounds, and compositions in a similar water/alcohol medium and stirred. The mixture can be heated moderately until the reaction is complete or nearly complete. Insoluble compositions formed can be obtained by filtering, while soluble compositions can be obtained by evaporating the solvent. If acid groups on the chelating moieties remain in the disclosed compositions, inorganic bases (e.g., hydroxides, carbonates and/or bicarbonates of sodium, potassium and/or lithium), organic bases, and/or basic amino acids can be used to neutralize acidic groups, e.g., to facilitate isolation or purification of the composition.

In preferred embodiments, the label moiety can be coupled to a detection agent in such a way so as not to interfere with the ability of the detection agent to interact with the target molecule (i.e. analyte). In some embodiments, the label moiety can be chemically bound to the detection agent. In some embodiments, the label moiety can be chemically bound to another moiety that is itself chemically bound to the detection agent, indirectly linking the detection and the disclosed components, compounds, and compositions.

28. Higher and Inhibit and Like Words

The terms higher, increases, elevates, or elevation or like terms or variants of these terms, refer to increases above basal levels, e.g., as compared to a control. The terms low, lower, reduces, decreases or reduction or like terms or variation of these terms, refer to decreases below basal levels, e.g., as compared to a control. For example, basal levels are normal in vivo levels prior to, or in the absence of, or addition of a molecule such as an agonist or antagonist to a cell. Inhibit or forms of inhibit or like terms refers to reducing or suppressing.

29. Label Moiety

The detection agent in the disclosed compositions can comprise a label moiety. A variety of label moieties are useful in the disclosed methods. As used herein, the term “label moiety” refers to any molecule which can be detected. Useful label moieties include molecules that can be administered in vivo and in vitro and subsequently detected or used in assays. Label moieties useful in the disclosed compositions and methods, articles, and machines include yet are not limited to enzymatic moieties, radioactive moieties, electromagnectic field moieties, chromophore moieties, fluorophores moieties, quantum dot moieties, heavy element moieties, proton emitting moieties, phosphorescent moieties, and fluorescent moieties. The label moiety can be, for example, any composition or molecule that facilitates visualization (i.e. recognition that an event or molecule is present relative to other events or molecules), either directly or indirectly.

In some embodiments, for instance, the label moiety comprises a barium compound, e.g., barium sulfate.

Other examples of label moieties include molecules which emit or can be caused to emit detectable radiation (e.g., fluorescence excitation, radioactive decay, spin resonance excitation, etc.), molecules which affect local electromagnetic fields (e.g., magnetic, ferromagnetic, ferromagnetic, paramagnetic, and/or superparamagnetic species), molecules which absorb or scatter radiation energy (e.g., chromophores and/or fluorophores), quantum dots, heavy elements and/or compounds thereof. See, e.g., label moieties described in U.S. Publication No. 2004/0009122. Other examples of label moieties include a proton-emitting molecules, a radiopaque molecules, and/or a radioactive molecules, such as a radionuclide like Tc-99m and/or Xe-13. Such molecules can be used as a radiopharmaceutical. In still other embodiments, the disclosed compositions can comprise one or more different types of label moieties, including any combination of the label moieties disclosed herein.

30. Library

A library or like terms is a collection. The library can be a collection of anything disclosed herein. For example, it can be a collection of detection agents, a collection of detection targets, a collection of assays, or a collection of labels. Also, it can be a collection of molecules, a molecule library; it can be a collection of cells, a cell library. A library can be for example, random or non-random, determined or undetermined.

31. Ligand

A ligand or like terms is a substance or molecule that is able to bind to and form a complex with another substance or molecule, a ligand target, such as a receptor. Actual irreversible covalent binding between a ligand and its ligand target is rare in biological systems. Ligand binding to ligand targets typically alters the chemical conformation, i.e., the three dimensional shape of the ligand target and often the ligand. The tendency or strength of binding is called affinity.

32. Material

Material is the tangible part of something (chemical, biochemical, biological, or mixed) that goes into the makeup of a physical object.

33. Medium

A medium is any mixture within which cells can be cultured. A growth medium is an object in which microorganisms or cells experience growth.

34. Molecule

As used herein, the terms “molecule” or like terms refers to a biological or biochemical or chemical entity that exists in the form of a chemical molecule or molecule with a definite molecular weight. A molecule or like terms is a chemical, biochemical or biological molecule, regardless of its size.

Many molecules are of the type referred to as organic molecules (molecules containing carbon atoms, among others, connected by covalent bonds), although some molecules do not contain carbon (including simple molecular gases such as molecular oxygen and more complex molecules such as some sulfur-based polymers). The general term “molecule” includes numerous descriptive classes or groups of molecules, such as proteins, nucleic acids, carbohydrates, steroids, organics, pharmaceuticals, organic pharmaceuticals, small molecules, receptors, antibodies, drugs, drug metabolites, and lipids. When appropriate, one or more of these more descriptive terms (many of which, such as “protein,” themselves describe overlapping groups of molecules) will be used herein because of application of the method to a subgroup of molecules, without detracting from the intent to have such molecules be representative of both the general class “molecules” and the named subclass, such as proteins. Unless specifically indicated, the word “molecule” would include the specific molecule and salts thereof, such as pharmaceutically acceptable salts.

35. Kits

The materials described above as well as other materials can be packaged together in any suitable combination as a kit useful for performing, or aiding in the performance of, the disclosed method. It is useful if the kit components in a given kit are designed and adapted for use together in the disclosed method. For example disclosed are kits for measuring analytes in a sample, such as a biological sample containing hundreds or thousands of analytes, the kit comprising the disclosed materials or a combination thereof. The kits can contain, for example, detection agents, solid supports, capture molecules, capture supports, or a combination.

36. Mixtures

Disclosed are mixtures formed by performing or preparing to perform the disclosed method. For example, disclosed are mixtures comprising a protein:antibody hybrid.

Whenever the method involves mixing or bringing into contact compositions or components or reagents, performing the method creates a number of different mixtures. For example, if the method includes 3 mixing steps, after each one of these steps a unique mixture is formed if the steps are performed separately. In addition, a mixture is formed at the completion of all of the steps regardless of how the steps were performed. The present disclosure contemplates these mixtures, obtained by the performance of the disclosed methods as well as mixtures containing any disclosed reagent, composition, or component, for example, disclosed herein.

37. Molecule Mixture

A molecule mixture or like terms is a mixture containing at least two molecules. The two molecules can be, but not limited to, structurally different (i.e., enantiomers), or compositionally different (e.g., protein isoforms, glycoform, or an antibody with different poly(ethylene glycol) (PEG) modifications), or structurally and compositionally different (e.g., unpurified natural extracts, or unpurified synthetic compounds).

38. Nucleic Acid Target Molecules

Variants of the target molecules can also be detected in the present invention. Variants include splice variants or mutants. Splice variants can often have sequences similar or identical to the normal or alternative sequence but with a unique junction of those sequences.

Variant sequences and derivatives can also be defined in terms of sequence similarity, identity, and/or homology to specific known sequences. This identity of particular sequences disclosed herein is also discussed elsewhere herein. In general, variants of DNA, RNA and proteins herein disclosed typically have at least, about 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99 percent homology to the stated sequence or the native sequence. Those of skill in the art readily understand how to determine the homology of two proteins or nucleic acids, such as RNA molecules. For example, the homology can be calculated after aligning the two sequences so that the homology is at its highest level. As used herein, homology of sequences can be considered sequence identity.

Another way of calculating homology can be performed by published algorithms. Optimal alignment of sequences for comparison may be conducted by the local homology algorithm of Smith and Waterman Adv. Appl. Math. 2: 482 (1981), by the homology alignment algorithm of Needleman and Wunsch, J. Mol. Biol. 48: 443 (1970), by the search for similarity method of Pearson and Lipman, Proc. Natl. Acad. Sci. U.S.A. 85: 2444 (1988), by computerized implementations of these algorithms (GAP, BESTFIT, FASTA, and TFASTA in the Wisconsin Genetics Software Package, Genetics Computer Group, 575 Science Dr., Madison, Wis.), or by inspection.

The same types of homology can be obtained for nucleic acids by for example the algorithms disclosed in Zuker, M. Science 244:48-52, 1989, Jaeger et al. Proc. Natl. Acad. Sci. USA 86:7706-7710, 1989, Jaeger et al. Methods Enzymol. 183:281-306, 1989 which are herein incorporated by reference for at least material related to nucleic acid alignment. It is understood that any of the methods typically can be used and that in certain instances the results of these various methods may differ, but the skilled artisan understands if identity is found with at least one of these methods, the sequences would be said to have the stated identity, and be disclosed herein.

For example, as used herein, a sequence recited as having a particular percent homology to another sequence refers to sequences that have the recited homology as calculated by any one or more of the calculation methods described above. For example, a first sequence has 80 percent homology, as defined herein, to a second sequence if the first sequence is calculated to have 80 percent homology to the second sequence using the Zuker calculation method even if the first sequence does not have 80 percent homology to the second sequence as calculated by any of the other calculation methods. As another example, a first sequence has 80 percent homology, as defined herein, to a second sequence if the first sequence is calculated to have 80 percent homology to the second sequence using both the Zuker calculation method and the Pearson and Lipman calculation method even if the first sequence does not have 80 percent homology to the second sequence as calculated by the Smith and Waterman calculation method, the Needleman and Wunsch calculation method, the Jaeger calculation methods, or any of the other calculation methods. As yet another example, a first sequence has 80 percent homology, as defined herein, to a second sequence if the first sequence is calculated to have 80 percent homology to the second sequence using each of calculation methods (although, in practice, the different calculation methods will often result in different calculated homology percentages).

39. Optional

“Optional” or “optionally” or like terms means that the subsequently described event or circumstance can or cannot occur, and that the description includes instances where the event or circumstance occurs and instances where it does not. For example, the phrase “optionally the composition can comprise a combination” means that the composition may comprise a combination of different molecules or may not include a combination such that the description includes both the combination and the absence of the combination (i.e., individual members of the combination).

40. Or

The word “or” or like terms as used herein means any one member of a particular list and also includes any combination of members of that list.

41. pH and pH Adjustment, Buffers and Other Reagents

Many times, when analyzing urinary proteins it is important to adjust the pH. In the present invention the pH adjustment can be done with a buffer solution or a tablet. The buffer solution contains a buffer salt that will bring the pH to the optimum pH for analysis. A pH tablet can be added directly to the device and upon addition of the urine sample the tablet will dissolve with gentle shaking. After the tablet has dissolved, the pH will be at the desired, optimum pH for analysis. The desired pH can be important for the collection of cells and for assays that will be conducted on a solid substrate. Sensitivity, specificity and cell integrity can be improved by eliminating pH as a confounding factor.

Also disclosed in the present invention is a lysis buffer. For example, assays requiring the lysis of cells can use a tablet or solution that contains the necessary detergents for cell lysis.

Furthermore, the invention discloses the presence of enzyme inhibitors such as DNase and RNase inhibitors or protease inhibitors in the different reagents. For example, assays requiring DNA or RNA would likely benefit from the presence of DNase and RNase inhibitors in order to preserve the analyte of interest (i.e. DNA or RNA). The inhibitors can either be a separate tablet or combined in a detergent tablet. Some assays may require intact proteins and thus inhibiting protease activity would be important. Thus, tablets or solutions containing specific enzyme inhibitors are disclosed.

Also disclosed in the present invention are enzymes that break down mucus. For example, samples that contain mucus would likely benefit from the presence of these enzymes in order to break down the mucus and prevent the mucus from either blocking the solid substrate or simply interfering with the detection method.

The disclosed buffers and reagents can be present in a variety of formulations. For example, they can be formulated as a solution, tablet, capsule or powder.

42. Phosphorescent

The term phosphorescent as used herein can be defined as luminescence that is caused by the absorption of radiations (as light or electrons) and continues for a noticeable time after these radiations have stopped.

43. Positive Control

A “positive control” or like terms is a control that shows that the conditions for data collection can lead to data collection.

44. Publications

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon.

45. Ranges

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself.

For example, if the value “10” is disclosed, then “about 10” is also disclosed. It is also understood that when a value is disclosed that “less than or equal to” the value, “greater than or equal to the value” and possible ranges between values are also disclosed, as appropriately understood by the skilled artisan. For example, if the value “10” is disclosed the “less than or equal to 10” as well as “greater than or equal to 10” is also disclosed. It is also understood that the throughout the application, data is provided in a number of different formats, and that this data, represents endpoints and starting points, and ranges for any combination of the data points. For example, if a particular data point “10” and a particular data point 15 are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

46. Receptor

A receptor or like terms is a protein molecule which can be embedded in either the plasma membrane or cytoplasm of a cell, to which a mobile signaling (or “signal”) molecule may attach. A molecule which binds to a receptor is often called a “ligand,” and may be a peptide (such as a neurotransmitter), a hormone, a pharmaceutical drug, or a toxin, and when such binding occurs, the receptor goes into a conformational change which ordinarily initiates a cellular response. However, some ligands merely block receptors without inducing any response (e.g. antagonists). Ligand-induced changes in receptors result in physiological changes which constitute the biological activity of the ligands. It is understood that receptors can often be used in vitro, out of the context of a cell for binding assays, for example.

47. Response

A response or like terms is any reaction to any stimulation.

48. Sample

By sample or like terms is meant an animal, a plant, a fungus, etc.; a natural product, a natural product extract, etc.; a tissue or organ from an animal; a cell (either within a subject, taken directly from a subject, or a cell maintained in culture or from a cultured cell line); a cell lysate (or lysate fraction) or cell extract; or a solution containing one or more molecules derived from a cell or cellular material (e.g. a polypeptide or nucleic acid), which is assayed as described herein. A sample may also be a liquid sample, such as a body fluid or excretion (for example, but not limited to, blood, urine, stool, saliva, tears, bile) that contains cells or cell components. Samples to be used in the disclosed methods can be from any source, particularly physiological fluids or body fluids. Examples of bodily fluids and excretions include but are not limited to urine, stool, blood—whole serum or plasma—, spinal fluid, cerebrospinal fluid, ocular lens liquid, semen, synovial fluid, peritoneal fluid, pleural fluid, sputum, lymph fluid, saliva, amniotic fluid, pus, lavage fluid, sweat, bile, tears, exosomes, nanoparticles, nanotubes, vomit, cerumen (earwax), gastric juice, pancreatic juice, breast milk, mucus, sebum (skin oil), vaginal secretion, aqueous humour, pericardial fluid, lymph, chyme, prostatic fluid.

Useful samples are those suspected or expected to contain one or more target molecules. Samples can be, for example, body fluid or extract from a patient or other animal suspected of being infected or suffering from a disease condition, or an environmental sample (for example, sewer water, lake water) suspected of harboring a particular organism.

Useful types of samples, or sources of samples, that are suitable for use in the disclosed methods are those samples already known or identified as samples suitable for use in other methods of detection and/or quantitation. Many such samples are known. For example, the sample may be from a human or veterinary clinical specimen. The sample can contain bacteria, yeast, and/or viruses. Methods for the detection of target molecules are known and can be used with the disclosed methods.

The samples can comprise molecules derived from biological materials. The biological material can comprise cells, tissues, biological fluids, extracellular solutions, extracellular matrices or a combination. In the case of biological fluids, extracellular solutions, extracellular matrices, and the like, molecules (i.e. proteins) can have been released into the biological fluids, extracellular solutions, extracellular matrices, and the like. In addition to proteins, the sample can contain other analytes such as DNA, RNA, metabolites, etc. For example, samples can be derived from body fluids and the like from any source or any organism. The disclosed sample can comprise protein, DNA, RNA, or a combination.

The sample can be diluted with a suitable reagent before analyzing the sample for specific analytes.

49. Substance

A substance or like terms is any physical object. A material is a substance. Molecules, ligands, cells, proteins, drugs, hormones, drug metabolites, tumor marker, and DNA can be considered substances. A machine or an article would be considered to be made of substances, rather than considered a substance themselves.

50. Stable

When used with respect to pharmaceutical compositions, the term “stable” or like terms is generally understood in the art as meaning less than a certain amount, usually 10%, loss of the active ingredient under specified storage conditions for a stated period of time. The time required for a composition to be considered stable is relative to the use of each product and is dictated by the commercial practicalities of producing the product, holding it for quality control and inspection, shipping it to a wholesaler or direct to a customer where it is held again in storage before its eventual use. Including a safety factor of a few months time, the minimum product life for pharmaceuticals is usually one year, and preferably more than 18 months. As used herein, the term “stable” references these market realities and the ability to store and transport the product at readily attainable environmental conditions such as refrigerated conditions, 2° C. to 8° C.

51. Subject

As used throughout, by a subject or like terms is meant an individual. Thus, the “subject” can include, for example, domesticated animals, such as cats, dogs, etc., livestock (e.g., cattle, horses, pigs, sheep, goats, etc.), laboratory animals (e.g., mouse, rabbit, rat, guinea pig, etc.) and mammals, non-human mammals, primates, non-human primates, rodents, birds, reptiles, amphibians, fish, and any other animal. In one aspect, the subject is a mammal such as a primate or a human. The subject can be a non-human.

52. Systems

Disclosed are systems useful for performing, or aiding in the performance of, the disclosed method. Systems generally comprise combinations of articles of manufacture such as structures, machines, devices, and the like, and compositions, compounds, materials, and the like. Such combinations that are disclosed or that are apparent from the disclosure are contemplated. For example, disclosed and contemplated are systems comprising target DNA probes and NextGen sequencing apparatus.

53. Treating

Treating or treatment or like terms can be used in at least two ways. First, treating or treatment or like terms can refer to administration or action taken towards a subject, manipulating a subject. Second, treating or treatment or like terms can refer to mixing any two things together, such as any two or more substances together, such as a molecule and a cell. This mixing will bring the at least two substances together such that a contact between them can take place. For instance, “treating cells to reach high confluency”, means to take care or manipulate cells so they reach high confluency.

When treating or treatment or like terms is used in the context of a subject with a disease, it does not imply a cure or even a reduction of a symptom for example. When the term therapeutic or like terms is used in conjunction with treating or treatment or like terms, it means that the symptoms of the underlying disease are reduced, and/or that one or more of the underlying cellular, physiological, or biochemical causes or mechanisms causing the symptoms are reduced. It is understood that reduced, as used in this context, means relative to the state of the disease, including the molecular state of the disease, not just the physiological state of the disease.

54. Values

Specific and preferred values disclosed for components, ingredients, additives, cell types, markers, and like aspects, and ranges thereof, are for illustration only; they do not exclude other defined values or other values within defined ranges. The compositions, apparatus, and methods of the disclosure include those having any value or any combination of the values, specific values, more specific values, and preferred values described herein.

Thus, the disclosed methods, compositions, articles, and machines, can be combined in a manner to comprise, consist of, or consist essentially of, the various components, steps, molecules, and composition, and the like, discussed herein. They can be used, for example, in methods for characterizing a molecule including a ligand as defined herein; a method of producing an index as defined herein; or a method of drug discovery as defined herein.

55. Nucleic Acids

There are a variety of molecules disclosed herein that are nucleic acid based, including, for example, detection agents. The disclosed nucleic acids can be made up of for example, nucleotides, nucleotide analogs, or nucleotide substitutes. Non-limiting examples of these and other molecules are discussed herein. It is understood that for example, when a vector is expressed in a cell that the expressed mRNA will typically be made up of A, C, G, and U. Likewise, it is understood that if a nucleic acid molecule is introduced into a cell or cell environment through for example exogenous delivery, it is advantageous that the nucleic acid molecule be made up of nucleotide analogs that reduce the degradation of the nucleic acid molecule in the cellular environment.

So long as their relevant function is maintained, detection agents and any other oligonucleotides and nucleic acids can be made up of or include modified nucleotides (nucleotide analogs). Many modified nucleotides are known and can be used in oligonucleotides and nucleic acids. A nucleotide analog is a nucleotide which contains some type of modification to either the base, sugar, or phosphate moieties. Modifications to the base moiety would include natural and synthetic modifications of A, C, G, and T/U as well as different purine or pyrimidine bases, such as uracil-5-yl, hypoxanthin-9-yl (I), and 2-aminoadenin-9-yl. A modified base includes but is not limited to 5-methylcytosine (5-me-C), 5-hydroxymethyl cytosine, xanthine, hypoxanthine, 2-aminoadenine, 6-methyl and other alkyl derivatives of adenine and guanine, 2-propyl and other alkyl derivatives of adenine and guanine, 2-thiouracil, 2-thiothymine and 2-thiocytosine, 5-halouracil and cytosine, 5-propynyl uracil and cytosine, 6-azo uracil, cytosine and thymine, 5-uracil (pseudouracil), 4-thiouracil, 8-halo, 8-amino, 8-thiol, 8-thioalkyl, 8-hydroxyl and other 8-substituted adenines and guanines, 5-halo particularly 5-bromo, 5-trifluoromethyl and other 5-substituted uracils and cytosines, 7-methylguanine and 7-methyladenine, 8-azaguanine and 8-azaadenine, 7-deazaguanine and 7-deazaadenine and 3-deazaguanine and 3-deazaadenine. Another modified base contains one or more of the 2′-O,4′-C-methylene-β-D-ribofuranosyl nucleosides which are known as locked nucleic acid (LNA™) monomers (Petersen and Wengel, Trends Biotech 21:74-81, 2003). Additional base modifications can be found for example in U.S. Pat. No. 3,687,808, Englisch et al., Angewandte Chemie, International Edition, 1991, 30, 613, and Sanghvi, Y. S., Chapter 15, Antisense Research and Applications, pages 289-302, Crooke, S. T. and Lebleu, B. ed., CRC Press, 1993. Certain nucleotide analogs, such as 5-substituted pyrimidines, 6-azapyrimidines and N-2, N-6 and O-6 substituted purines, including 2-aminopropyladenine, 5-propynyluracil and 5-propynylcytosine. 5-methylcytosine can increase the stability of duplex formation. Other modified bases are those that function as universal bases. Universal bases include 3-nitropyrrole and 5-nitroindole. Universal bases substitute for the normal bases but have no bias in base pairing. That is, universal bases can base pair with any other base. Base modifications often can be combined with for example a sugar modification, such as 2′-O-methoxyethyl, to achieve unique properties such as increased duplex stability. There are numerous United States patents such as U.S. Pat. Nos. 4,845,205; 5,130,302; 5,134,066; 5,175,273; 5,367,066; 5,432,272; 5,457,187; 5,459,255; 5,484,908; 5,502,177; 5,525,711; 5,552,540; 5,587,469; 5,594,121, 5,596,091; 5,614,617; and 5,681,941, which detail and describe a range of base modifications. Each of these patents is herein incorporated by reference in its entirety, and specifically for their description of base modifications, their synthesis, their use, and their incorporation into oligonucleotides and nucleic acids.

LNA™ monomers are a class of nucleic acid analogues in which the ribose ring is “locked” into the ideal conformation for base stacking and backbone pre-organization and can be used just like a regular nucleotide. The nucleic acid contains a methylene bridge connecting the 2′-O and the 4′-C. The “locked” structure increases the stability of oligonucleotides by means of increasing the melting temperature (Kaur et al. Biochemistry 45:7347-55, 2006). LNA™ can be used for a variety of molecular biology techniques. Locked nucleic acids can be used for but are not limited to microarrays, FISH probes, real-time PCR probes, small RNA research, SNP genotyping, mRNA antisense oligonucleotides, allele-specific PCR, RNAi, DNAzymes, fluorescence polarization probes, gene repair/exon skipping, splice variant detection and comparative genome hybridization.

Nucleotide analogs can also include modifications of the sugar moiety. Modifications to the sugar moiety would include natural modifications of the ribose and deoxyribose as well as synthetic modifications. Sugar modifications include but are not limited to the following modifications at the 2′ position: OH; F; O-, S-, or N-alkyl; O-, S-, or N-alkenyl; O-, S- or N-alkynyl; or O-alkyl-O-alkyl, wherein the alkyl, alkenyl and alkynyl can be substituted or unsubstituted C1 to C10, alkyl or C2 to C10 alkenyl and alkynyl. 2′ sugar modifications also include but are not limited to —O[(CH₂)nO]mCH₃, —O(CH₂)nOCH₃, —O(CH₂)nNH₂, —O(CH₂)nCH₃, —O(CH₂)n-ONH₂, and —O(CH₂)nON[(CH₂)nCH₃)]₂, where n and m are from 1 to about 10.

Other modifications at the 2′ position include but are not limited to: C1 to C10 lower alkyl, substituted lower alkyl, alkaryl, aralkyl, O-alkaryl or O-aralkyl, SH, SCH₃, OCN, Cl, Br, CN, CF₃, OCF₃, SOCH₃, SO₂, CH₃, ONO₂, NO₂, N₃, NH₂, heterocycloalkyl, heterocycloalkaryl, aminoalkylamino, polyalkylamino, substituted silyl, an RNA cleaving group, a reporter group, an intercalator, a group for improving the pharmacokinetic properties of an oligonucleotide, or a group for improving the pharmacodynamic properties of an oligonucleotide, and other substituents having similar properties. Similar modifications can also be made at other positions on the sugar, particularly the 3′ position of the sugar on the 3′ terminal nucleotide or in 2′-5′ linked oligonucleotides and the 5′ position of 5′ terminal nucleotide. Modified sugars would also include those that contain modifications at the bridging ring oxygen, such as CH₂ and S, Nucleotide sugar analogs can also have sugar mimetics such as cyclobutyl moieties in place of the pentofuranosyl sugar. There are numerous United States patents that teach the preparation of such modified sugar structures such as U.S. Pat. Nos. 4,981,957; 5,118,800; 5,319,080; 5,359,044; 5,393,878; 5,446,137; 5,466,786; 5,514,785; 5,519,134; 5,567,811; 5,576,427; 5,591,722; 5,597,909; 5,610,300; 5,627,053; 5,639,873; 5,646,265; 5,658,873; 5,670,633; and 5,700,920, each of which is herein incorporated by reference in its entirety, and specifically for their description of modified sugar structures, their synthesis, their use, and their incorporation into nucleotides, oligonucleotides and nucleic acids.

Nucleotide analogs can also be modified at the phosphate moiety. Modified phosphate moieties include but are not limited to those that can be modified so that the linkage between two nucleotides contains a phosphorothioate, chiral phosphorothioate, phosphorodithioate, phosphotriester, aminoalkylphosphotriester, methyl and other alkyl phosphonates including 3′-alkylene phosphonate and chiral phosphonates, phosphinates, phosphoramidates including 3′-amino phosphoramidate and aminoalkylphosphoramidates, thionophosphoramidates, thionoalkylphosphonates, thionoalkylphosphotriesters, and boranophosphates. It is understood that these phosphate or modified phosphate linkages between two nucleotides can be through a 3′-5′ linkage or a 2′-5′ linkage, and the linkage can contain inverted polarity such as 3′-5′ to 5′-3′ or 2′-5′ to 5′-2′. Various salts, mixed salts and free acid forms are also included. Numerous United States patents describe how to make and use nucleotides containing modified phosphates and include but are not limited to, U.S. Pat. Nos. 3,687,808; 4,469,863; 4,476,301; 5,023,243; 5,177,196; 5,188,897; 5,264,423; 5,276,019; 5,278,302; 5,286,717; 5,321,131; 5,399,676; 5,405,939; 5,453,496; 5,455,233; 5,466,677; 5,476,925; 5,519,126; 5,536,821; 5,541,306; 5,550,111; 5,563,253; 5,571,799; 5,587,361; and 5,625,050, each of which is herein incorporated by reference its entirety, and specifically for their description of modified phosphates, their synthesis, their use, and their incorporation into nucleotides, oligonucleotides and nucleic acids.

It is understood that nucleotide analogs need only contain a single modification, but can also contain multiple modifications within one of the moieties or between different moieties.

Nucleotide substitutes are molecules having similar functional properties to nucleotides, but which do not contain a phosphate moiety, such as peptide nucleic acid (PNA). Nucleotide substitutes are molecules that will recognize and hybridize to (base pair to) complementary nucleic acids in a Watson-Crick or Hoogsteen manner, but which are linked together through a moiety other than a phosphate moiety. Nucleotide substitutes are able to conform to a double helix type structure when interacting with the appropriate target nucleic acid.

Nucleotide substitutes can also include nucleotides or nucleotide analogs that have had the phosphate moiety and/or sugar moieties replaced. Nucleotide substitutes do not contain a standard phosphorus atom. Substitutes for the phosphate can be for example, short chain alkyl or cycloalkyl internucleoside linkages, mixed heteroatom and alkyl or cycloalkyl internucleoside linkages, or one or more short chain heteroatomic or heterocyclic internucleoside linkages. These include those having morpholino linkages (formed in part from the sugar portion of a nucleoside); siloxane backbones; sulfide, sulfoxide and sulfone backbones; formacetyl and thioformacetyl backbones; methylene formacetyl and thioformacetyl backbones; alkene containing backbones; sulfamate backbones; methyleneimino and methylenehydrazino backbones; sulfonate and sulfonamide backbones; amide backbones; and others having mixed N, O, S and CH₂ component parts. Numerous United States patents disclose how to make and use these types of phosphate replacements and include but are not limited to U.S. Pat. Nos. 5,034,506; 5,166,315; 5,185,444; 5,214,134; 5,216,141; 5,235,033; 5,264,562; 5,264,564; 5,405,938; 5,434,257; 5,466,677; 5,470,967; 5,489,677; 5,541,307; 5,561,225; 5,596,086; 5,602,240; 5,610,289; 5,602,240; 5,608,046; 5,610,289; 5,618,704; 5,623,070; 5,663,312; 5,633,360; 5,677,437; and 5,677,439, each of which is herein incorporated by reference its entirety, and specifically for their description of phosphate replacements, their synthesis, their use, and their incorporation into nucleotides, oligonucleotides and nucleic acids.

It is also understood in a nucleotide substitute that both the sugar and the phosphate moieties of the nucleotide can be replaced, by for example an amide type linkage (aminoethylglycine) (PNA). U.S. Pat. Nos. 5,539,082; 5,714,331; and 5,719,262 teach how to make and use PNA molecules, each of which is herein incorporated by reference. (See also Nielsen et al., Science 254:1497-1500 (1991)).

It is also possible to link other types of molecules (conjugates) to nucleotides or nucleotide analogs to enhance for example, cellular uptake. Conjugates can be chemically linked to the nucleotide or nucleotide analogs. Such conjugates include but are not limited to lipid moieties such as a cholesterol moiety. (Letsinger et al., Proc. Natl. Acad. Sci. USA, 1989, 86, 6553-6556). There are many varieties of these types of molecules available in the art and available herein.

A Watson-Crick interaction is at least one interaction with the Watson-Crick face of a nucleotide, nucleotide analog, or nucleotide substitute. The Watson-Crick face of a nucleotide, nucleotide analog, or nucleotide substitute includes the C2, N1, and C6 positions of a purine based nucleotide, nucleotide analog, or nucleotide substitute and the C2, N3, C4 positions of a pyrimidine based nucleotide, nucleotide analog, or nucleotide substitute. Such interactions are the basis of hybridization of nucleic acid strands and molecules. The base pairing of certain nucleotide bases in this way defines nucleic acid sequences, strands, and molecules that are complementary to each other. Complementary bases are the basis for complementary (and thus, hybridizable) nucleic acid sequences, strands, and molecules. For example, complementary sequences have complementary nucleotide bases.

A Hoogsteen interaction is the interaction that takes place on the Hoogsteen face of a nucleotide or nucleotide analog, which is exposed in the major groove of duplex DNA. The Hoogsteen face includes the N7 position and reactive groups (NH2 or O) at the C6 position of purine nucleotides.

Oligonucleotides and nucleic acids can be comprised of nucleotides and can be made up of different types of nucleotides or the same type of nucleotides. For example, one or more of the nucleotides in an oligonucleotide can be ribonucleotides, 2′-O-methyl ribonucleotides, or a mixture of ribonucleotides and 2′-O-methyl ribonucleotides; about 10% to about 50% of the nucleotides can be ribonucleotides, 2′-O-methyl ribonucleotides, or a mixture of ribonucleotides and 2′-O-methyl ribonucleotides; about 50% or more of the nucleotides can be ribonucleotides, 2′-O-methyl ribonucleotides, or a mixture of ribonucleotides and 2′-O-methyl ribonucleotides; or all of the nucleotides are ribonucleotides, 2′-O-methyl ribonucleotides, or a mixture of ribonucleotides and 2′-O-methyl ribonucleotides. Such oligonucleotides and nucleic acids can be referred to as chimeric oligonucleotides and chimeric nucleic acids.

i. Primers and Probes

Disclosed are compositions including primers and probes, which are capable of interacting with the disclosed nucleic acids such as target RNA molecules and target DNA probes. In certain embodiments the primers are used to support DNA amplification reactions. Typically the primers will be capable of being extended in a sequence specific manner. Extension of a primer in a sequence specific manner includes any methods wherein the sequence and/or composition of the nucleic acid molecule to which the primer is hybridized or otherwise associated directs or influences the composition or sequence of the product produced by the extension of the primer. Extension of the primer in a sequence specific manner therefore includes, but is not limited to, PCR, DNA sequencing, DNA extension, DNA polymerization, RNA transcription, or reverse transcription. Techniques and conditions that amplify the primer in a sequence specific manner are preferred. In certain embodiments the primers are used for the DNA amplification reactions, such as PCR or direct sequencing. It is understood that in certain embodiments the primers can also be extended using non-enzymatic techniques, where for example, the nucleotides or oligonucleotides used to extend the primer are modified such that they will chemically react to extend the primer in a sequence specific manner. Typically the disclosed primers hybridize with the disclosed nucleic acids or region of the nucleic acids or they hybridize with the complement of the nucleic acids or complement of a region of the nucleic acids.

The size of the primers or probes for interaction with the nucleic acids in certain embodiments can be any size that supports the desired enzymatic manipulation of the primer, such as DNA amplification or the simple hybridization of the probe or primer. A typical primer or probe would be at least 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 125, 150, 175, 200, 225, 250, 275, 300, 325, 350, 375, 400, 425, 450, 475, 500, 550, 600, 650, 700, 750, 800, 850, 900, 950, 1000, 1250, 1500, 1750, 2000, 2250, 2500, 2750, 3000, 3500, or 4000 nucleotides long.

In other embodiments a primer or probe can be less than or equal to 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 125, 150, 175, 200, 225, 250, 275, 300, 325, 350, 375, 400, 425, 450, 475, 500, 550, 600, 650, 700, 750, 800, 850, 900, 950, 1000, 1250, 1500, 1750, 2000, 2250, 2500, 2750, 3000, 3500, or 4000 nucleotides long.

The primers for the disclosed target DNA probes typically can be used to produce an amplified DNA product that contains a region of the target DNA probe or the complete target DNA probe. For example, the primer can correspond to a signature sequence, a detection sequence, or both. As used herein, a primer corresponds to a nucleic acid molecule or sequence if it contains a sequence that is complementary to, or complementary to a complement of, a sequence in the nucleic acid molecule or sequence such that the primer can function as a primer of the sequence (or its complement) in the nucleic acid molecule or sequence under the conditions used. In general, typically the size of the product can be such that the size can be accurately determined to within 3, or 2 or 1 nucleotides.

In certain embodiments this product is at least 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 125, 150, 175, 200, 225, 250, 275, 300, 325, 350, 375, 400, 425, 450, 475, 500, 550, 600, 650, 700, 750, 800, 850, 900, 950, 1000, 1250, 1500, 1750, 2000, 2250, 2500, 2750, 3000, 3500, or 4000 nucleotides long.

In other embodiments the product is less than or equal to 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 125, 150, 175, 200, 225, 250, 275, 300, 325, 350, 375, 400, 425, 450, 475, 500, 550, 600, 650, 700, 750, 800, 850, 900, 950, 1000, 1250, 1500, 1750, 2000, 2250, 2500, 2750, 3000, 3500, or 4000 nucleotides long.

### Uses

The disclosed methods and compositions are applicable to numerous areas including, but not limited to, analyte detection, quantitation, and/or measurement. Other uses are disclosed, apparent from the disclosure, and/or will be understood by those in the art.

### EXAMPLES

### A. Example 1

### Vacuum Filtration Device Mock Experiment

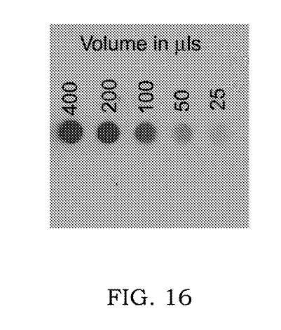

A urine sample obtained from a bladder cancer patient pre-screened for the presence thromboxane receptor β isoform (TBβ) and the screening results were positive was used. Increasing volumes of the urine were filtered through a nitrocellulose membrane using a dot-blot device. Membranes were removed and washed twice with PBS, blocked with 5% milk in TBST and probed with TBβ antibodies (#3061) at a dilution of 1:1000. Conventional western blot analysis was performed for the detection method. The signal was detected using chemiluminescence reagents and exposure to X-ray film. Results are shown in FIG. 16.

### B. Example 2

### Comparison of Disclosed Device to Common Home Pregnancy Test

1. Introduction

The disclosed device can increase the sensitivity of point of care urine tests. The disclosed device is compared to the common pregnancy test. The pregnancy test is a protein based test in which the presence of the hormone human chorionic gonadotrophin (HCG) is detected. HCG is detectable in the urine of pregnant women after there is implantation of the fertilized egg. It can take a minimum of 5 days for the common pregnancy test to be positive in women who are pregnant. However, the sensitivity of the test can be improved by measuring the beta chain of HCG which can be detected in urine as early at 1 to 3 day after successful conception.

2. Methods:

i. Materials

a. Reagents

Nitrocellulose membrane, cut to size for blotting unit; Filter paper, cut to size for blotting unit (i.e. Whatman™ 3MM filter paper); Ultrapure water; PBS Buffer; Blotting unit, dot blot format; TBST; Antibodies.

Examples of antibodies used are: Thermal Scientific's Mab MA1-35020 which recognizes β chain of HCG (Used for ELISA); HCG antibody from HyTest Ltd: http://www.hytest.fi/product/hcg-antibody; MAbs: G9, 28A4, G2, 27E8, 77F12 and new MAb: F1; and Southern Biotech Goat Anti-mouse IgG(gamma chain specific) conjugated with HRP, BGal or Biotin.

The specificity of these antibodies can vary. mAbs 28A4, G2 and 27E8 specifically recognize beta-subunit of HCG. They are not cross-reacting with hLH, hTSH, hFSH. mAbs G9 and 77F12 specifically recognize HCG and they react mainly with alpha-subunit. These mAbs are cross-reacting with whole molecule of HCG, hLH, hTSH and hFSH. Cross-reactivity with free beta-subunit of HCG was not detected. MAb F1 is specific for the alpha-chain of FSH, LH, TSH and HCG.

ii. Experimental Design

a. Phase 1

A series of dilutions of HCG are made in saline along with a zero concentration. The lowest concentration is one that is at the limits of detection for the common home pregnancy test. This is further diluted serially two fold at a time to determine the fold improvement in sensitivity. Each solution is tested with the over the counter pregnancy test. The same solution is tested as described below. Concentration-response curves are generated with the minimum detectable amount for each test being established. Each concentration is tested on 3 separate occasions with the mean and standard error for each concentration to be calculated.

b. Phase 2

The second phase of this study is to spike urine samples obtained initially from men and then subsequently from women who are not pregnant with known amounts of HCG and test them with the common home pregnancy test and the methods described below. The male urine serves to determine the potential for false positive results. The concentration of HCG to be used is determined in phase 1.

iii. Emulating Disclosed Device

a. Method of Detection:

The dot blot procedure described herein can emulate the disclosed device. The dot blot procedure is used with nitrocellulose as the filter support. Nitrocellulose is used since it can trap the HCG. Multiple volumes of the sample can be filtered (range 100 μL-1 mL). The detection utilizes an antibody specific for the beta chain of HCG(1) followed by detection with a biotin or alkaline phosphatase labeled goat anti-mouse IgG antibody(2).

b. Set Up and Assembly of the Blotting Unit:

Manufacturer's instructions can be used for detailed assembly instructions. Briefly, the steps are as follows: 1) Prepare Nitrocellulose membrane by carefully placing the membrane in ultrapure water and soak for 2 minutes. Then soak in PBS for additional 5 minutes. 2) Place one sheet of moistened thick filter paper on the unit. (Note: Some units may require more than one sheet.) Wet the filter paper in contact with the Nitrocellulose membrane with the same buffer used to equilibrate the membrane. 3) Place the membrane on top of the filter paper. 4) Close the unit. 5) Connect to vacuum line. Do not apply the vacuum. With the vacuum off, carefully pipette (100 uls-1 ml) of samples in PBS (Phase 1) or urine (Phase 2) into the wells. 6) Apply vacuum to the blotting unit. 7) When all of the samples have filtered through the membrane, turn off the vacuum. 8) Disassemble the dot-blot apparatus and move the membrane to a tray filled with PBS, wash twice with PBS. (note: for samples with endogenous peroxidases, wash once with H2O2 3% for 3 minutes at RT followed by washing twice with PBS.) 9) Block in 5% milk in TBST (TBS with 0.05% tween 20) at RT for 1 hr. 10) After blocking incubate with the Primary antibodies (1:400 dilution in 5% milk) for 1 hour at RT. 11) Following the incubation with the primary antibodies wash 5 times (5 minutes each with TBST) then add the biotinylated secondary antibodies (1:500). Note the Secondary antibodies (Goat anti-mouse is pre-absorbed against human). 12) Wash again as stated in step 11. 13) After washing, add the chemillumenscent substrate (Super Signal Western Pico-Pierce) for 5 min at RT. 14) Expose to X-ray film.

iv. Disclosed Device

a. Method of Detection:

Use the disclosed collection device comprising a nitrocellulose filter. Nitrocellulose is used since it can trap the HCG. Approximately 10 ml of urine are filtered. The detection utilizes an antibody specific for the beta chain of HCG (primary antibody) followed by detection with a biotin or alkaline phosphatase labeled goat anti-mouse IgG antibody (secondary antibody).

b. Procedure

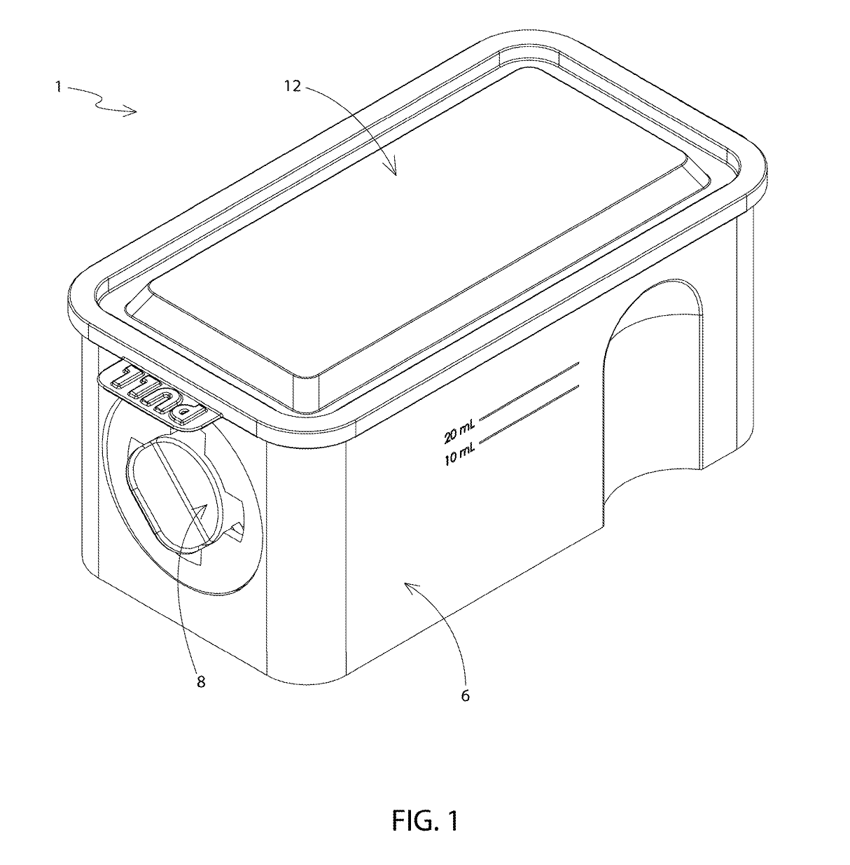

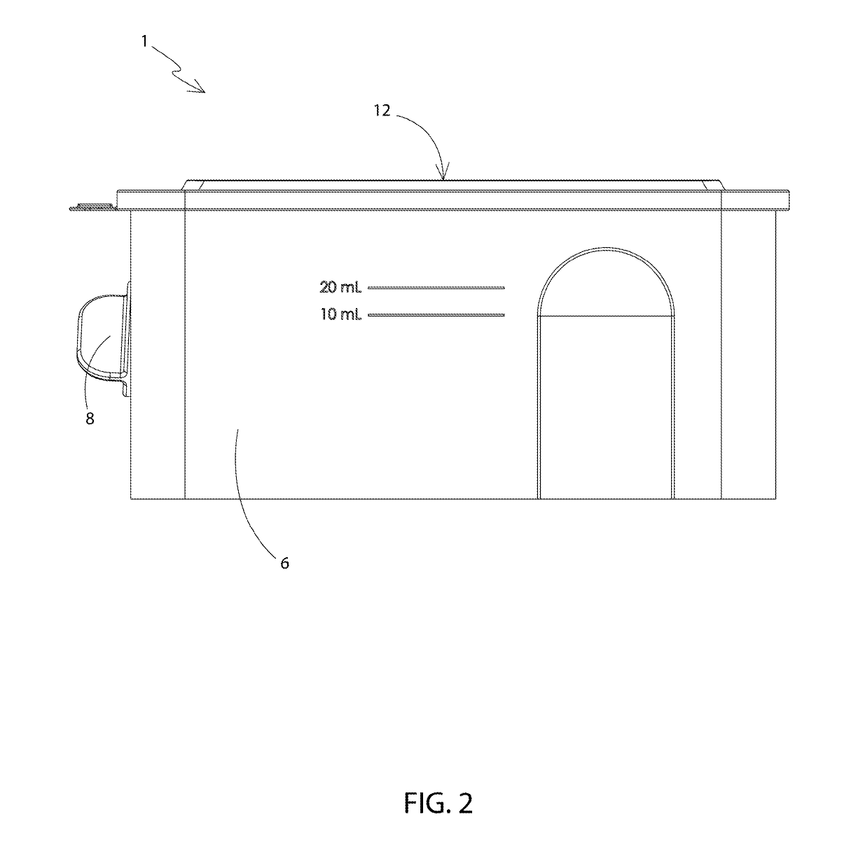

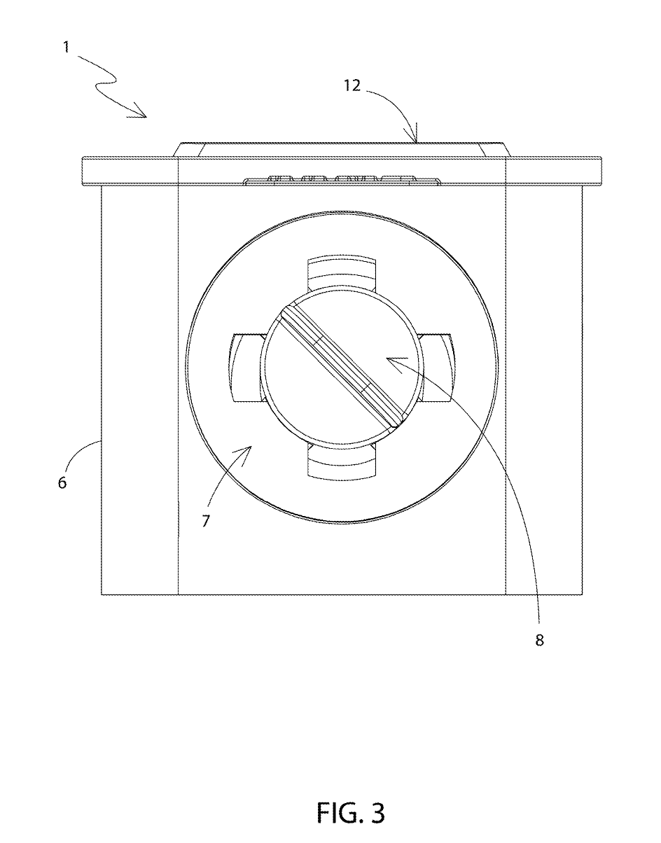

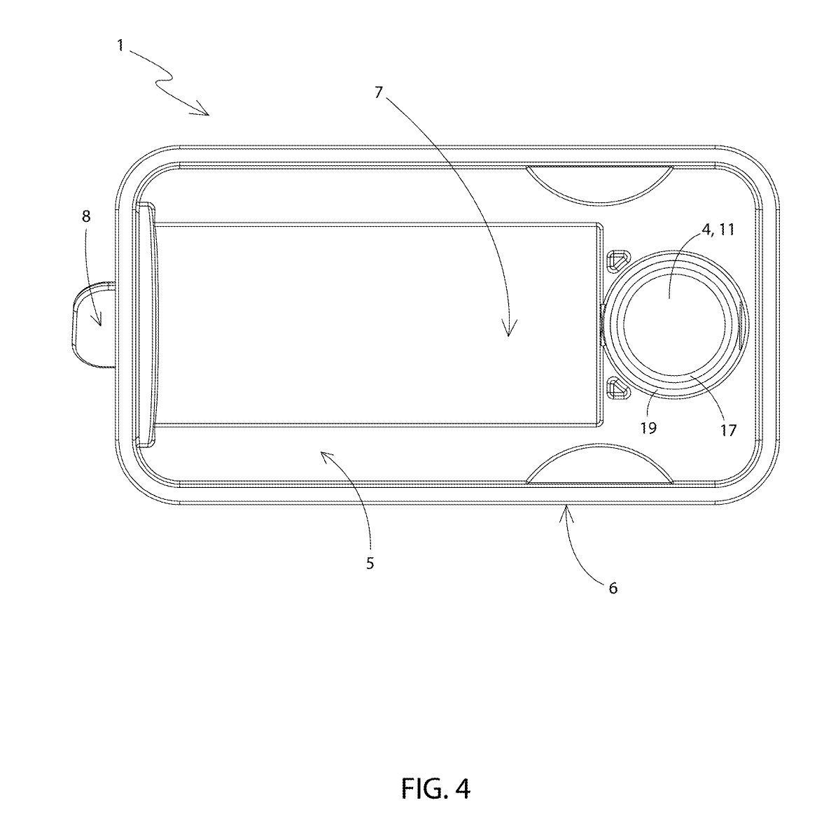

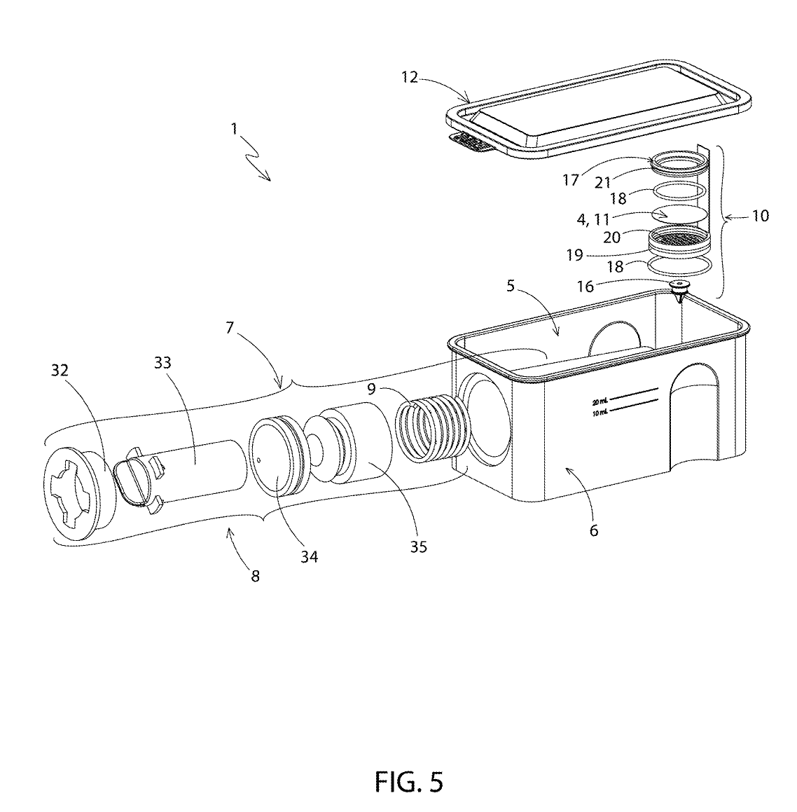

Use the disclosed device as shown in FIG. 1. Urinate in a sterile cup and then remove the lid from the device and deposit the urine into the first chamber (5) of the analyzer. Mix with appropriate stabilizing agents positioned in the fourth chamber in the first chamber (25). The pH of the urine can be adjusted by mixing with a solution or dry chemical present in the device. Specific stabilizers can be added as a function of desired analyte detection and/or post filtration analyses. For example, DNase inhibitors can be added to stabilize DNA; RNase inhibitors can be added to stabilize RNA, etc.

The spring activated piston device is released to generate the vacuum required to move the sample from the first chamber (5) of the device through the collection assembly (which contains the solid supports/filters) into the second chamber (6). The collection assembly can comprise a slot blot adapter causing the urine analytes (i.e. any HCG that is present) to accumulate in distinct areas on the membrane. Flow through (14) will be retained and the collection assembly removed for processing (detection/analysis). Sample flow through (any unbound analytes) drains into the second chamber of the analyzer.

Remove the collection assembly, comprising the membrane (e.g., 0.2 μm pore size Nitrocellulose), and place the nitrocellulose in a tray filled with PBS to remove any non-specific binding. Wash twice with PBS. For samples with endogenous peroxidases, wash once with H₂O₂ 3% for 3 minutes at RT followed by washing twice with PBS. Block in 5% milk in TBST (TBS with 0.05% tween 20) at RT for 1 hr. After blocking incubate with the Primary antibodies (1:400 dilution of a mouse monoclonal antibody in 5% milk) for 1 hour at RT. Following the incubation with the primary antibodies wash 5 times (5 minutes each with TBST) then add the biotinylated secondary antibodies (1:500). Note the Secondary antibodies (Goat anti-mouse) are pre-absorbed against human. Wash again as stated above. Next add Streptavidin-Horseradish Peroxidase for 2 hours at RT. Wash again two times with PBS. After washing, add the final substrate solution (a precipitating substrate such as AEC) for 5 min to 30 min at RT. Spots will appear on the membrane wherever HCG was present. Alternatively, enzyme activity can be measured with an enhanced chemiluminescent system. In another embodiment, antibody conjugated with alkaline phosphatase will be used and colorimetricdetectionis performed with substrate solution containing, 4-nitro-blue tetrazolium chloride (NBT) and 5-bromo-4-chloro-3-indolyl phosphate (BCIP).

3. Results

The concentration of even the dilute samples will show increased sensitivity over the current home pregnancy test. The emulation of the device as well as the actual device will show more sensitivity than the current home pregnancy test.

### C. Example 3

### Concentration and Detection of HCG

Fresh dilutions of HCG were prepared in saline. A commercial EPT pregnancy test was evaluated for sensitivity at 50 mU/ml dilution and at a 20 mU/ml dilution. A positive signal was detected at 50 mU/ml and a weakly positive signal was detected at 20 mU/ml.

An analyzer device as described herein was loaded with circular nitrocellulose filters and a clear plastic mask was compressed on top of it with an approximate 3 to 4 mm circular opening in the middle. The clear plastic mask limited exposure of the filter to fluid flow and was therefore used as a concentrator. The 3 to 4 mm opening acted as a conduit to concentrate HCG on specific reduced surface area of the nitrocellulose filters.

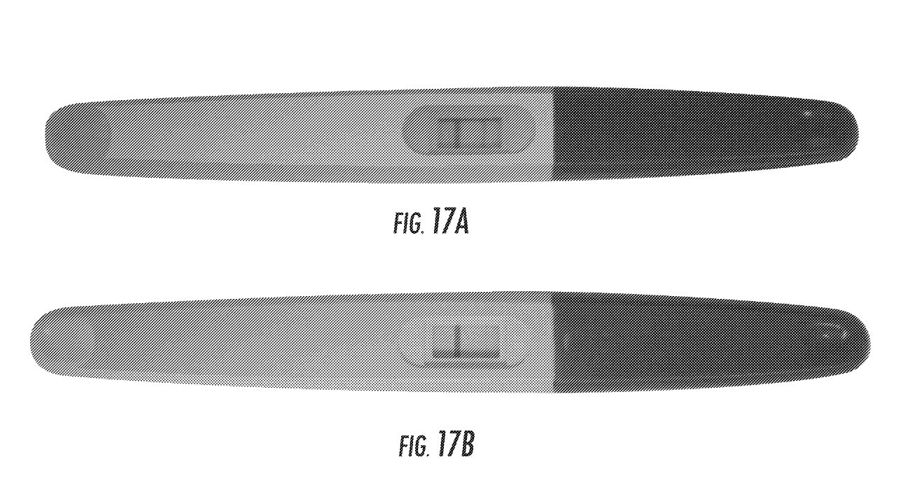

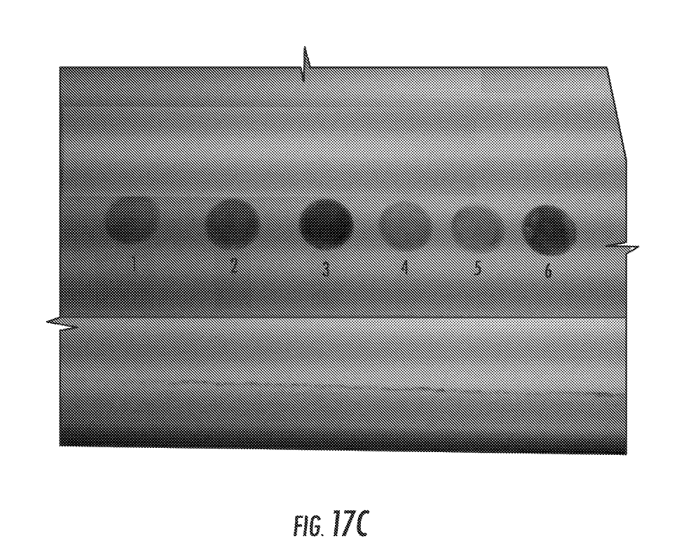

Dilutions of the HCG were filtered through the conduit and through the filter. Each sample was filtered on a single piece of nitrocellulose filter. Filters were removed from the collection assembly and blocked for 1 hour with 3% BSA in TBST. The filters were then incubated overnight with rabbit polyclonal antibody to HCG. This was followed by washing 5 times with TBST then the filters were re-incubated with the secondary detection antibody (goat-anti rabbit-HRP conjugated) for 45 min followed by washing 5 times with TBST. The filters were incubated for 5 minutes with chemilumenscent reagent and exposed to X-ray film for 5 seconds. The results are shown in FIGS. 17A-C.

FIG. 17A shows the detection of HCG by the commercial EPT pregnancy test with a dilution of 50 mU/ml. FIG. 17B shows a weakly positive signal with a dilution of 20 mU/ml.

FIG. 17C shows a blot of the 6 nitrocellulose filters at dilutions of: 1) 10 mU/ml, 1.0 ml; 2) 10 mU/ml, 5.0 ml; 3) 20 mU/ml, 1.0 ml; 4) 20 mU/ml, 5.0 ml; 5) 50 mU/ml, 4.2 ml; and 6) 100 mU/ml, 4.7 ml.

The results show that devices described here are more, and up to five times more, sensitive than the commercial EPT pregnancy test at detecting HCG.

1. An article comprising: a first chamber and a second chamber, wherein the first chamber and second chamber are connected by a collection assembly, wherein the collection assembly comprises a port through which liquid can pass and a solid substrate, wherein the solid substrate can retain a substance, and a vacuum generator operably connected to the second chamber.

2. The article of claim 1, wherein the first chamber and second chamber share at least one wall.

3. The article of claim 1, wherein the collection assembly further comprises a solid substrate support.

4. The article of claim 3, further comprising a sealer operably connected to the solid substrate support and the second chamber.

5. The article of claim 1, wherein the chamber further comprises a solid support lock operably connected to a solid substrate support.

6. The article of claim 5, further comprising a sealer operably connected to the solid substrate support and the solid support lock.

7. The article of claim 1, wherein the solid substrate comprises an acrylamide, cellulose, nitrocellulose, glass, polystyrene, or polyvinylidene fluoride (PVDF) filter, filter paper (Whatman), Glass fiber filters (GF) (A,B,C), fiberglass, polyethylimine coated GFs, porous mylar or other transparent porous films, cellulose nitrate (CN) membrane, mixed cellulose ester membrane, cellulose acetate membrane, polyethersulfone (PES) membrane, PTFE membrane, ultrafiltration membranes of poly(vinyl chloride) (PVC), carboxylated poly(vinyl chloride) (CPVC), polystyrene, polyethylene vinyl acetate, polypropylene, polymethacrylate, polyethylene, polyethylene oxide, glass, polysilicates, polycarbonates, teflon, fluorocarbons, nylon, silicon rubber, polyanhydrides, polyglycolic acid, polylactic acid, polyorthoesters, polypropylfumerate, collagen, glycosaminoglycans, and polyamino acids.

8. The article of claim 7, wherein the solid substrate further comprises a detection agent.

9. The article of claim 8, wherein the detection agent comprises a label moiety.

10. The article of claim 9, wherein the label moiety comprises an enzymatic moiety, radioactive moiety, electromagnetic field moiety, chromophore moiety, fluorophores moiety, quantum dot moiety, heavy element moiety, proton emitting moiety, phosphorescent moiety, and fluorescent moiety.

11. The article of claim 10, wherein the fluorophore moiety comprises fluorescein isothiocyanate (FITC), 5,6-carboxymethyl fluorescein, Texas red, nitrobenz-2-oxa-1,3-diazol-4-yl (NBD), coumarin, dansyl chloride, rhodamine, amino-methyl coumarin (AMCA), Eosin, Erythrosin, BODIPY®, Cascade Blue®, Oregon Green®, pyrene, lissamine, xanthenes, acridines, oxazines, phycoerythrin, macrocyclic chelates of lanthanide ions such as quantum Dye™, fluorescent energy transfer dyes, such as thiazole orange-ethidium heterodimer, and the cyanine dyes Cy3, Cy3.5, Cy5, Cy5.5 and Cy7. Examples of other specific fluorescent labels include 3-Hydroxypyrene 5,8,10-Tri Sulfonic acid, 5-Hydroxy Tryptamine (5-HT), Acid Fuchsin, Alizarin Complexon, Alizarin Red, Allophycocyanin, Aminocoumarin, Anthroyl Stearate, Astrazon Brilliant Red 4G, Astrazon Orange R, Astrazon Red 6B, Astrazon Yellow 7 GLL, Atabrine, Auramine, Aurophosphine, Aurophosphine G, BAO 9 (Bisaminophenyloxadiazole), BCECF, Berberine Sulphate, Bisbenzamide, Blancophor FFG Solution, Blancophor SV, Bodipy F1, Brilliant Sulphoflavin FF, Calcien Blue, Calcium Green, Calcofluor RW Solution, Calcofluor White, Calcophor White ABT Solution, Calcophor White Standard Solution, Carbostyryl, Cascade Yellow, Catecholamine, Chinacrine, Coriphosphine O, Coumarin-Phalloidin, CY3.1 8, CY5.1 8, CY7, Dans (1-Dimethyl Amino Naphaline 5 Sulphonic Acid), Dansa (Diamino Naphtyl Sulphonic Acid), Dansyl NH—CH₃, Diamino Phenyl Oxydiazole (DAO), Dimethylamino-5-Sulphonic acid, Dipyrrometheneboron Difluoride, Diphenyl Brilliant Flavine 7GFF, Dopamine, Erythrosin ITC, Euchrysin, FIF (Formaldehyde Induced Fluorescence), Flazo Orange, Fluo 3, Fluorescamine, Fura-2, Genacryl Brilliant Red B, Genacryl Brilliant Yellow 10GF, Genacryl Pink 3G, Genacryl Yellow 5GF, Gloxalic Acid, Granular Blue, Haematoporphyrin, Indo-1, Intrawhite Cf Liquid, Leucophor PAF, Leucophor SF, Leucophor WS, Lissamine Rhodamine B200 (RD200), Lucifer Yellow CH, Lucifer Yellow VS, Magdala Red, Marina Blue, Maxilon Brilliant Flavin 10 GFF, Maxilon Brilliant Flavin 8 GFF, MPS (Methyl Green Pyronine Stilbene), Mithramycin, NBD Amine, Nitrobenzoxadidole, Noradrenaline, Nuclear Fast Red, Nuclear Yellow, Nylosan Brilliant Flavin EBG, Oxadiazole, Pacific Blue, Pararosaniline (Feulgen), Phorwite AR Solution, Phorwite BKL, Phorwite Rev, Phorwite RPA, Phosphine 3R, Phthalocyanine, Phycoerythrin R, Polyazaindacene Pontochrome Blue Black, Porphyrin, Primuline, Procion Yellow, Pyronine, Pyronine B, Pyrozal Brilliant Flavin 7GF, Quinacrine Mustard, Rhodamine 123, Rhodamine 5 GLD, Rhodamine 6G, Rhodamine B, Rhodamine B 200, Rhodamine B Extra, Rhodamine BB, Rhodamine BG, Rhodamine WT, Serotonin, Sevron Brilliant Red 2B, Sevron Brilliant Red 4G, Sevron Brilliant Red B, Sevron Orange, Sevron Yellow L, SITS (Primuline), SITS (Stilbene Isothiosulphonic acid), Stilbene, Snarf 1, sulpho Rhodamine B Can C, Sulpho Rhodamine G Extra, Tetracycline, Thiazine Red R, Thioflavin S, Thioflavin TCN, Thioflavin 5, Thiolyte, Thiozol Orange, Tinopol CBS, True Blue, Ultralite, Uranine B, Uvitex SFC, Xylene Orange, and XRITC, fluorescein (5-carboxyfluorescein-N-hydroxysuccinimide ester), rhodamine (5,6-tetramethyl rhodamine), and the cyanine dyes Cy3, Cy3.5, Cy5, Cy5.5 and Cy7, 6-carboxyfluorescein (6-FAM), 2′,4′,1,4,-tetrachlorofluorescein (TET), 2′,4′,5′,7′,1,4-hexachlorofluorescein (HEX), 2′,7′-dimethoxy-4′,5′-dichloro-6-carboxyrhodamine (JOE), 2′-chloro-5′-fluoro-7′,8′-fused phenyl-1,4-dichloro-6-carboxyfluorescein (NED), and 2′-chloro-7′-phenyl-1,4-dichloro-6-carboxyfluorescein (VIC).

12. The article of claim 8, wherein the detection agent comprises a protein, a functional nucleic acid, a carbohydrate, a lipids, a carbohydrate containing molecule, a lipid containing molecule, or peptide mimetic.

13. The article of claim 12, wherein the protein comprises an antibody or receptor.

14. The article of claim 13, wherein the antibody comprises a monoclonal antibody.

15. The article of claim 14, wherein the receptor comprises protein A, Protein G, avidin, streptavidin, or neutravidin.

16. The article of claim 15, wherein the functional nucleic acid comprises an antisense, probe or aptamer.

17. The article of claim 1, wherein the collection assembly further comprises a pre-solid substrate.

18. The article of claim 17, wherein the pre-solid substrate comprises a prefilter.

19. The article of claim 1, further comprising a buffer.

20. The article of claim 19, wherein the buffer comprises a buffer capsule.

21. The article of claim 1, wherein article further comprises a detection agent capsule.

22. The article of claim 19, wherein the buffer comprises a solid form.

23. The article of claim 22, wherein the buffer agent comprises TRIS or other binding buffers, phophates, NaHCO₃, HEPES, protein stabilizers, RNA stabilizers, DNA stabilizers, cell preserving and fixing agents, lysing agents.

24. The article of claim 23, wherein the protein stabilizers are protease inhibitors or phosphatase inhibitors.

25. The article of claim 23, wherein the RNA stabilizers are RNase inhibitors.

26. The article of claim 23, wherein the DNA stabilizers are DNase inhibitors.

27. The article of claim 1, further comprising a detector agent capsule.

28. The article of claim 1, wherein the vacuum generator comprises a spring activated piston device.

29. The article of claim 1, wherein the vacuum generator comprises a tube with a piston operatively connected to the second chamber, wherein when the piston is withdrawn from the tube air in the second chamber is removed.

30. The article of claim 28, wherein the vacuum generator further comprises a spring operatively associated with the piston, wherein the spring when uncompressed forces the piston to be withdrawn.

31. The article of claim 1, wherein the article further comprises a lid connected to the first chamber by a hinge, wherein the lid forms a seal with the first chamber.

32. The article of claim 1, further comprising a slot blot or ELISA adaptor.

33. The article of claim 1, further comprising a support screen.

34. The article of claim 1, wherein the article further comprises a lid, wherein the lid inverts during processing.

35. The article of claim 1, wherein the article further comprises a third chamber, wherein the third chamber retains unprocessed fluids.

36. The article of claim 1, wherein the collection assembly comprises a one-way valve to prevent the liquid from flowing back through filter.

37. The article of claim 1, wherein the collection assembly further comprises a removable filter cassette for processing or analysis outside of the article.

38. The article of claim 1, wherein the first chamber comprises a bead holder compartment that allows mixing of the fluids with beads prior to processing.

39. The article of claim 1, wherein the liquid comprises urine, stool, blood—whole serum or plasma—, cerebrospinal fluid, ocular lens liquid, semen, synovial fluid, peritoneal fluid, pleural fluid, sputum, lymph fluid, saliva, amniotic fluid, pus, lavage fluid, sweat, bile, tears, exosomes, nanoparticles, vomit, gastric juice, pancreatic juice, breast milk, mucus, sebum (skin oil), vaginal secretion, aqueous humour, pericardial fluid, lymph, chyme, prostatic fluid.

40. The article of claim 1, wherein the article further comprises a mechanical piston lock to store energy.

41. A collection assembly for concentrating a substance on a filter, comprising:
a. a substrate support defining at least one opening for the passage of fluid, wherein the substrate support is configured to house a filter above the opening, the filter allowing passage of fluid there through the filter and into the opening; and
b. a concentrator apparatus configured to limit the surface area of the filter exposed to the fluid as the fluid flows from the concentrator to the filter resulting in concentration of the substance on the filter.

42. The collection assembly of claim 41, wherein the concentrator includes a body that defines at least one conduit, the conduit configured to direct fluid onto a limited portion of the filter.

43. The collection assembly of claim 41, wherein the body defines a plurality of conduits, each configured to direct fluid onto a limited portion of the filter.

44. The collection assembly of claim 41, further comprising a plurality of filters, wherein the body defines a plurality of conduits, each configured to direct fluid onto a limited portion of a separate individual filter of the plurality of filters.
